(19) United States
(12) Patent Application Publication
(10) Pub. No.: US 2024/0176257 A1
(43) Pub. Date: May 30, 2024

(54) ELECTROPHOTOGRAPHIC PHOTORECEPTOR, METHOD FOR MANUFACTURING SAME, AND ELECTROPHOTOGRAPHIC APPARATUS

(71) Applicant: FUJI ELECTRIC CO., LTD., Kawasaki-shi (JP)

(72) Inventors: Seizo KITAGAWA, Matsumoto-city (JP); Kenichi OKURA, Matsumoto-city (JP)

(73) Assignee: FUJI ELECTRIC CO., LTD., Kawasaki-shi (JP)

(21) Appl. No.: 18/477,545

(22) Filed: Sep. 28, 2023

(30) Foreign Application Priority Data
Nov. 10, 2022 (JP) 2022-180408

(51) Int. Cl. G03G 5/047; G03G 5/06

(52) U.S. Cl. CPC G03G 5/047; G03G 5/0609; G03G 5/0672; G03G 5/0696

(57) ABSTRACT

A highly sensitive and highly durable positive charging multilayer electrophotographic photoreceptor includes: a conductive substrate; a charge transport layer containing at least a first hole transport material and a first resin binder; and a charge generation layer containing at least a second hole transport material, an electron transport material, a charge generation material, and a second resin binder, the charge transport layer and the charge generation layer being sequentially laminated on the conductive substrate. The charge transport layer contains a compound represented by General Formula (AD1) below,

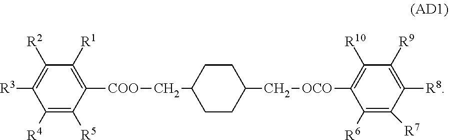

The electrophotographic photoreceptor can be applied to a positive charging electrophotographic apparatus having a high resolution and a high speed, having excellent operational stability, causing no image defects resulting from cracking caused by the adhesion of a contaminant component, having less deterioration of the electrical characteristics by ozone, causing no image defects resulting from creep deformation, and stably providing high image quality, a method for manufacturing the same, and an electrophotographic apparatus using the same.

### CROSS-REFERENCE TO A RELATED APPLICATION

This non-provisional Application for a U.S. Patent claims the benefit of priority of JP 2022-180408 filed Nov. 10, 2022, DAS code No. D4E5, the entire contents of which is hereby incorporated by reference.

### TECHNICAL FIELD

The present invention relates to an electrophotographic photoreceptor (hereinafter also simply referred to as “photoreceptor”) used in an electrophotographic apparatus, such as electrophotographic printers or copiers and fax machines, a method for manufacturing the same, and an electrophotographic apparatus.

### BACKGROUND ART

The electrophotographic photoreceptor has a structure in which a photosensitive layer having a photoconductive function is provided on a conductive substrate as a basic structure. In recent years, research and development on organic electrophotographic photoreceptors containing organic compounds as functional components performing charge generation or charge transport has been actively advanced due to the advantages thereof, such as material diversity, high productivity, and safety, and the application thereof to copiers, printers, and the like has been advanced.

In general, the photoreceptor requires a function of holding a surface charge in a dark place, a function of receiving light and generating a charge, and further a function of transporting the generated charge. A photosensitive layer plays these roles. The photoreceptors are classified into a multilayer (function separation type) photoreceptor and a single-layer photoreceptor by the mode of the photosensitive layer. The multilayer photoreceptor includes a photosensitive layer containing a laminate of a charge generation layer and a charge transport layer. The charge generation layer mainly performs a charge generation function in light reception. The charge transport layer performs a function of transporting the charge generated in the charge generation layer in light reception. The multilayer photosensitive layer performs a function of holding the surface charge in a dark place. The single-layer photoreceptor includes a single-layer photosensitive layer having both a charge generation function and a charge transport function and performing a surface charge holding function.

The photoreceptors include a positive charging photoreceptor making the charging characteristics of the photoreceptor surface positive charging characteristics and a negative charging photoreceptor making the charging characteristics of the photoreceptor surface negative charging characteristics. A currently mainly used electrophotographic apparatus is a negative charging electrophotographic apparatus, and a negative charging photoreceptor is used. In the negative charging photoreceptor, a negative charging multilayer photoreceptor is used in which a charge generation layer containing a charge generation material dispersed with a resin binder and a charge transport layer containing a hole transport material dispersed with a resin binder are sequentially laminated. On the other hand, a positive charging electrophotographic apparatus has also been put into practical use, and a positive charging photoreceptor is used. In the positive charging photoreceptor, mainly a positive charging single-layer photoreceptor having a configuration in which a charge generation material, a hole transport material, and an electron transport material are dispersed with a resin binder in the same layer is being generally put into wide practical use. As the main reason therefor, it is considered to be because an electron transport function of the electron transport material inferior in the transport function to a hole transport function of the hole transport material is complemented by the hole transport material. In this positive charging single-layer photoreceptor, the generation of charges (electron and hole) occurs also inside a film because the charge generation material is dispersed in the single-layer film. However, the charge generation amount increases toward the vicinity of the surface of the photosensitive layer, and thus the electron transport distance from the vicinity of the surface to the surface may be smaller than the hole transport distance from the vicinity of the surface to a substrate. Hence, it is considered that the electron transport function does not need to be as high as the hole transport function. This realizes sufficient environmental stability and fatigue characteristics for practical use.

However, this positive charging single-layer photoreceptor is advantageous in that a single film has both the functions of the charge generation function and the charge transport function, and therefore a coating step can be simplified and a high good product rate and a high process capacity are easily obtained, while this positive charging single-layer photoreceptor has posed a problem that both the hole transport material and the electron transport material are contained in large quantities in the single layer to achieve high sensitivity, and therefore the resin binder content decreases and the durability decreases. Thus, the positive charging single-layer photoreceptor has been limited in achieving both high sensitivity and high durability.

Further, the positive charging single-layer photoreceptor also has had a drawback that the decrease in the resin binder ratio in the positive charging single-layer photoreceptor reduces the glass transition point, deteriorating the contamination resistance to a contact member.

Therefore, to achieve all of the sensitivity, durability, and contamination resistance adaptable to the recent miniaturization, higher speed, higher resolution, and colorization of devices, a conventional positive charging single-layer photoreceptor is difficult to be made adaptable, and colorization, and thus a new positive charging multilayer photoreceptor in which a charge transport layer and a charge generation layer are sequentially laminated has also been proposed (see, for example, Patent Document 1) and has also been put into practical use. In this positive charging multilayer photoreceptor, the charge generation layer of the upper layer is a layer in which the charge generation material, the electron transport material, and the hole transport material are mainly compounded with a resin binder and the charge transport layer of the lower layer is a layer in which a hole transport material is mainly compounded with a resin binder. More specifically, the charge generation layer has the charge generation function, the electron transport function, and the hole transport function and the charge transport layer has the hole transport function, so the positive charging multilayer photoreceptor has a functionally-separated layer configuration.

When no protective layer is used, the charge generation layer of the upper layer serves as the surface layer, and therefore, as the film thickness of the charge generation layer, a film thickness considering scraping in actual use is required. However, due to the presence of the charge transport layer in the lower layer, the film thickness does not need to be as thick as a positive charging single-layer photosensitive layer, and therefore the charge generation material can be reduced in amount. The main constituent materials of the charge generation layer are the same as those of the positive charging single-layer photosensitive layer. In this case, the electron transport function is more important than the hole transport function, and therefore the content of the hole transport material can be reduced, and thus the electron transport material ratio or the resin binder ratio can be set higher than that of the positive charging single-layer photosensitive layer.

The charge transport layer has only to have the hole transport function and does not necessarily require the charge generation function or the electron transport function, and therefore the charge generation material and the electron transport material are not essential. Further, the charge transport layer is not the surface layer, and therefore is not a portion where scraping occurs during actual use, and thus physical durability is not strongly required. Therefore, the resin binder content can be reduced, and thus the hole transport material ratio can be set higher than that of the positive charging single-layer photosensitive layer.

Accordingly, the positive charging multilayer photoreceptor is the function separate type, and therefore the charge generation layer and the charge transport layer can be individually optimized, so that the positive charging multilayer photoreceptor is configured such that both high sensitivity and high durability are easily achieved.

In the organic electrophotographic photoreceptor, regardless of whether it is a negative charging type, a positive charging type, a multilayer type, or a single-layer type, various additives can be added, in addition to the functional materials, such as the charge generation material, the hole transport material, and the electron transport material, or the resin binder, to each photosensitive layer as desired to improve the sensitivity, reduce the residual potential, improve the environmental resistance or the stability against harmful light, improve the durability including friction resistance, and the like.

For example, it is known to compound an additive, such as an antioxidant, in the photosensitive layer of the photoreceptor to prevent the deterioration of the photoreceptor by ozone. As a typical antioxidant, dibutylhydroxytoluene (BHT) which is a hindered phenolic antioxidant is known. In addition, for example, Patent Document 2 describes that the addition of specific amine compounds to the photosensitive layer significantly improves the ozone resistance and produces a photoreceptor excellent in electrical characteristics. It is also described that the addition amount is more preferably within the range of 1 to 16% by weight in that layer.

Further, Patent Document 3 describes that, by utilizing the action that a specific cyclohexanedimethanol-diaryl ester compound added as the additive to fill a void generated in a film at the molecular level when the resin binder of the photosensitive layer forms the film, a stronger film is formed, the inflow/outflow of harmful gases, such as ozone, or low-molecular-weight gases, such as water vapor, is suppressed, the abrasion resistance of the photoreceptor is improved, and the deterioration of the electrical characteristics is prevented. It is described that the addition amount is more preferably within the range of 0.5 parts by weight or more and 20 parts by weight or less based on 100 parts by weight of the resin binder in the layer to which the specific cyclohexanedimethanol-diaryl ester compound is added.

Further, Patent Document 4 describes that, when a hole is formed inside the photosensitive layer due to the adhesion of contaminant components to the photoreceptor surface and the elution of monomer components, a specific compound as the additive can act on the hole to release local stress and suppress the occurrence of cracking and the generation of black spots accompanying the occurrence of cracking. Further, it is also described that, when the content of the specific compound as the additive exceeds 14% by weight in terms of solid content of the photosensitive layer, the glass transition point of the photosensitive layer decreases, resulting in a decrease in the abrasion resistance in some cases or the dispersibility of the compound in the resin binder decreases, resulting in crystallization in some cases, and therefore the content of the additive is more preferably set to a value within the range of 4 to 10% by weight. It has also been described that, for the elution of the monomer components, the elution amount can be regulated by controlling the solubility into the contaminant components by the use of the hole transport material having predetermined solubility.

Further, Patent Document 5 describes that, by using relatively rigid polycarbonate or the like as a resin binding agent of the charge generation layer as the outermost surface layer of the positive charging multilayer photoreceptor and adding a space filler, the space filler fills a space in the molecular level derived from the polymer structure of the polycarbonate or the like, forming a more rigid coating film, and thus a good photoreceptor free from creep deformation can be obtained.

Patent Document 1 describes that the occurrence of cracking due to the adhesion of contaminant components, such as sebum, can be prevented by reducing the total amount of a residual solvent contained in the charge generation layer and the charge transport layer to 50 μg/cm² or less by drying in a reduced pressure state in the positive charging multilayer photoreceptor.

### RELATED ART DOCUMENTS

### Patent Documents

[Patent Document 1] WO 2013/021430

[Patent Document 2] JPH3-172852A

[Patent Document 3] JP2007-279446A

[Patent Document 4] JP2007-256768A

[Patent Document 5] JP2009-288569A

### SUMMARY OF THE INVENTION

### Problems to be Solved by the Invention

The generation of ozone occurs less frequently in the positive charging electrophotographic apparatus than in the negative charging electrophotographic apparatus. Therefore, the ozone resistance has been conventionally less desired in the positive charging photoreceptor than in the negative charging photoreceptor.

However, due to the difficulty of exhausting air in a recent downsized electrophotographic apparatus and the fact that a tandem color machine has four chargers, the concentration of ozone near the photoreceptor increases even when the amount of ozone generated from one positive charger is small. Then, when the photoreceptor is exposed to ozone in such an environment for a long period of time, the photoreceptor deteriorates, leading to the deterioration of the electrical characteristics. Therefore, high ozone resistance is also demanded in the positive charging multilayer photoreceptor, and higher ozone resistance is demanded particularly in a cylindrical photoreceptor with a small diameter of between 15 mm or more and less than 28 mm used in a small electrophotographic apparatus.

When the creep strength of the photoreceptor is insufficient, toner filming or filming of external additives or paper dust is likely to occur, increasing the generation amount of minute black spots or the like caused by sticking of toner and paper dust mixtures in a high temperature and high humidity environment. In addition, the creep deformation caused by a contact member, such as a transfer roller, a cleaning roller, or a developing roller, is likely to occur. When the photoreceptor undergoes the creep deformation, image defects occur. Accordingly, high creep strength is also demanded in the positive charging multilayer photoreceptor.

Further, when a contaminant component, such as oils and fats or sebum, adheres to the photoreceptor, cracking occurs in the photosensitive layer in some cases. In a place where the cracking occurs, image defects, such as black spots or white spots, occur. Therefore, the positive charging multilayer photoreceptor is also demanded to prevent the occurrence of cracking even when the contaminant component adheres.

Thus, it is an object of the present invention to solve the above-described problems in a positive charging multilayer electrophotographic photoreceptor and to provide a highly sensitive and highly durable positive charging multilayer electrophotographic photoreceptor applied to a positive charging electrophotographic apparatus having a high resolution and a high speed, having excellent operational stability, causing no image defects resulting from cracking caused by the adhesion of a contaminant component, such as oils and fats or sebum, having less deterioration of the electrical characteristics by ozone, causing no image defects resulting from the creep deformation caused by a contact member, and stably providing high image quality, a method for manufacturing the same, and an electrophotographic apparatus using the same.

### Means for Solving the Problems

The present inventors have extensively examined the cause of the occurrence of cracking due to sebum adhesion in the positive charging multilayer electrophotographic photoreceptor.

As a result, it was estimated from the cross-section observation of a photoreceptor in which cracking occurred that, in a positive charging multilayer photoreceptor having a charge generation layer as the surface and a charge transport layer provided in the lower layer, the origin of the occurrence of cracking is not in the charge generation layer near the surface and the cracking occurs in the interface between the charge generation layer and the charge transport layer or in the charge transport layer away from the surface.

This is presumed that the cracking by the following mechanism occurs. More specifically, components in the sebum adhering to the surface gradually permeate into the charge generation layer, but, the period while the components remain inside the charge generation layer, the components do not cause cracking, even when the hole transport material in the charge generation layer slightly dissolves. However, it is considered that, when the components in the sebum permeate into the interface between the charge generation layer and the charge transport layer or further into the charge transport layer, the hole transport material in the charge transport layer dissolves and moves to the sebum adhering to the photoreceptor surface, a void is generated, stress concentrates in the void, the void serves as the starting point of the occurrence of cracking, cracking occurs in the charge transport layer, and the cracking propagates to the charge generation layer of the upper layer, so that cracking reaching the surface of the charge generation layer occurs. In particular, it is presumed that the cracking by this mechanism more remarkably occurs in the positive charging multilayer photoreceptor in which the content of the hole transport material in the charge transport layer is larger than the content of the hole transport material in the charge generation layer.

From the viewpoint above, the present inventors have further examined not only the prevention of the occurrence of cracking in the charge generation layer of the upper layer of the positive charging multilayer photoreceptor, but the prevention of the occurrence of cracking in the charge transport layer of the lower layer. As a result, the present inventors have found that, by compounding a compound represented by General Formula (AD1) below as the additive in the charge transport layer, the occurrence of cracking due to sebum adhesion can be prevented without reducing the creep strength of the positive charging multilayer photoreceptor and the ozone resistance is simultaneously greatly improved, and thus have completed the present invention.

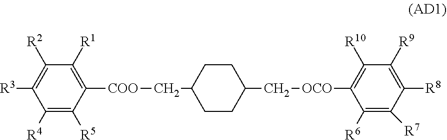

(In General Formula (AD1), R¹ to R¹⁰ each independently represent a hydrogen atom, a halogen atom, a substituted or unsubstituted alkyl group having 1 to 5 carbon atoms, a substituted or unsubstituted aryl group, or an alkoxy group having 1 to 5 carbon atoms. A substituent of a substituted group includes a halogen atom, an alkyl group having 1 to 5 carbon atoms, an aryl group, or an alkoxy group having 1 to 5 carbon atoms.)

Further, the present inventors have extensively examined an additive to the charge generation layer for a further improvement of the ozone resistance in the positive charging multilayer photoreceptor.

As a result, it was found that the kind or the amount of the additive acts on not only the ozone resistance of the positive charging multilayer photoreceptor but the creep deformation of the charge generation layer.

From such a viewpoint, the present inventors have conducted a further examination, and, as a result, have found that, by compounding a compound represented by General Formula (AD2) below as the additive in the charge generation layer, the ozone resistance is further improved without reducing the creep strength of the positive charging multilayer photoreceptor, and thus have completed the present invention.

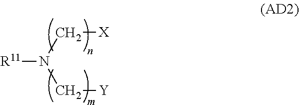

(In General Formula (AD2), R¹¹ represents a hydrogen atom, an alkyl group having 1 to 5 carbon atoms, a substituted or unsubstituted aryl group, or a substituted or unsubstituted aralkyl group, X, Y represents a substituted or unsubstituted aryl group, and n, m represents 1 or 2. A substituent of a substituted group represents a halogen atom, an alkyl group having 1 to 5 carbon atoms, an aryl group, or an alkoxy group having 1 to 5 carbon atoms.)

More specifically, a first aspect of the present invention is an electrophotographic photoreceptor including: in an positive charging multilayer electrophotographic photoreceptor containing a conductive substrate; a charge transport layer containing at least a first hole transport material and a first resin binder; and a charge generation layer containing at least a second hole transport material, an electron transport material, a charge generation material, and a second resin binder, the charge transport layer and the charge generation layer being sequentially laminated on the conductive substrate, the compound represented by General Formula (AD1) above in the charge transport layer.

The content of the compound represented by General Formula (AD1) above in the charge transport layer is suitably 15 parts by mass or more and 30 parts by mass or less based on a total of 100 parts by mass of the first hole transport material and the first resin binder. The charge generation layer preferably contains the compound represented by General Formula (AD2) above. In this case, the content of the compound represented by General Formula (AD2) above in the charge generation layer is suitably 0.5 parts by mass or more and 5 parts by mass or less based on a total of 100 parts by mass of the second hole transport material, the electron transport material, the charge generation material, and the second resin binder.

The charge transport layer also preferably further contains the compound represented by General Formula (AD2) above.

The content of the compound represented by General Formula (AD2) above in the charge transport layer is suitably 1 part by mass or more and 10 parts by mass or less based on a total of 100 parts by mass of the first hole transport material and the first resin binder.

Either one or both of the first hole transport material and the second hole transport material preferably contains or contain a compound represented by Structural Formula (HT1) below.

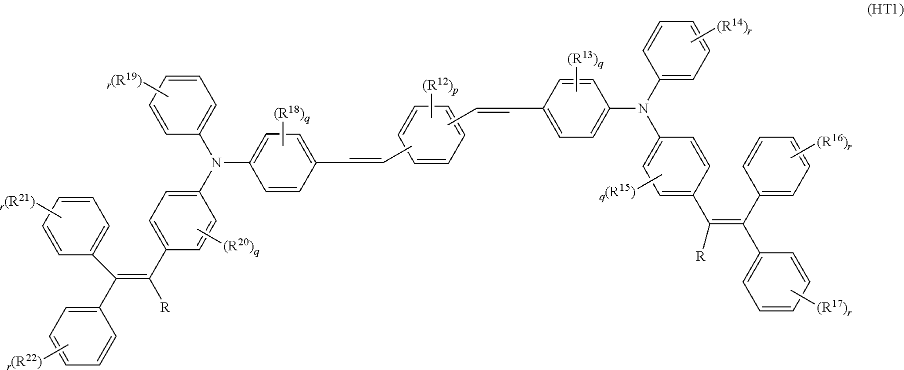

(In Structural Formula (HT1), R¹² represents a hydrogen atom or an alkyl group having 1 to 3 carbon atoms which may have a substituent, R 13 to R 22 each independently represent a hydrogen atom, a halogen atom, an alkyl group having 1 to 6 carbon atoms which may have a substituent, or an alkoxy group having 1 to 6 carbon atoms which may have a substituent, p is an integer of 0 to 4, q is an integer of 0 to 4, r is an integer of 0 to 5, and R represents a hydrogen atom or an alkyl group having 1 to 3 carbon atoms which may have a substituent.) The charge generation material is preferably titanyl phthalocyanine.

Preferably, in General Formula (AD1) above, R¹ to R¹⁰ each independently represent a hydrogen atom or a methyl group.

Preferably in General Formula (AD2) above, R¹¹ represents a benzyl group, X and Y represent an unsubstituted phenyl group, and n and m represent 1.

The charge transport layer and the charge generation layer can be formed by a dip coating method.

The conductive substrate is suitably a cylindrical aluminum substrate with a diameter of 28 mm or more and 40 mm or less or a cylindrical aluminum substrate with a diameter of 15 mm or more and less than 28 mm.

A second aspect of the present invention is a method for manufacturing an electrophotographic photoreceptor including: in manufacturing the above-described electrophotographic photoreceptor, a step of preparing a charge transport layer coating solution containing at least the first hole transport material, the first resin binder, and the compound represented by General Formula (AD1) above; and a step of forming the charge transport layer by a dip coating method using the charge transport layer coating solution.

A third aspect of the present invention is a monochrome electrophotographic apparatus mounted with the above-described electrophotographic photoreceptor and having the printing speed of 50 pages per minute (ppm) or more, a monochrome electrophotographic apparatus mounted with the above-described electrophotographic photoreceptor and having the photoconductor drum life of 50,000 sheets or more, a tandem color electrophotographic apparatus mounted with the above-described electrophotographic photoreceptor and having the printing speed of 30 ppm or more, or a tandem color electrophotographic apparatus mounted with the above-described electrophotographic apparatus and having the photoconductor drum life of 30,000 sheets or more.

### Effects of the Invention

The present invention has been able to realize a highly sensitive and highly durable positive charging multilayer electrophotographic photoreceptor, particularly even when applied to a positive charging electrophotographic apparatus having a high resolution and a middle and high speed, such as a small tandem color printer, having excellent operational stability, causing no image defects resulting from cracking caused by the adhesion of a contaminant component, such as oils and fats or sebum, having less deterioration of the electrical characteristics by ozone, causing no image defects resulting from the creep deformation caused by a contact member, and stably providing high image quality, a method for manufacturing the same, and an electrophotographic apparatus using the same.

### BRIEF DESCRIPTION OF THE DRAWINGS

FIG. 1 is a schematic cross-sectional view illustrating one example of an electrophotographic photoreceptor according to an embodiment of the present invention;

FIG. 2 is a schematic configuration view illustrating one configuration example of the electrophotographic apparatus according to the embodiment of the present invention; and

FIG. 3 is a schematic configuration view illustrating another example of an electrophotographic process arrangement in the electrophotographic apparatus according to the embodiment of the present invention.

### MODE FOR CARRYING OUT THE INVENTION

Hereinafter, a specific embodiment of an electrophotographic photoreceptor according to an embodiment of the present invention is described in detail with reference to the drawings. The present invention is not limited at all by the following description.

### (Electrophotographic Photoreceptor)

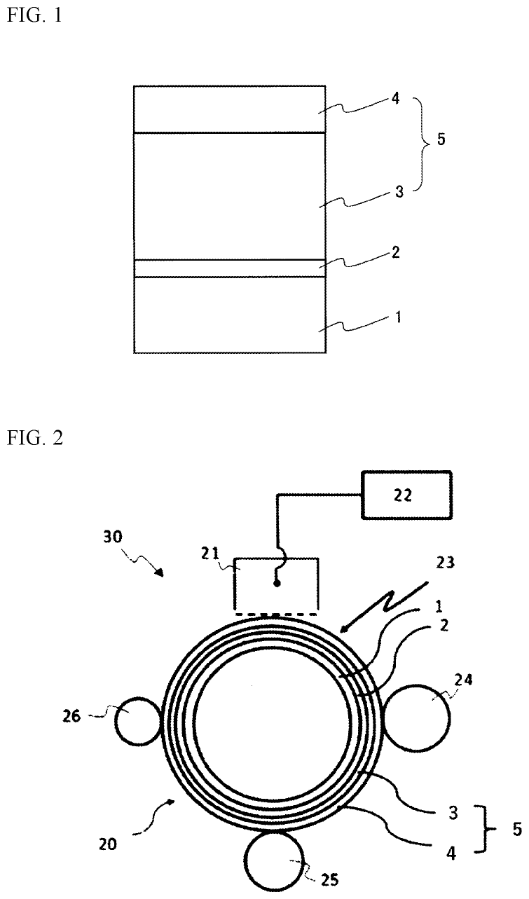

FIG. 1 is a schematic cross-sectional view illustrating one example of the electrophotographic photoreceptor according to the embodiment of the present invention and illustrates a positive charging multilayer electrophotographic photoreceptor. As illustrated in FIG. 1, the positive charging multilayer photoreceptor includes a multilayer positive charging photosensitive layer 5. The photosensitive layer 5 includes a charge transport layer 3 with a charge transport function and a charge generation layer 4 with a charge generation function, which are sequentially laminated on the surface of a cylindrical conductive substrate 1 via an undercoat layer 2. In the photoreceptor illustrated in FIG. 1, the undercoat layer 2 may be provided as necessary. Although not illustrated, the photoreceptor illustrated in FIG. 1 can be provided with a surface protective layer on the outermost surface of the photoreceptor.

In the positive charging multilayer electrophotographic photoreceptor according to the embodiment of the present invention, the charge transport layer 3 contains a compound represented by General Formula (AD1) below.

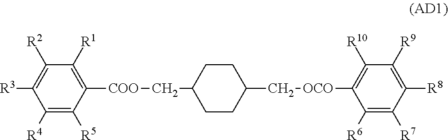

(In General Formula (AD1), R¹ to R¹⁰ each independently represent a hydrogen atom, a halogen atom, a substituted or unsubstituted alkyl group having 1 to 5 carbon atoms, a substituted or unsubstituted aryl group, or an alkoxy group having 1 to 5 carbon atoms. A substituent represents a halogen atom, an alkyl group having 1 to 5 carbon atoms, an aryl group, or an alkoxy group having 1 to 5 carbon atoms.)

Specific examples of the compound having the structure represented by General Formula (AD1) above include, but not limited to, the following substances. The compound having the structure represented by General Formula (AD1) above is preferably one in which R¹ to R¹⁰ each independently represent a hydrogen atom or a methyl group.

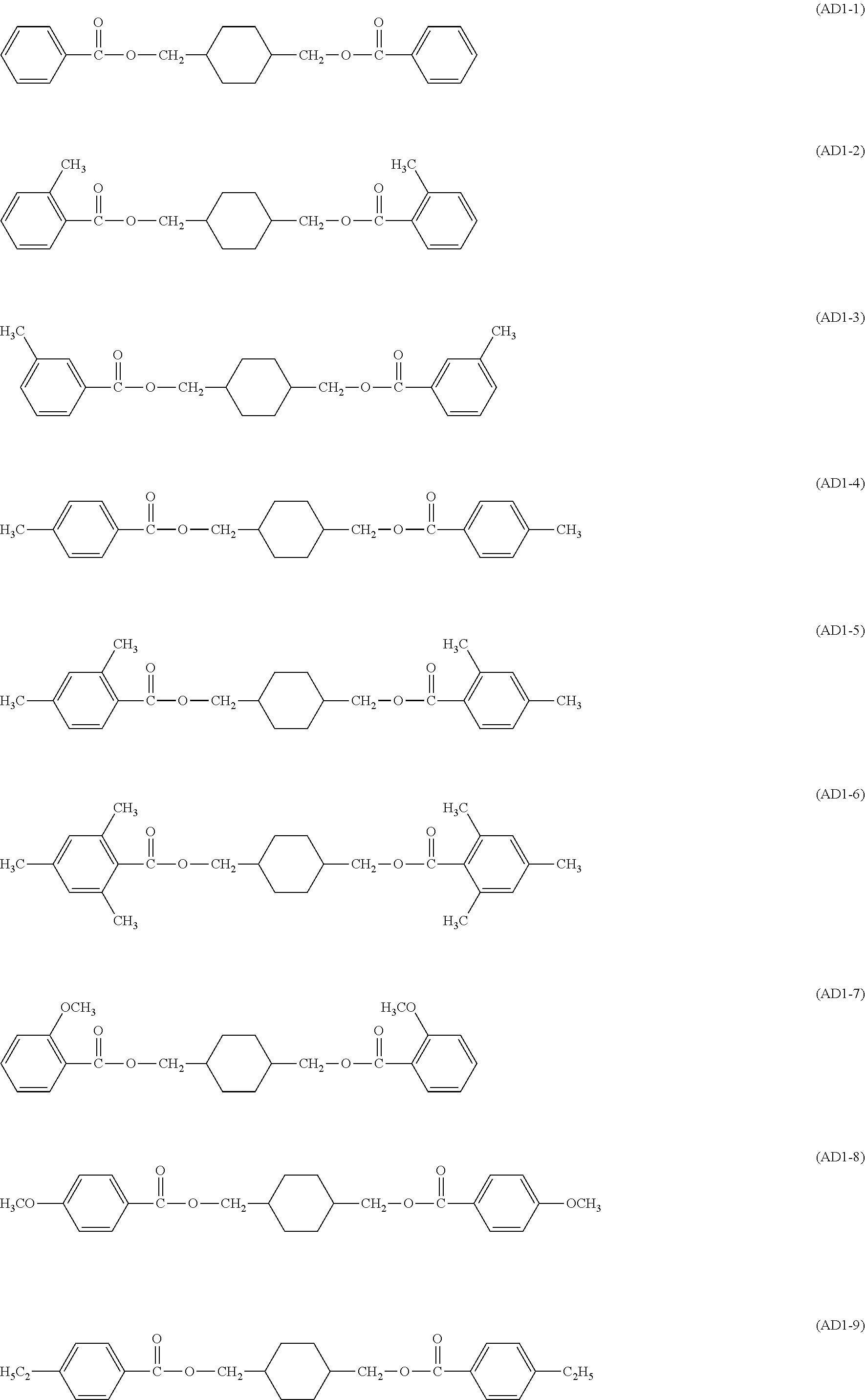

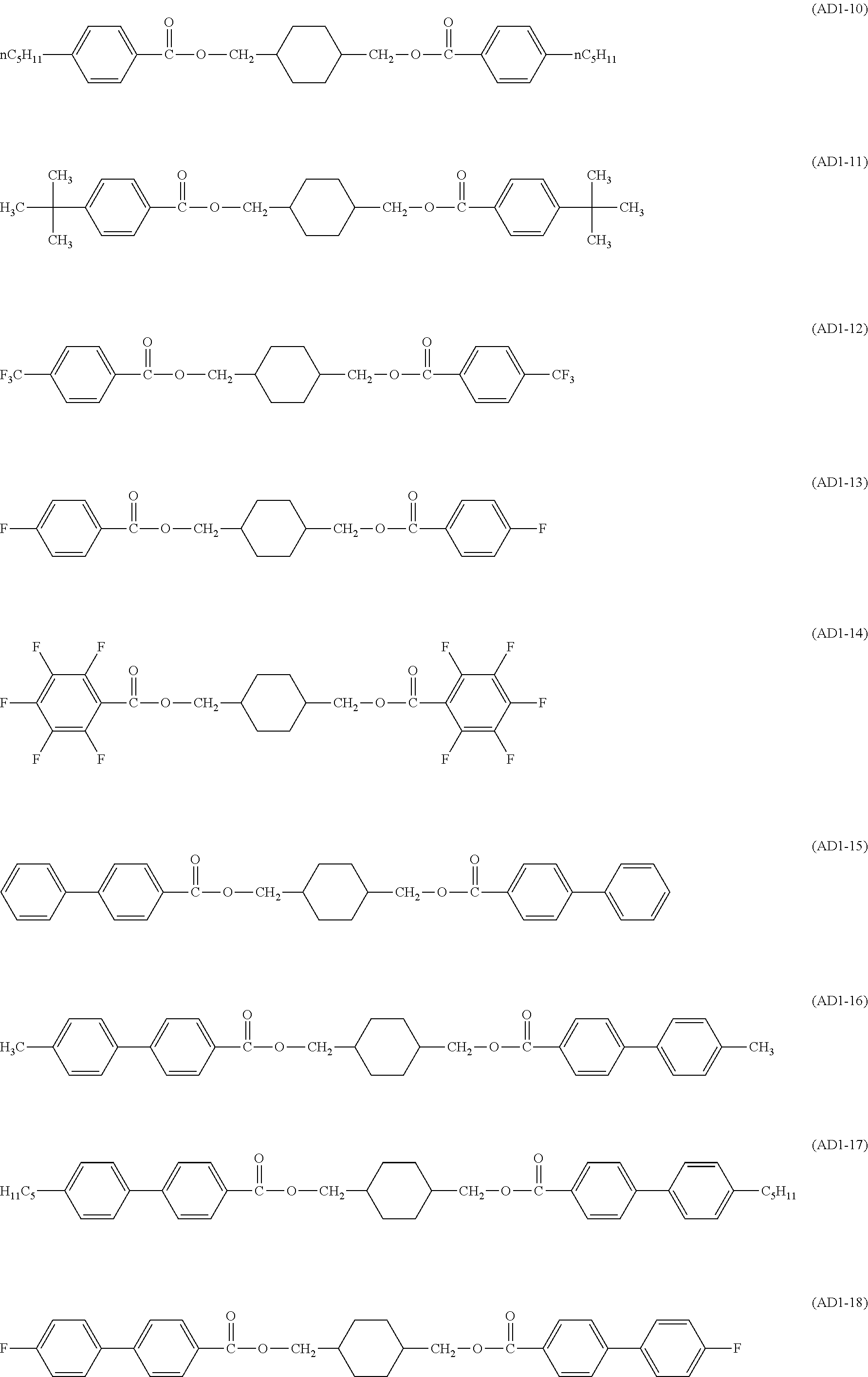

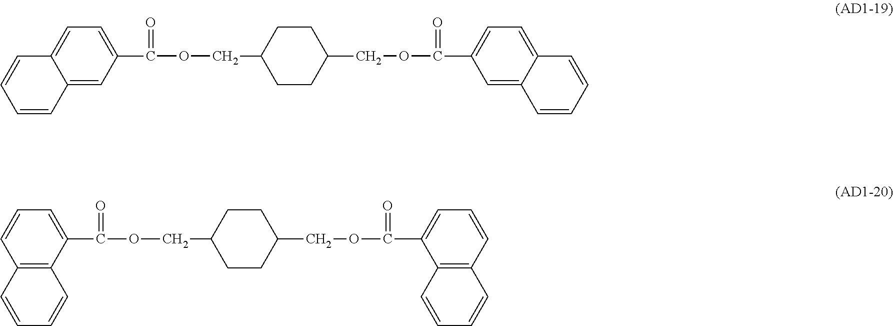

In a positive charging multilayer electrophotographic photoreceptor according to

another embodiment of the present invention, the charge generation layer 4 preferably contains a compound represented by General Formula (AD2) below.

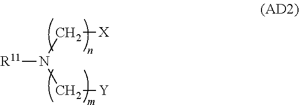

(In General Formula (AD2), represents a hydrogen atom, an alkyl group having 1 to 5 carbon atoms, a substituted or unsubstituted aryl group, or a substituted or unsubstituted aralkyl group, X, Y represents a substituted or unsubstituted aryl group, and n, m represents 1 or 2. A substituent represents a halogen atom, an alkyl group having 1 to 5 carbon atoms, an aryl group, or an alkoxy group having 1 to 5 carbon atoms.)

Specific examples of the compound having the structure represented by General Formula (AD2) above include, but not limited to, the following substances. The compound having the structure represented by General Formula (AD2) above is preferably one in which RH represents a benzyl group, X and Y represent an unsubstituted phenyl group, and n and m represent 1.

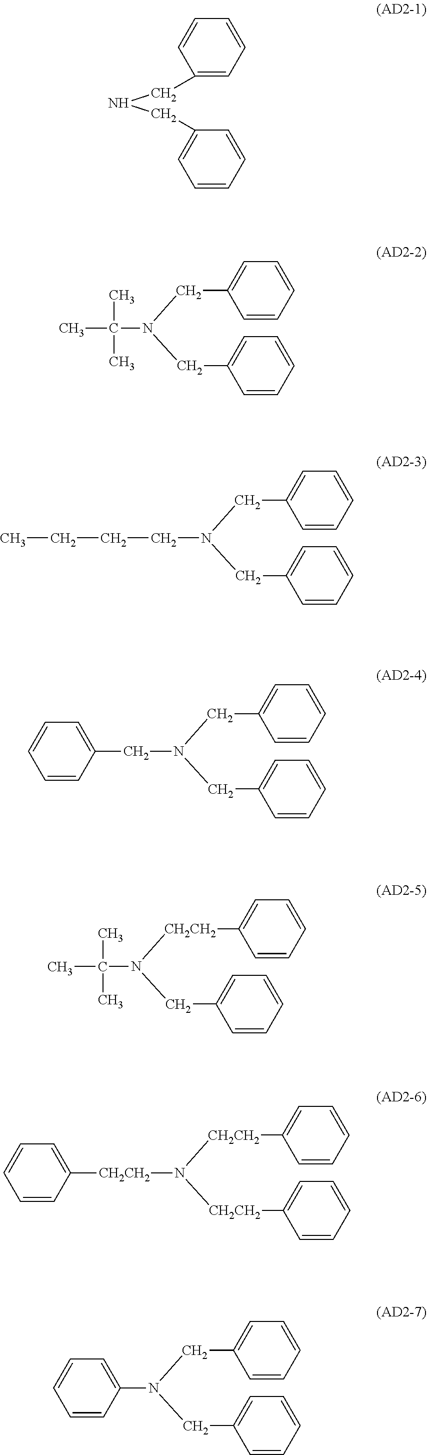

By compounding the compound represented by General Formula (AD1) above in the charge transport layer 3, the occurrence of cracking due to sebum adhesion can be prevented without reducing the creep strength of the photoreceptor, and the ozone resistance can be simultaneously greatly improved. Further, by compounding the compound represented by General Formula (AD2) above in the charge generation layer 4, the above-described effects can be more satisfactorily obtained. Further, the compound represented by General Formula (AD2) above can also be compounded in the charge transport layer 3, and thus the initial electrical characteristics can be improved without impairing the above-described effects.

Hereinafter, a specific configuration of the positive charging multilayer photoreceptor of the present invention is described in detail.

The conductive substrate 1 serves as an electrode of the photoreceptor and, simultaneously, serves as a support of each layer constituting the photoreceptor, and may have any shape, such as a cylindrical shape, a plate shape, or a film shape. As materials of the conductive substrate 1, metals, such as aluminum, stainless steel, and nickel, or those obtained by applying conductive treatment to the surface of glass, resin, and the like are usable.

In particular, when a cylindrical aluminum substrate with a diameter of 28 mm or more and 40 mm or less or a diameter of 15 mm or more and less than 28 mm is used as the conductive substrate 1, an effect of preventing the occurrence of cracking due to sebum adhesion without reducing the creep strength of the photoreceptor and, simultaneously, greatly improving the ozone resistance can be satisfactorily obtained.

The undercoat layer 2 contains a layer containing resin as the main ingredient or a metal oxide film, such as the one obtained by an alumite treatment (anodizing). The undercoat layer 2 is provided as necessary for the purpose of controlling the charge injection property from the conductive substrate 1 to the photosensitive layer, covering defects on the surface of the conductive substrat 1, or improving the adhesion between the photosensitive layer and the conductive substrate 1, for example. Examples of resin materials used in the undercoat layer 2 include insulating polymers, such as casein, polyvinyl alcohol, polyamide, melamine, and cellulose, and conductive polymers, such as polythiophene, polypyrrole, and polyaniline, and these resins can be used alone or combined and mixed as appropriate for use. Metal oxides, such as titanium dioxide and zinc oxide, may be compounded in these resins for use.

In the positive charging multilayer photoreceptor, the photosensitive layer 5 is formed on the conductive substrate 1 and has a configuration in which the charge transport layer 3 and the charge generation layer 4 are sequentially laminated. The charge transport layer 3 contains at least a first hole transport material and a first resin binder. The charge generation layer 4 contains at least a charge generation material, a second hole transport material, an electron transport material, and a second resin binder. In the positive charging multilayer photoreceptor, an electron transport material may be further compounded in the charge transport layer 3.

As the first hole transport material of the charge transport layer 3 and the second hole transport material of the charge generation layer 4, hole transport materials, such as a hydrazone compound, a pyrazoline compound, a pyrazolone compound, an oxadiazole compound, an oxazole compound, an arylamine compound, a benzidine compound, a stilbene compound, a styryl compound, poly-N-vinylcarbazole, and polysilane, are usable, for example, and, among the above, the arylamine compound is preferable. These hole transport materials can be used alone or in combination of two or more kinds thereof. As the hole transport material, those excellent in the ability to transport a hole generated in light irradiation and suitable for the combination with the charge generation material are preferable. Further, as the hole transport material, those having hole mobility of 15×10⁻⁶ [cm²/V·s] or more and particularly 20×10⁻⁶ to 80×10⁻⁶ [cm²/V·s] when the electric field strength is set to 20 V/μm are suitably used. When the hole mobility is less than 15×10⁻⁶ [cm²/V·s], a ghost is likely to occur. Herein, the hole mobility can be measured using a coating solution obtained by adding the hole transport material into the resin binder to have a proportion of 50% by mass. The ratio between the hole transport material and the resin binder is 50:50. The resin binder may be a bisphenol Z-type polycarbonate resin. For example, Iupizeta PCZ-500 (trade name, manufactured by Mitsubishi Gas Chemical Company, Inc.) may be used. Specifically, this coating solution is applied onto a base material and dried at 120° C. for 30 minutes to prepare a coating film with a film thickness 7 μm, and the hole mobility at a constant electric field strength of 20 V/μm can be measured using a Time of Flight (TOF) method. The measurement temperature is 300 K.

Specific examples of the hole transport material include a compound having a structure represented by General Formula (HT1) below. Preferably, either one or both of the first hole transport material and the second hole transport material contains or contain the compound represented by Structural Formula (HT1) below.

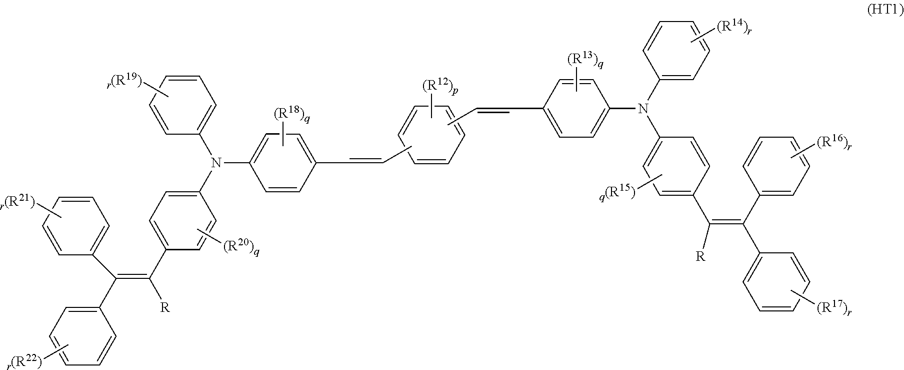

(In Structural Formula (HT1), R¹² represents a hydrogen atom or an alkyl group having 1 to 3 carbon atoms which may have a substituent, R¹³ to R²² each independently represent a hydrogen atom, a halogen atom, an alkyl group having 1 to 6 carbon atoms which may have a substituent, or an alkoxy group having 1 to 6 carbon atoms which may have a substituent, p is an integer of 0 to 4, q is an integer of 0 to 4, r is an integer of 0 to 5, and R represents a hydrogen atom or an alkyl group having 1 to 3 carbon atoms which may have a substituent.)

Specific examples of the compound having the structure represented by General Formula (HT1) above as the hole transport material include the following substances.

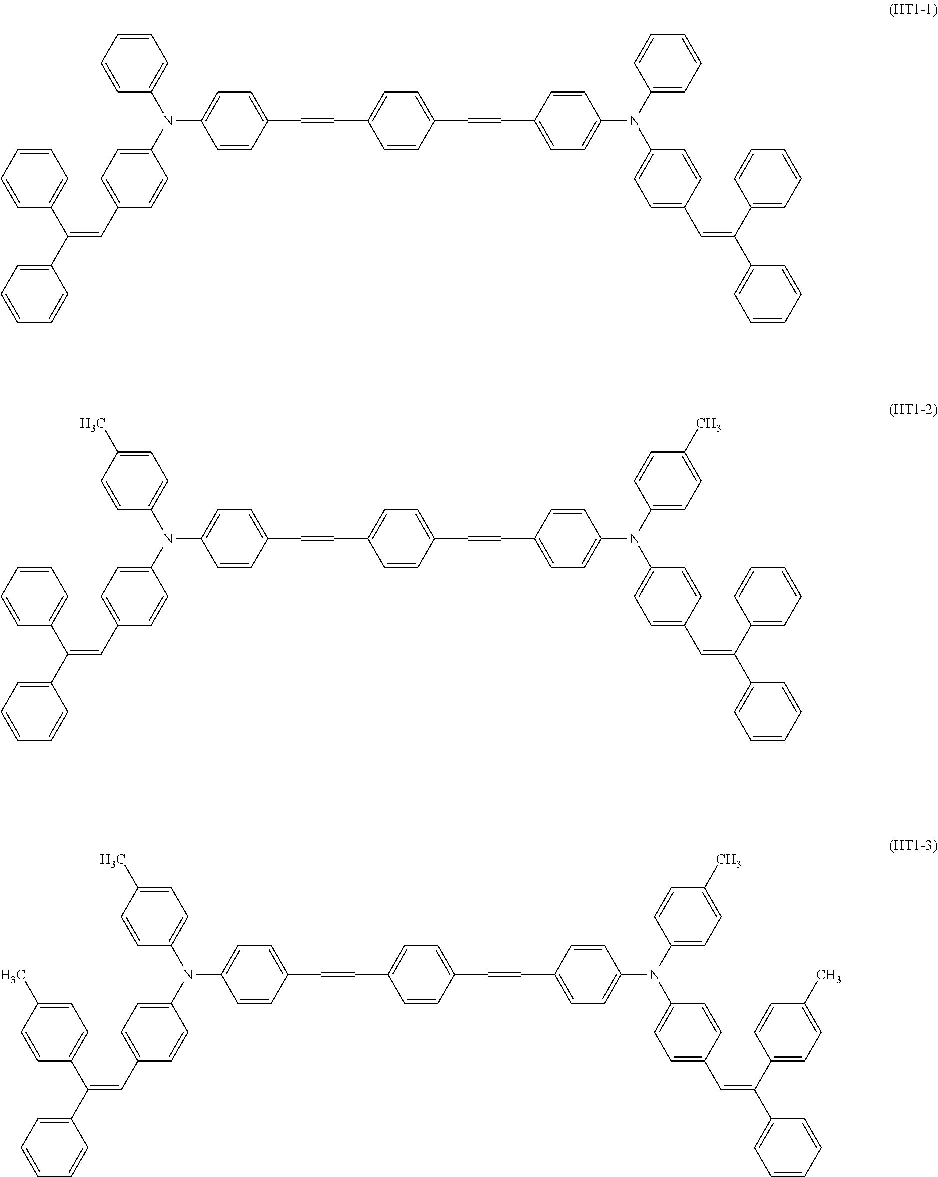

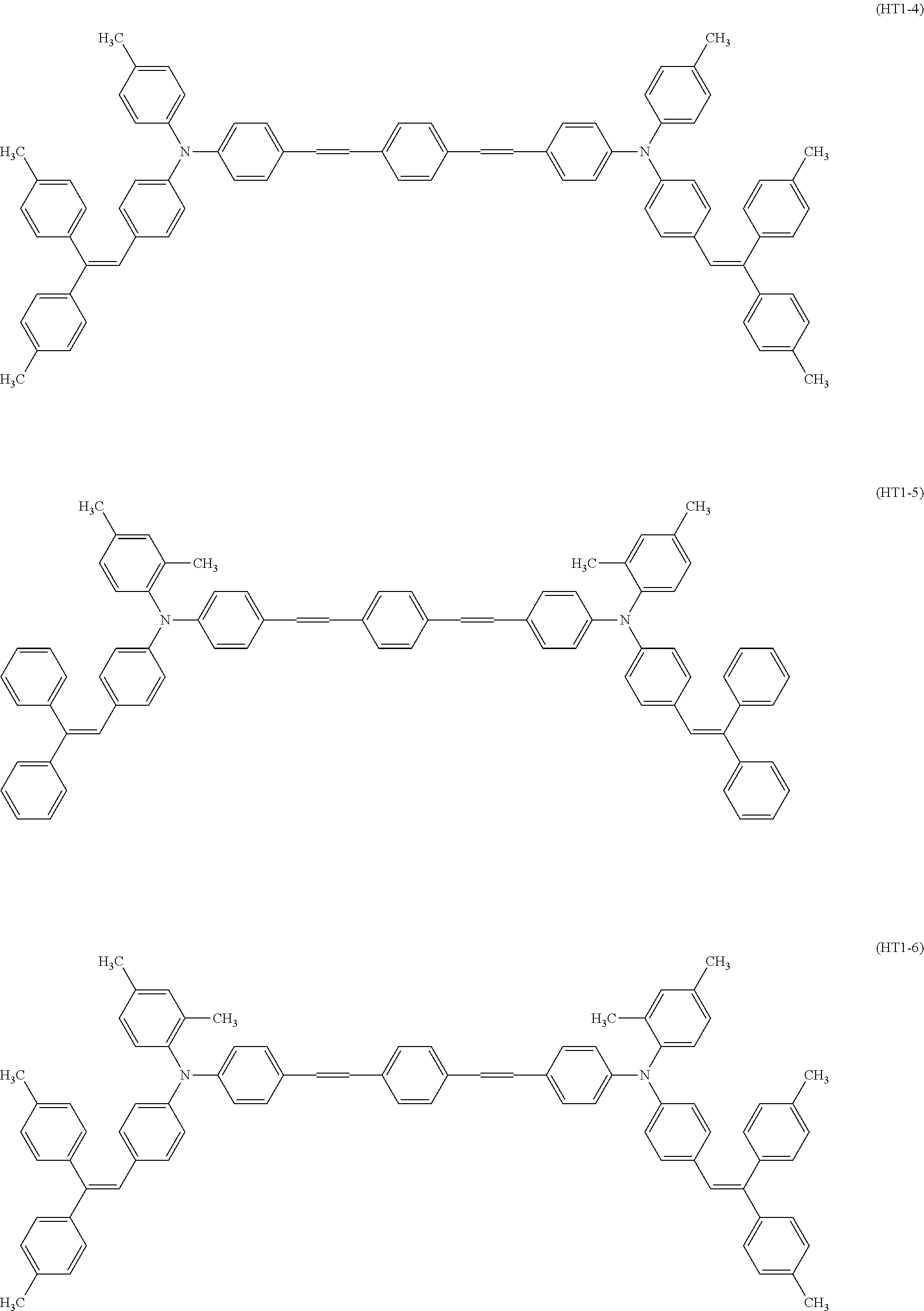

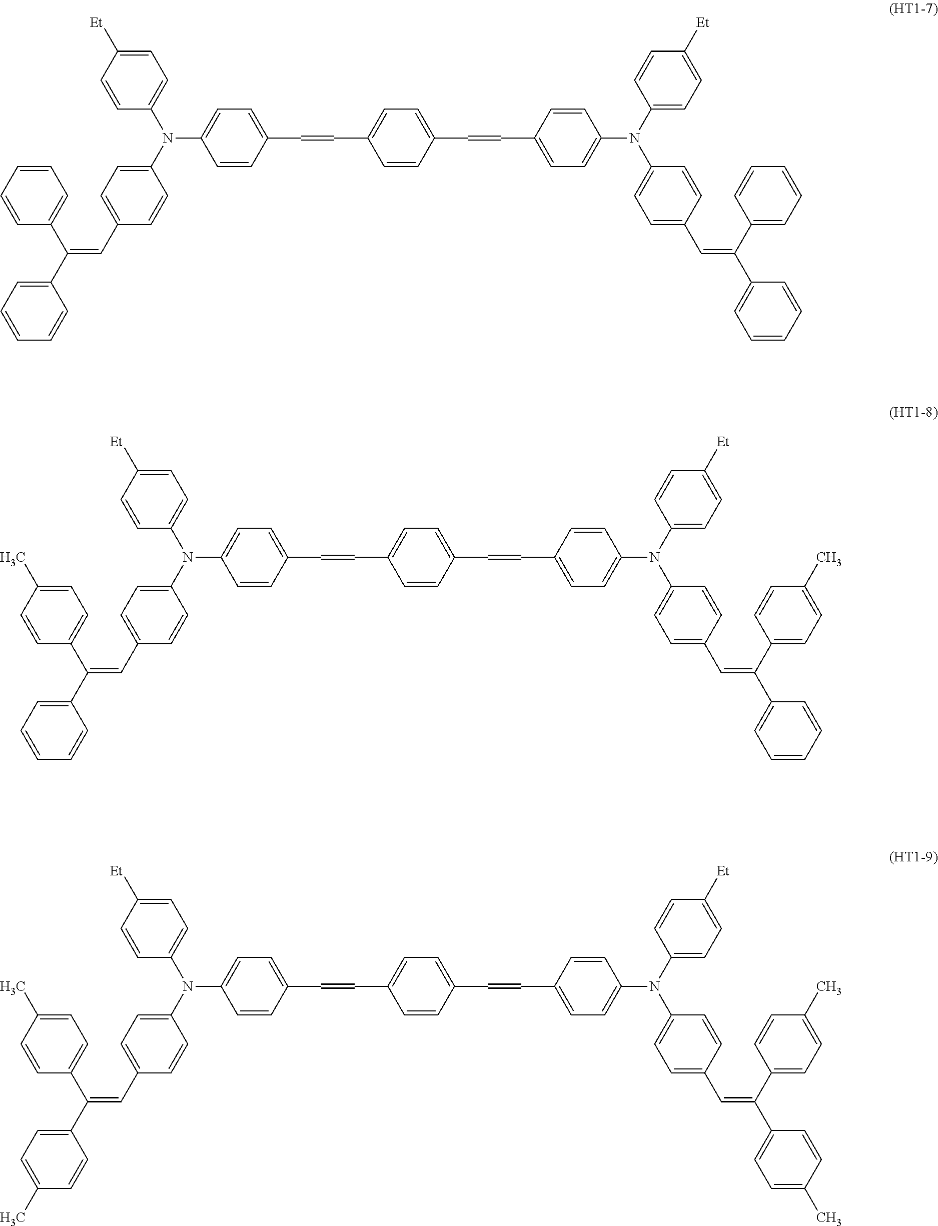

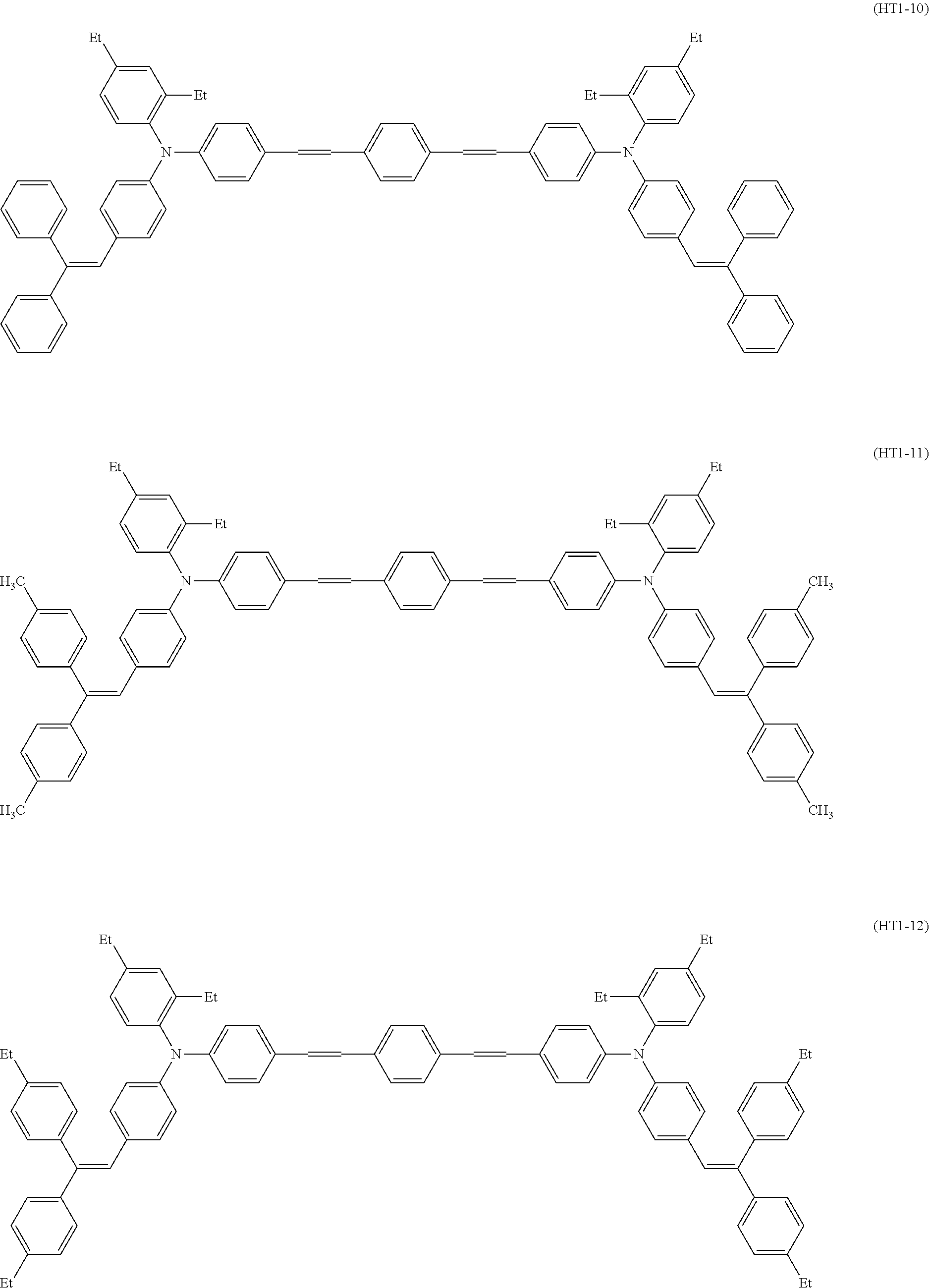

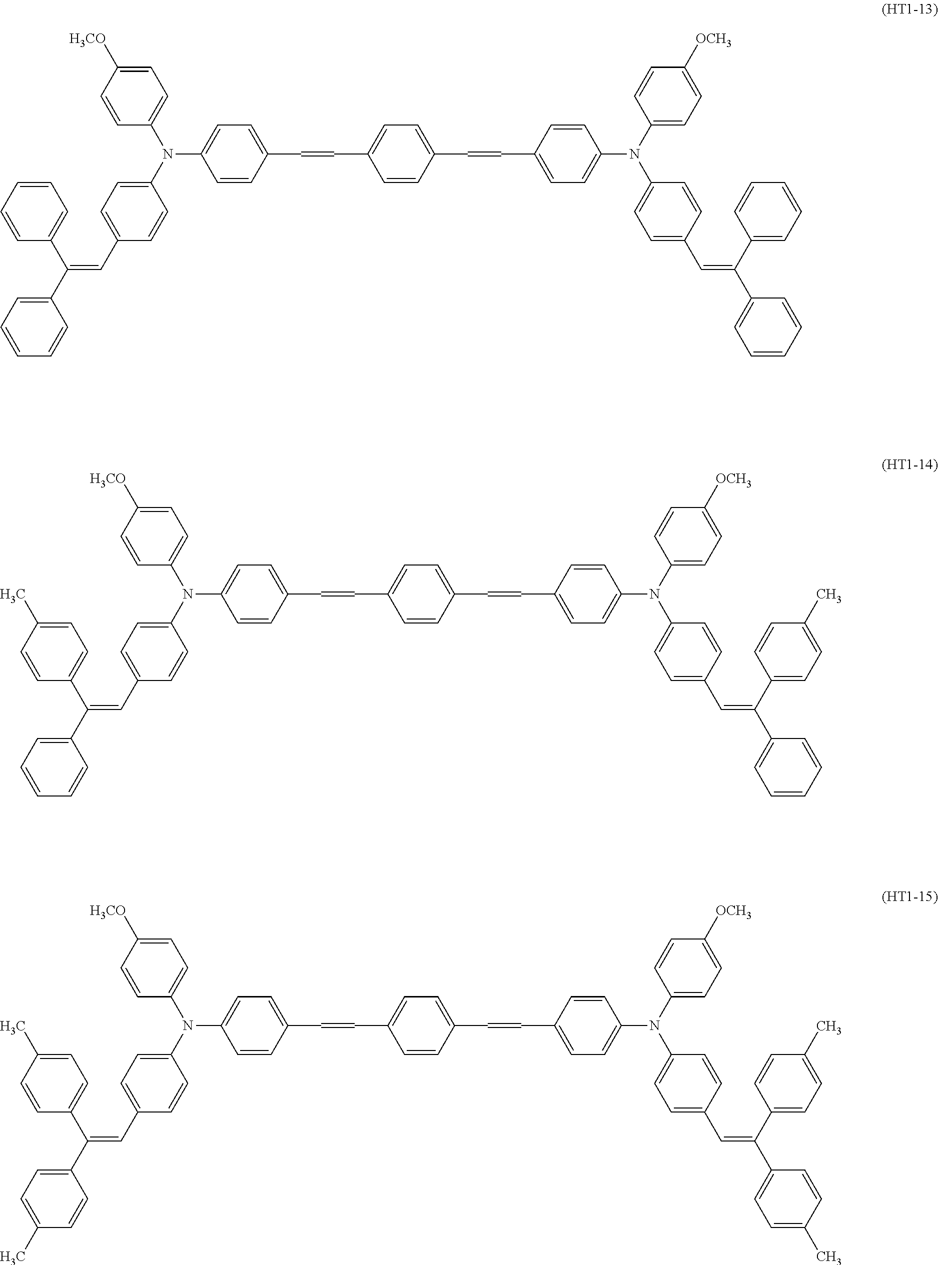

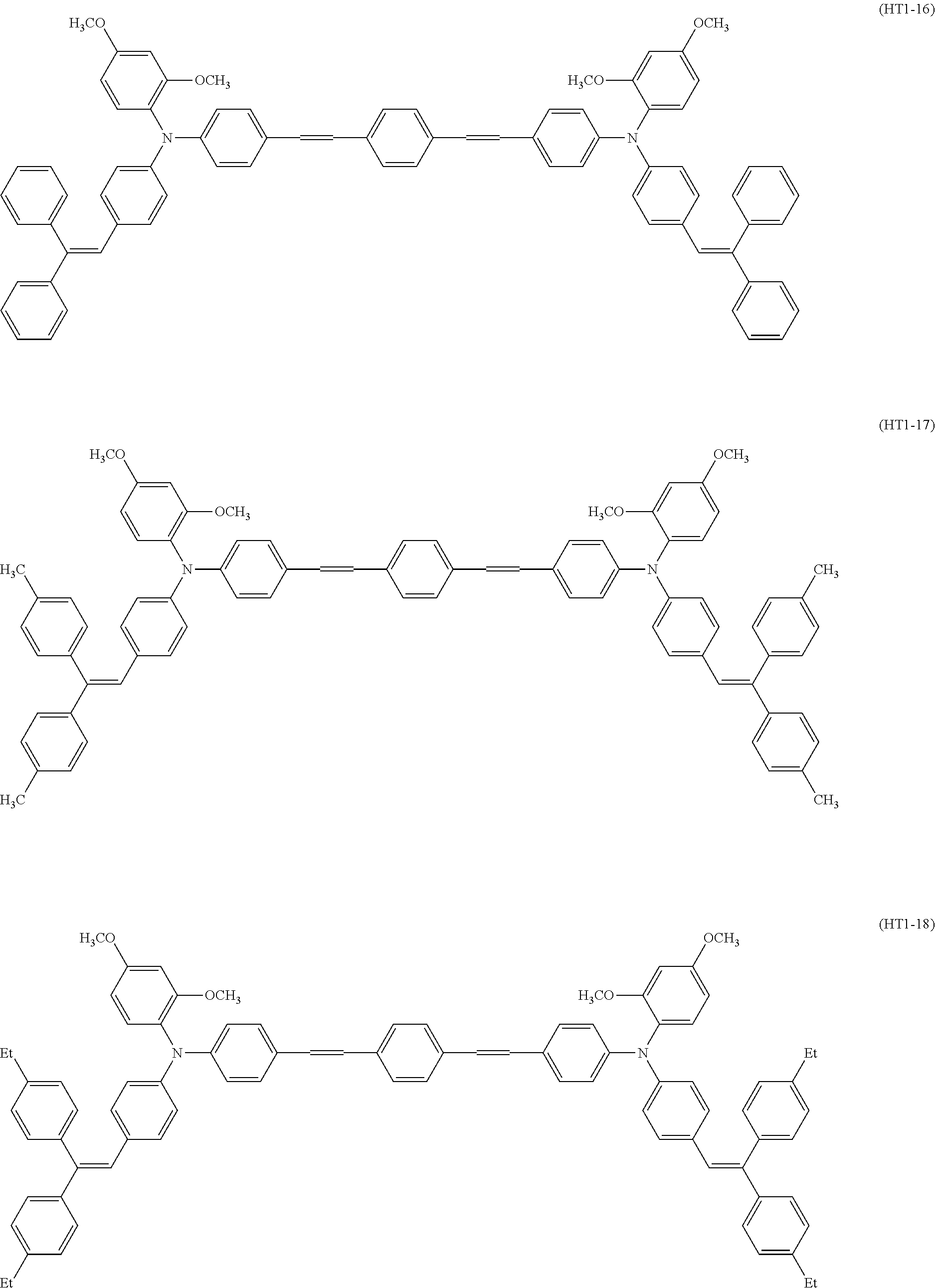

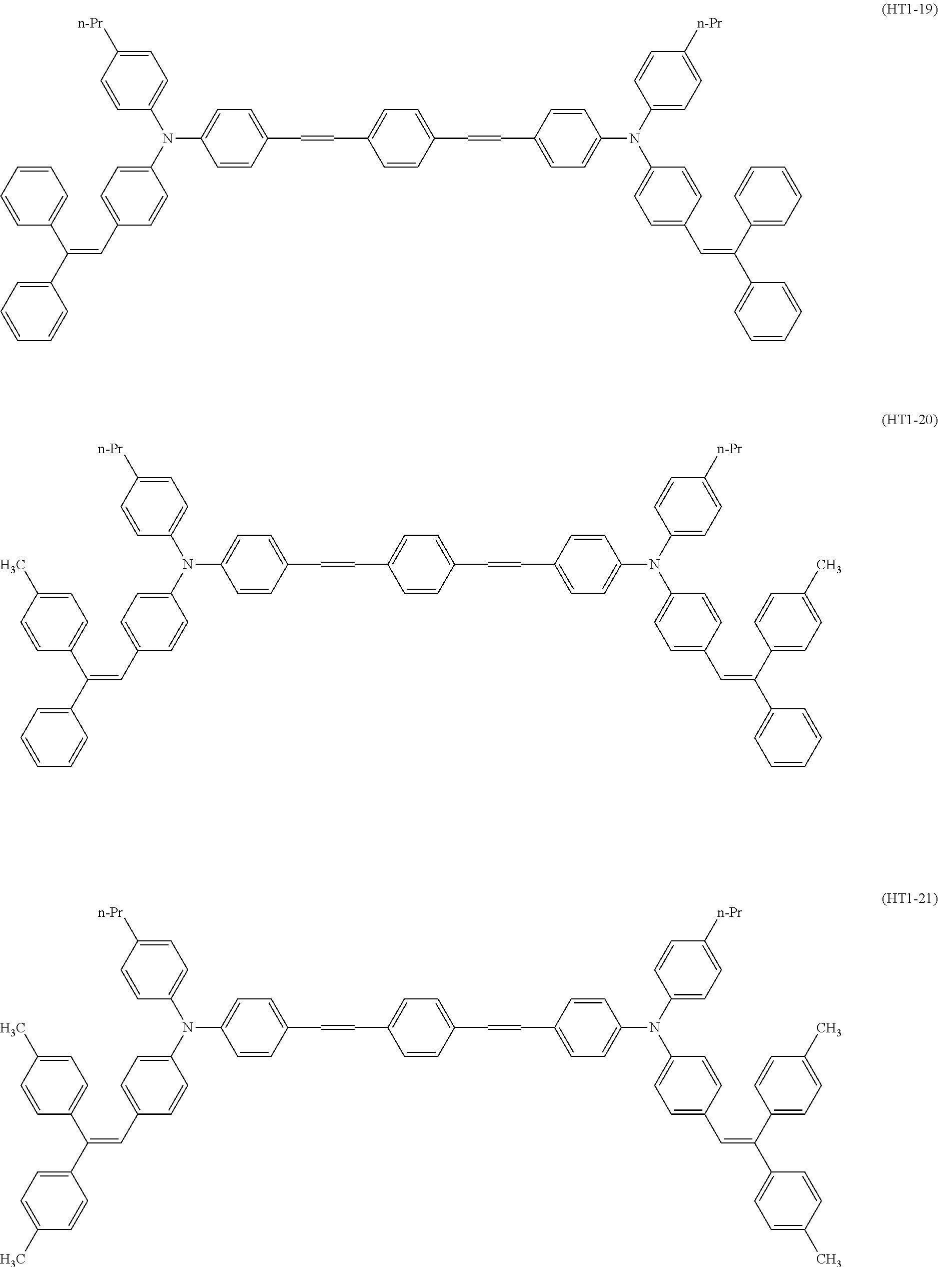

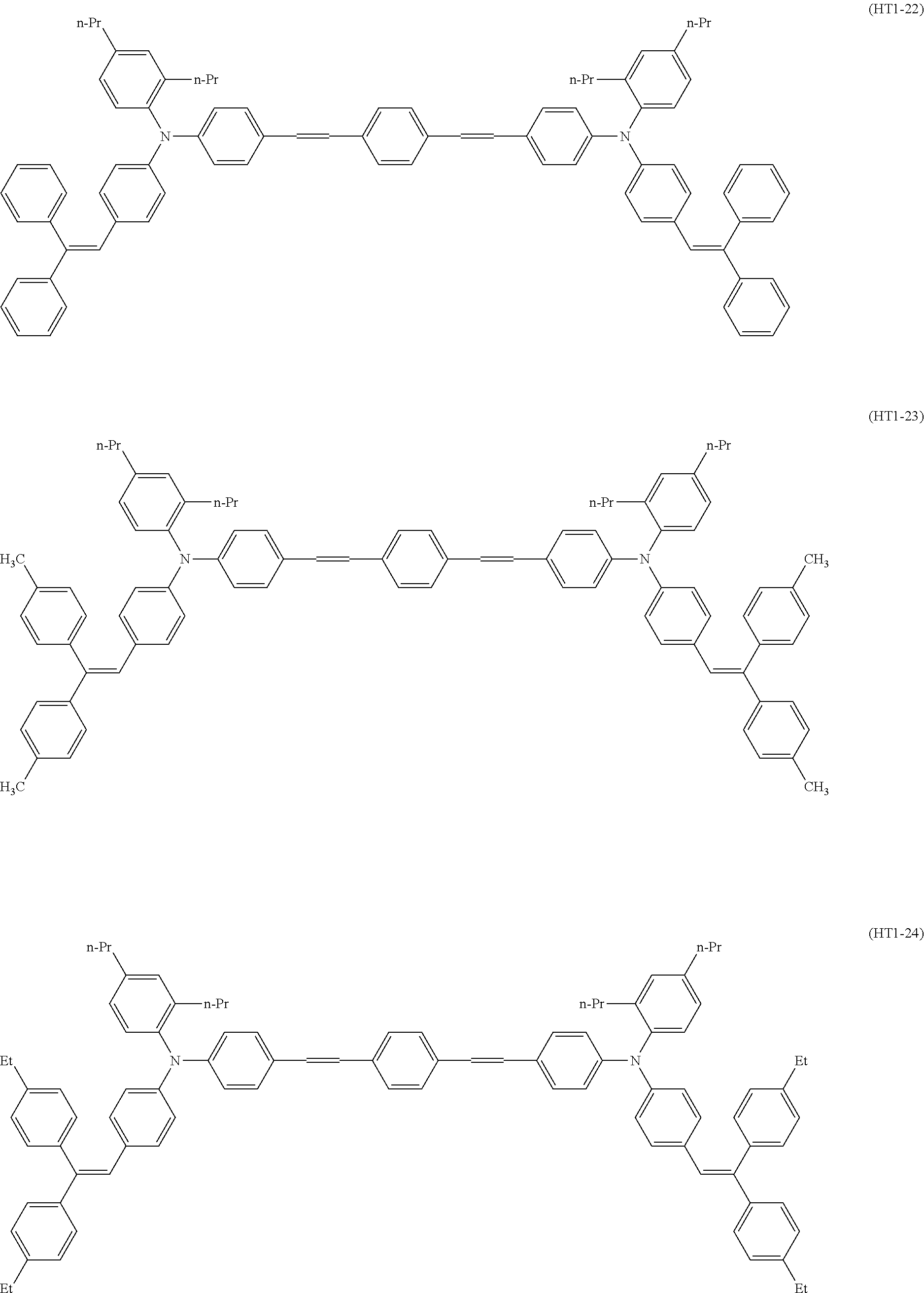

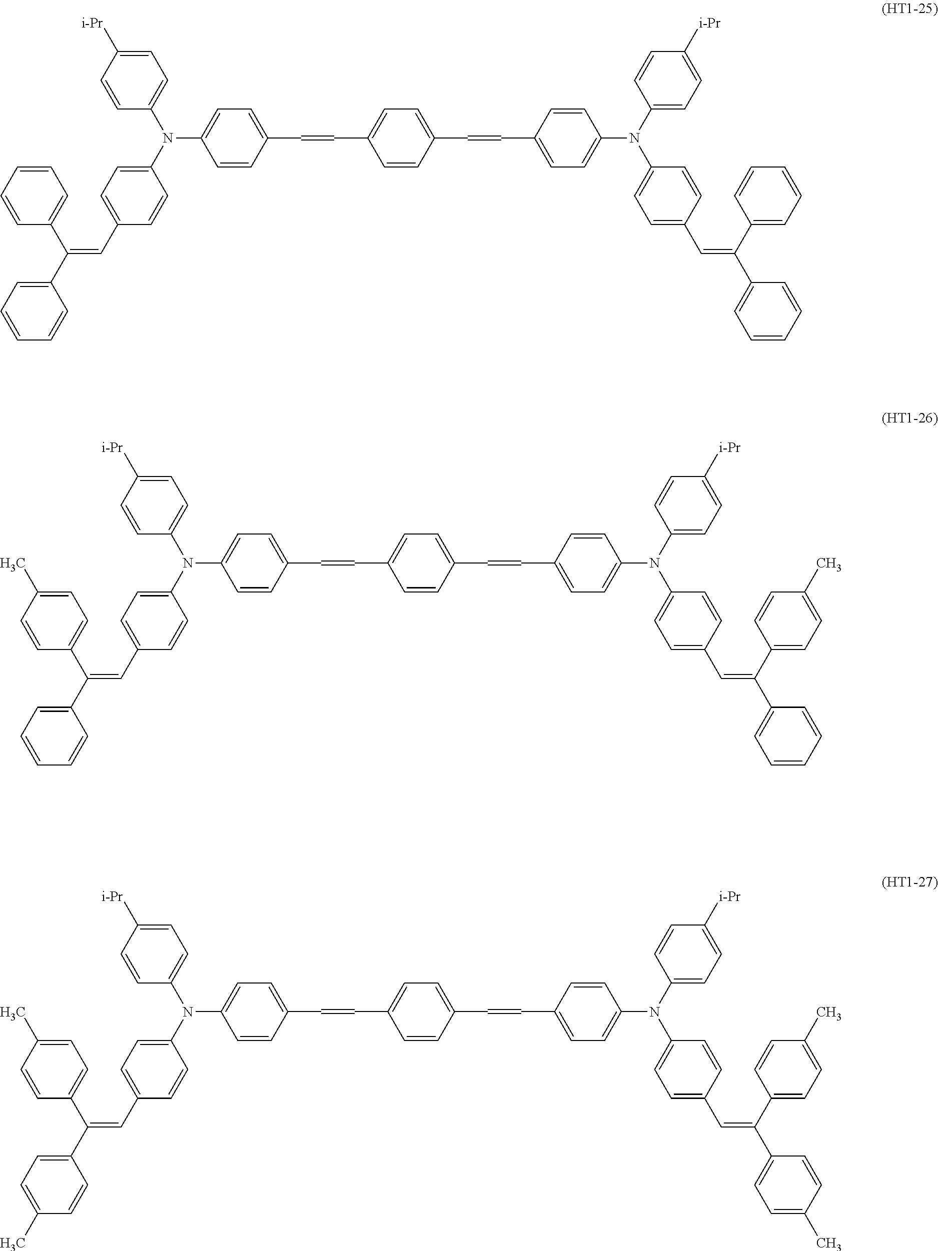

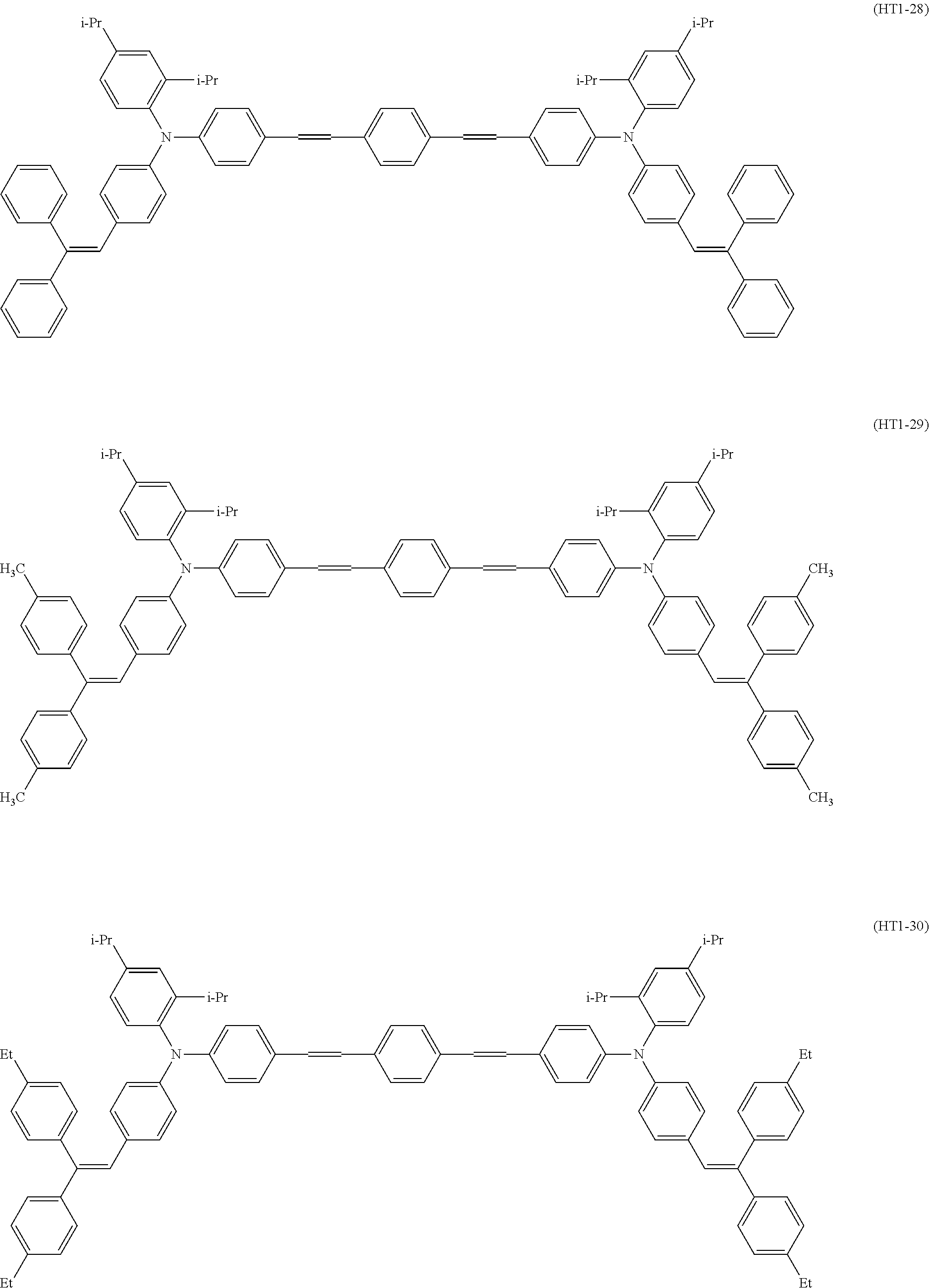

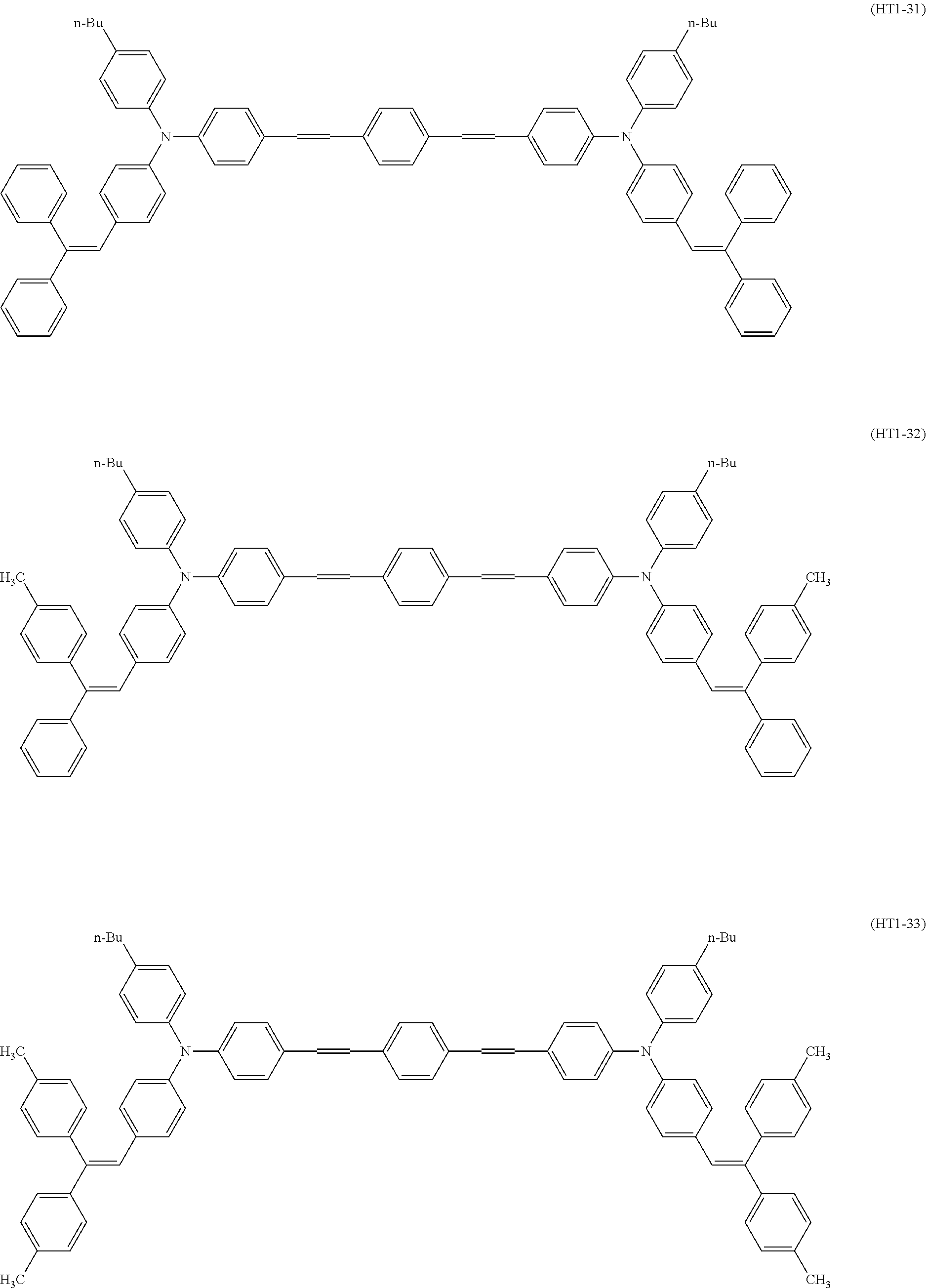

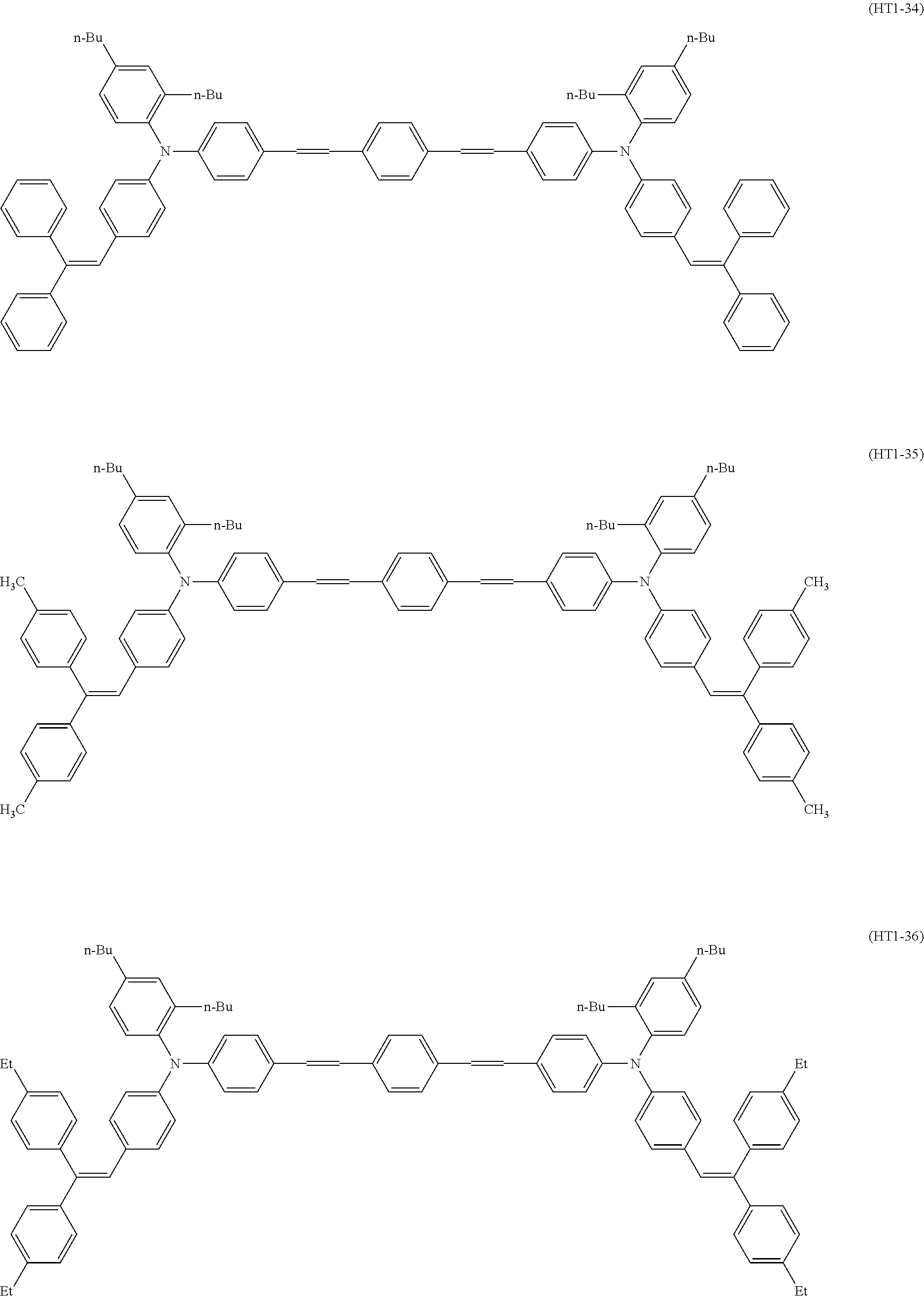

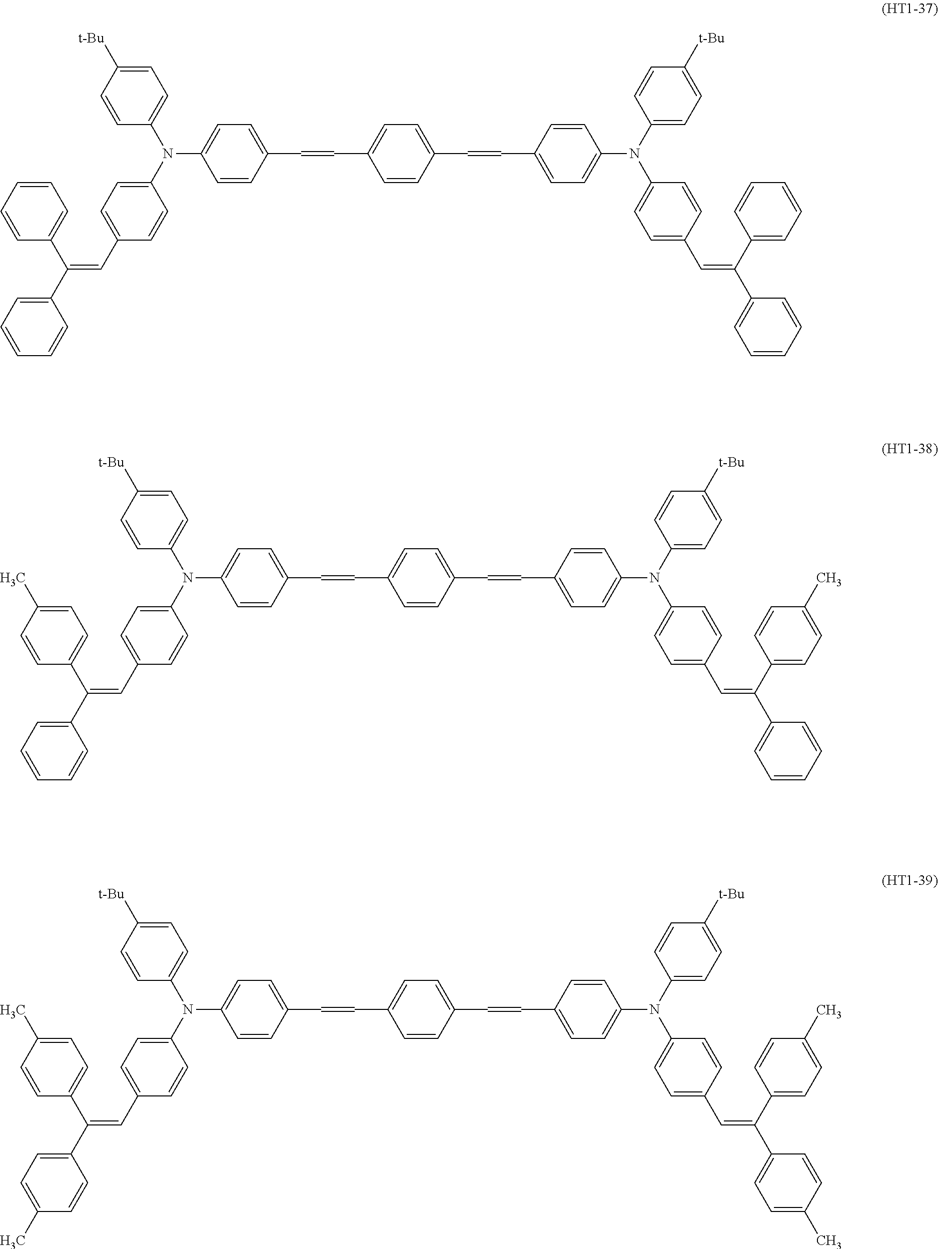

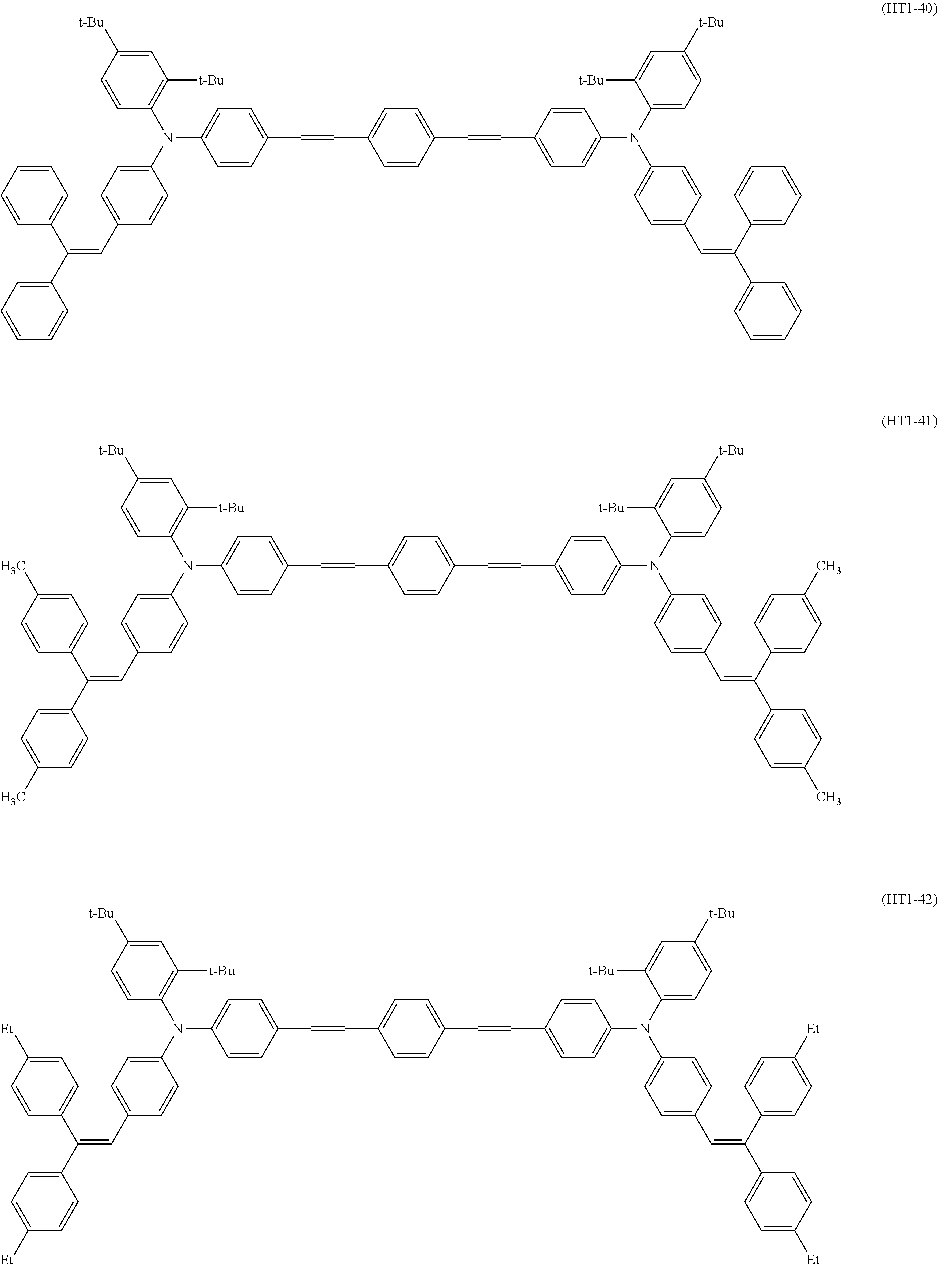

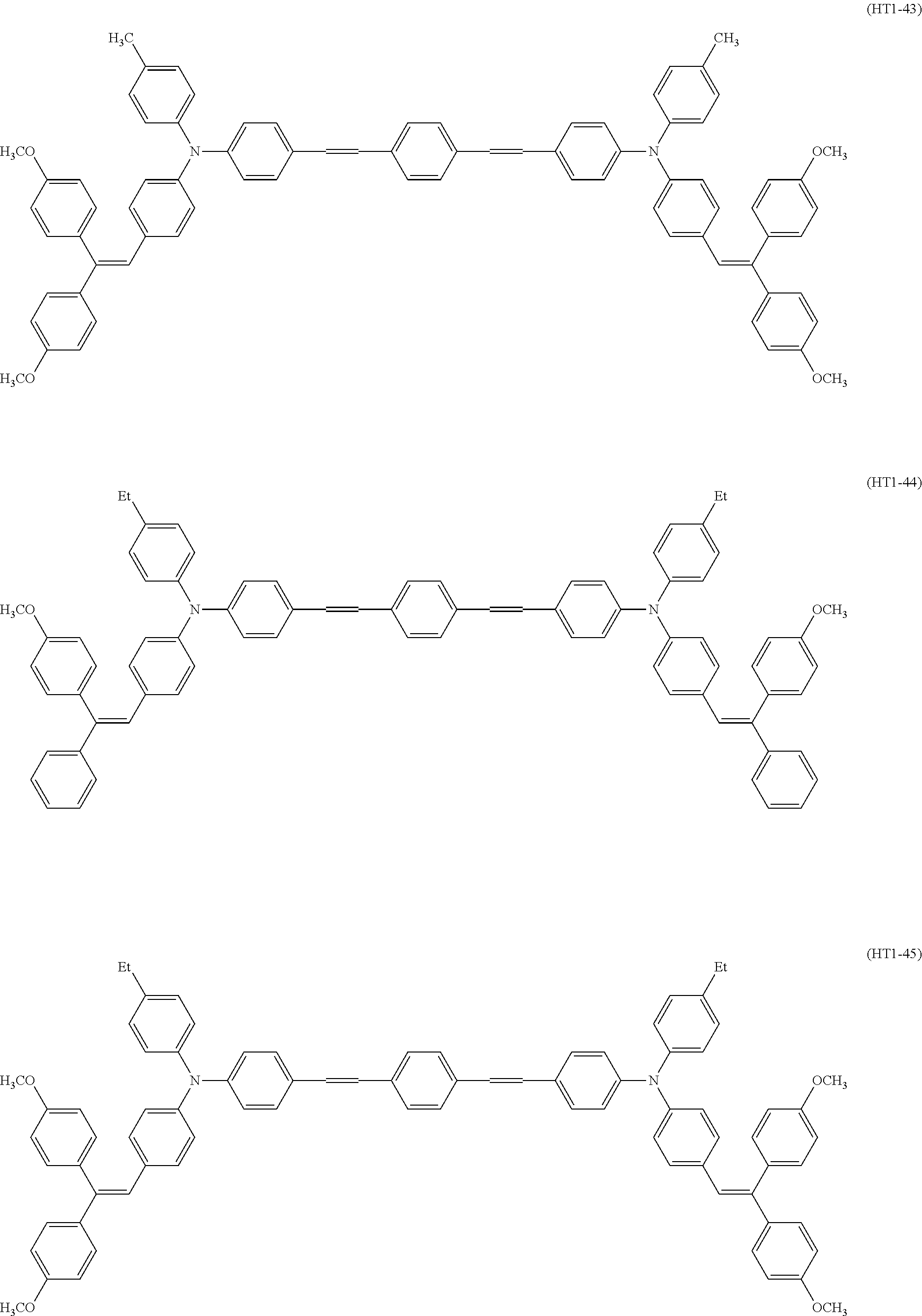

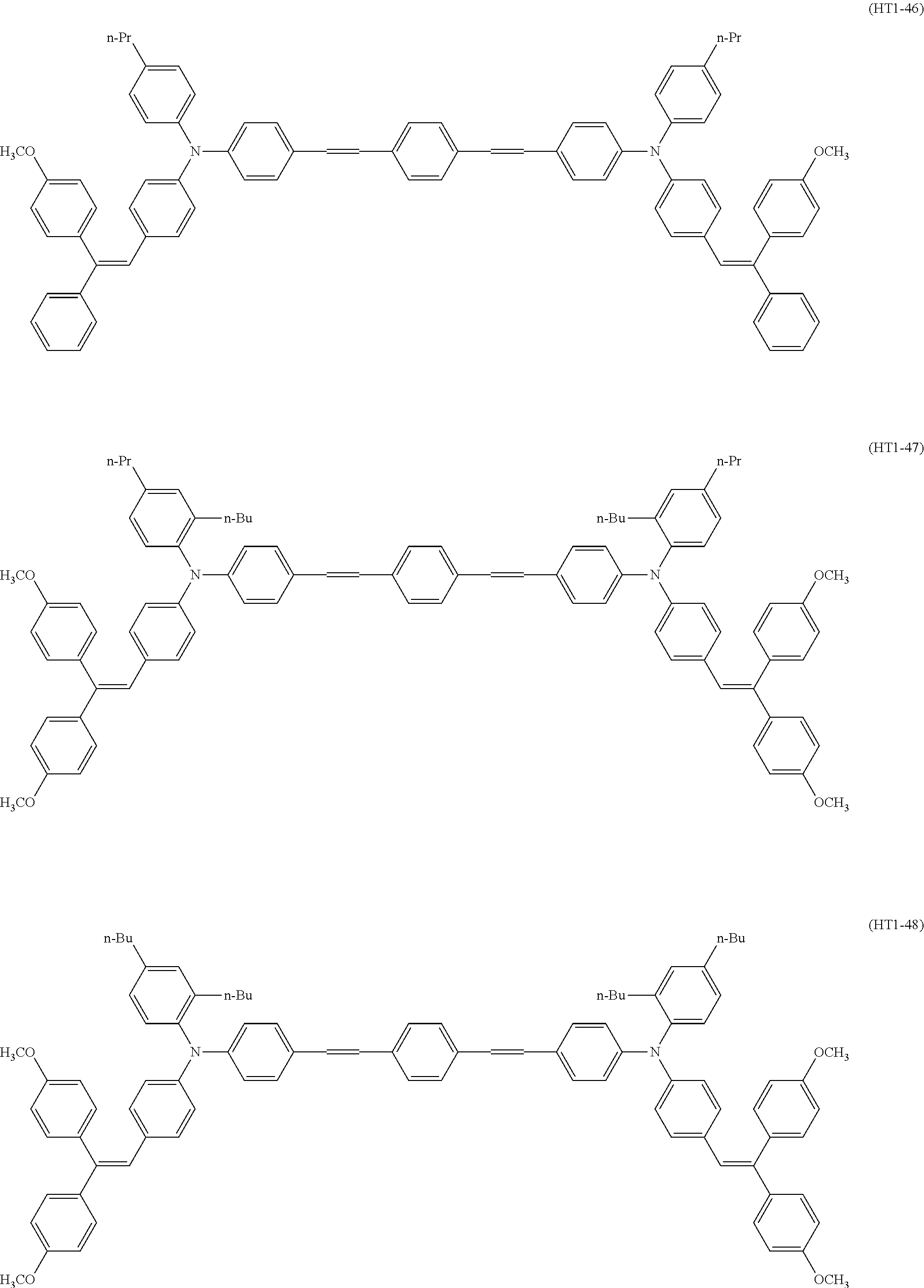

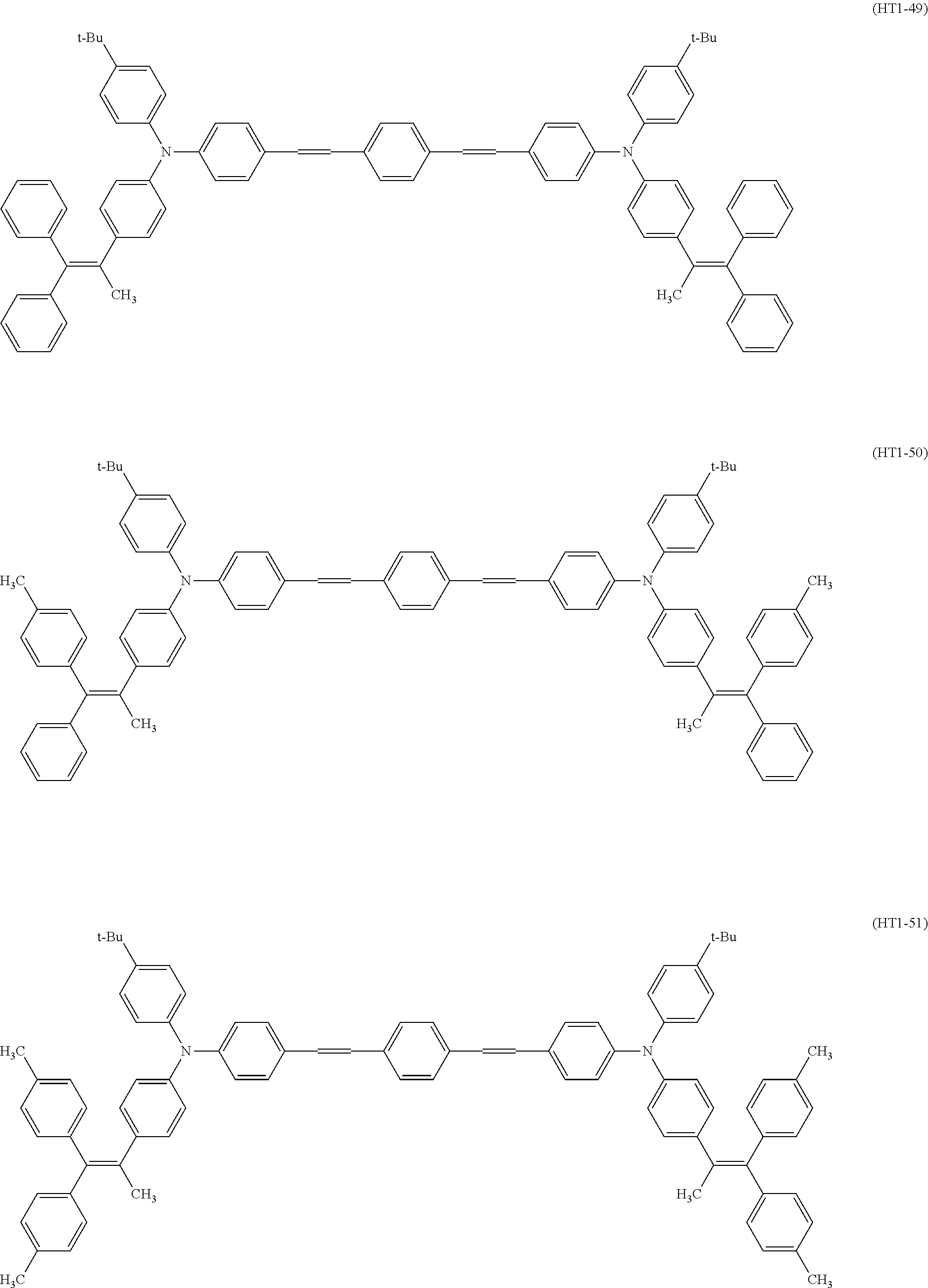

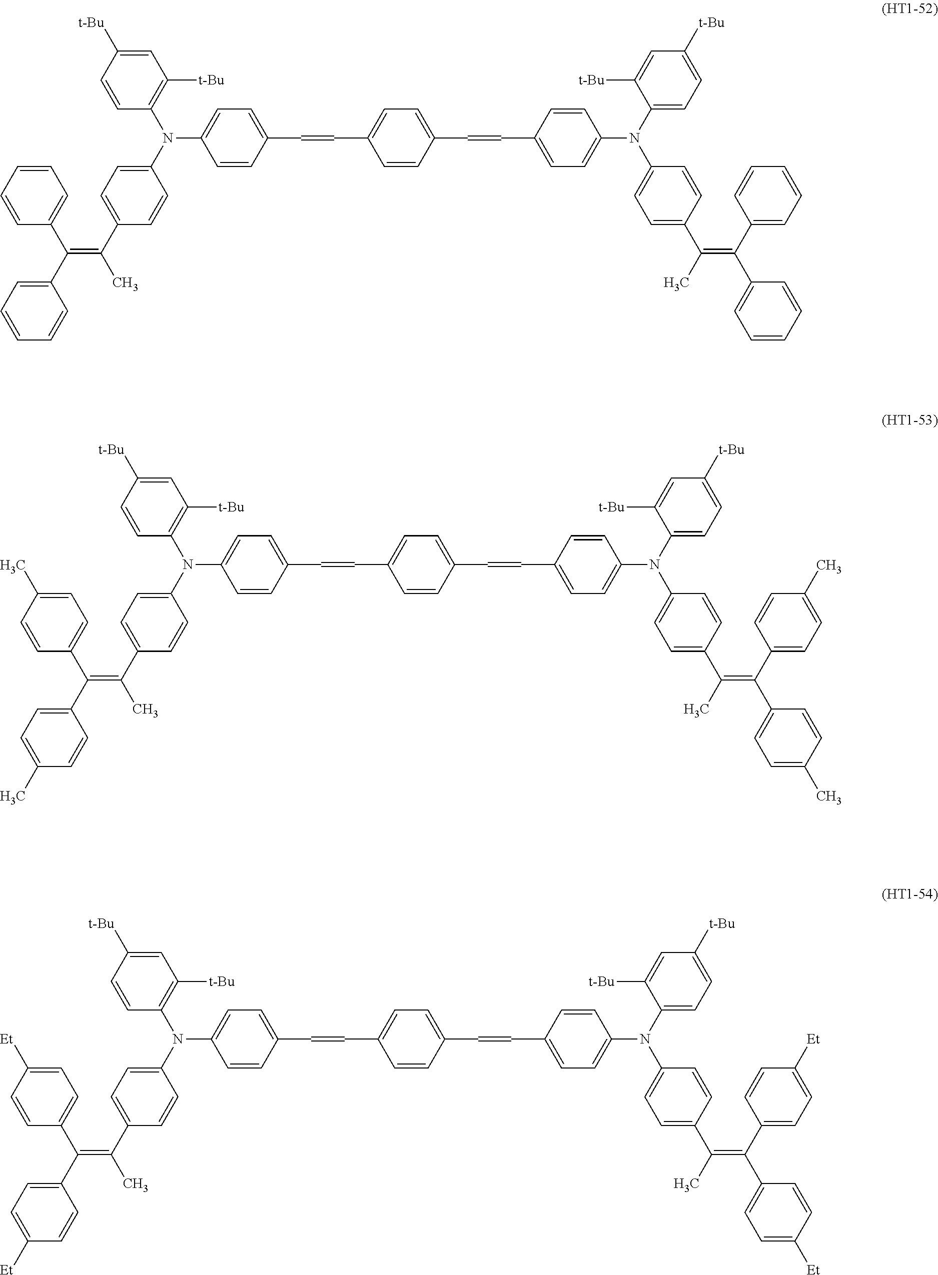

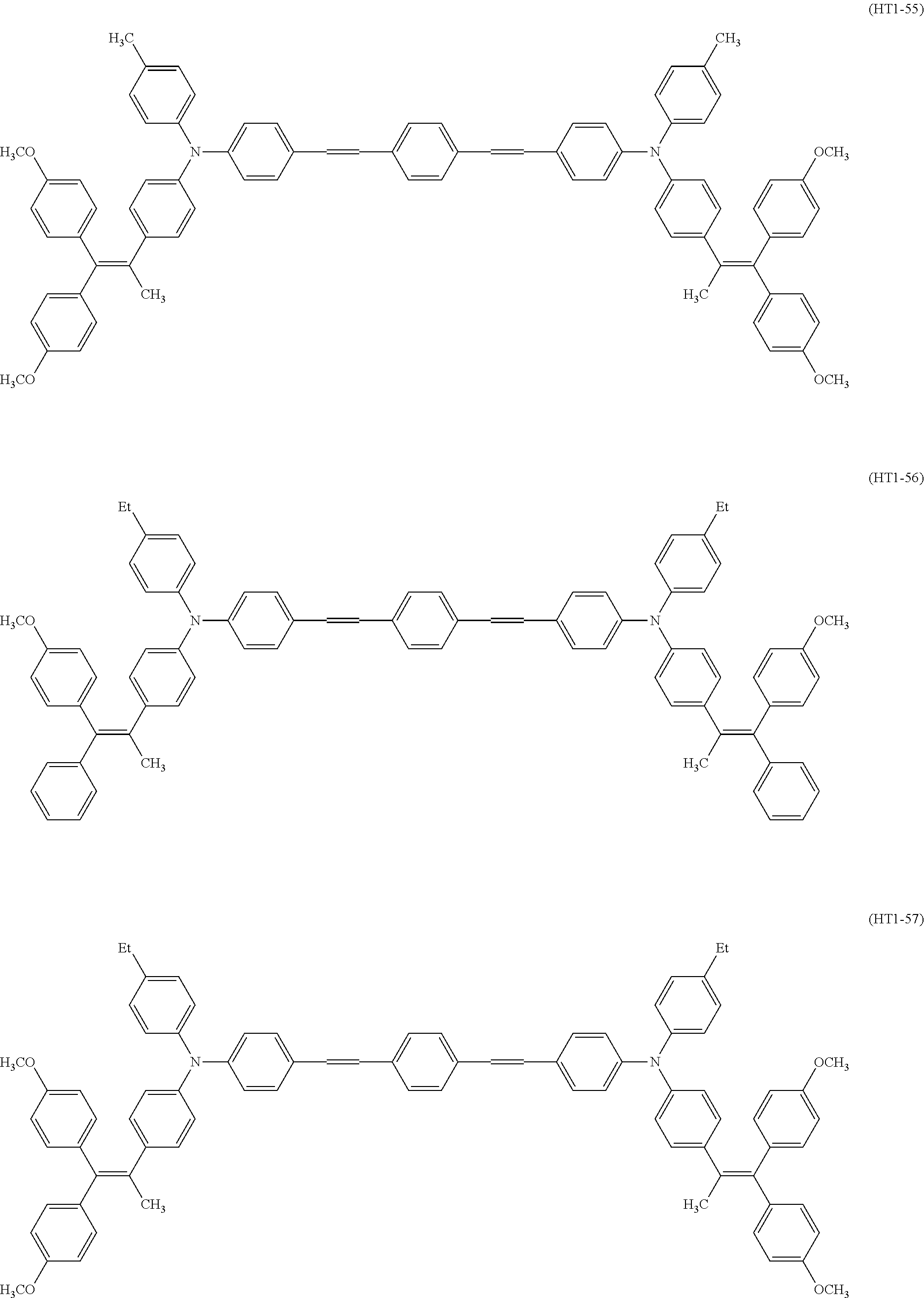

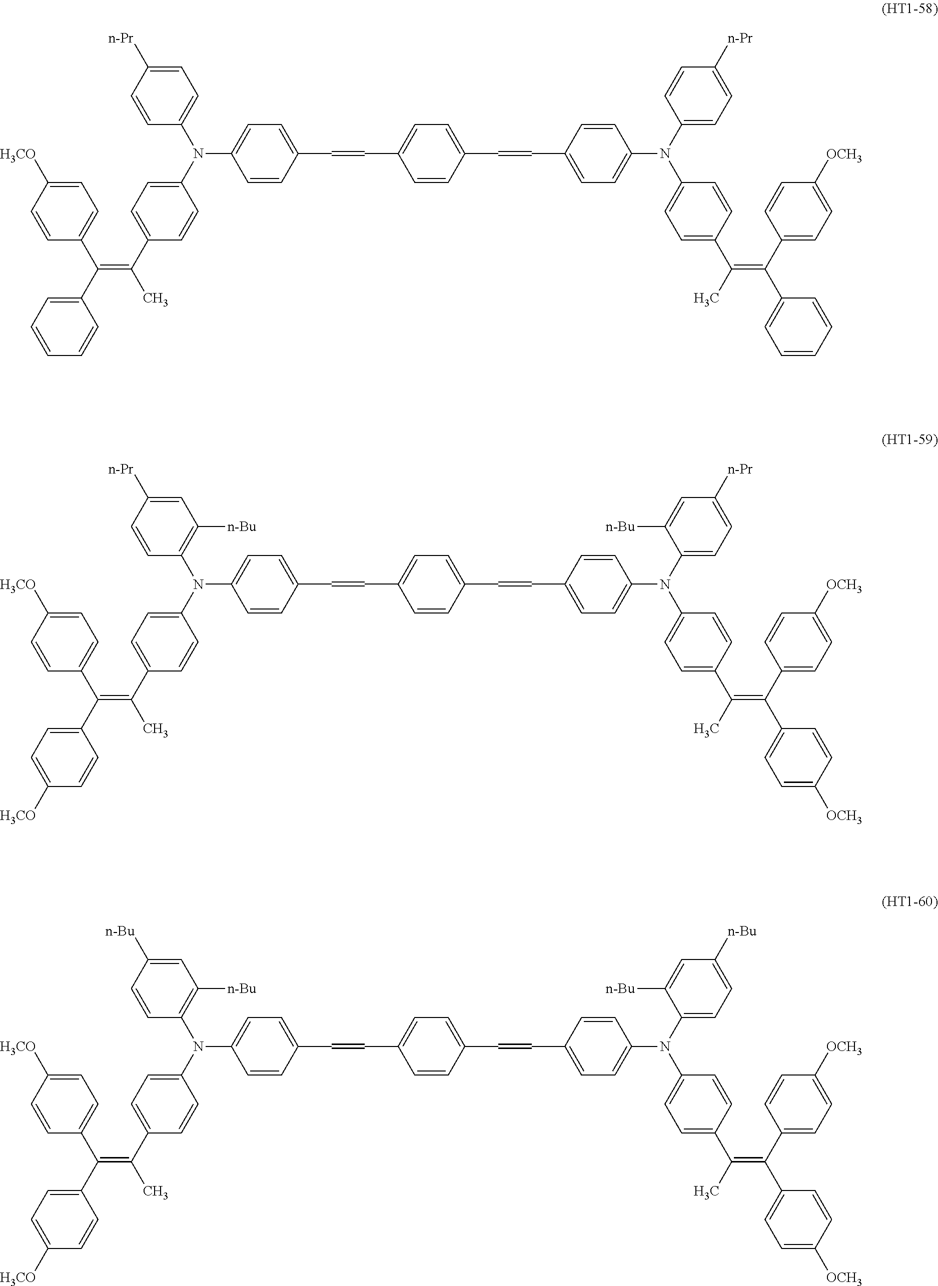

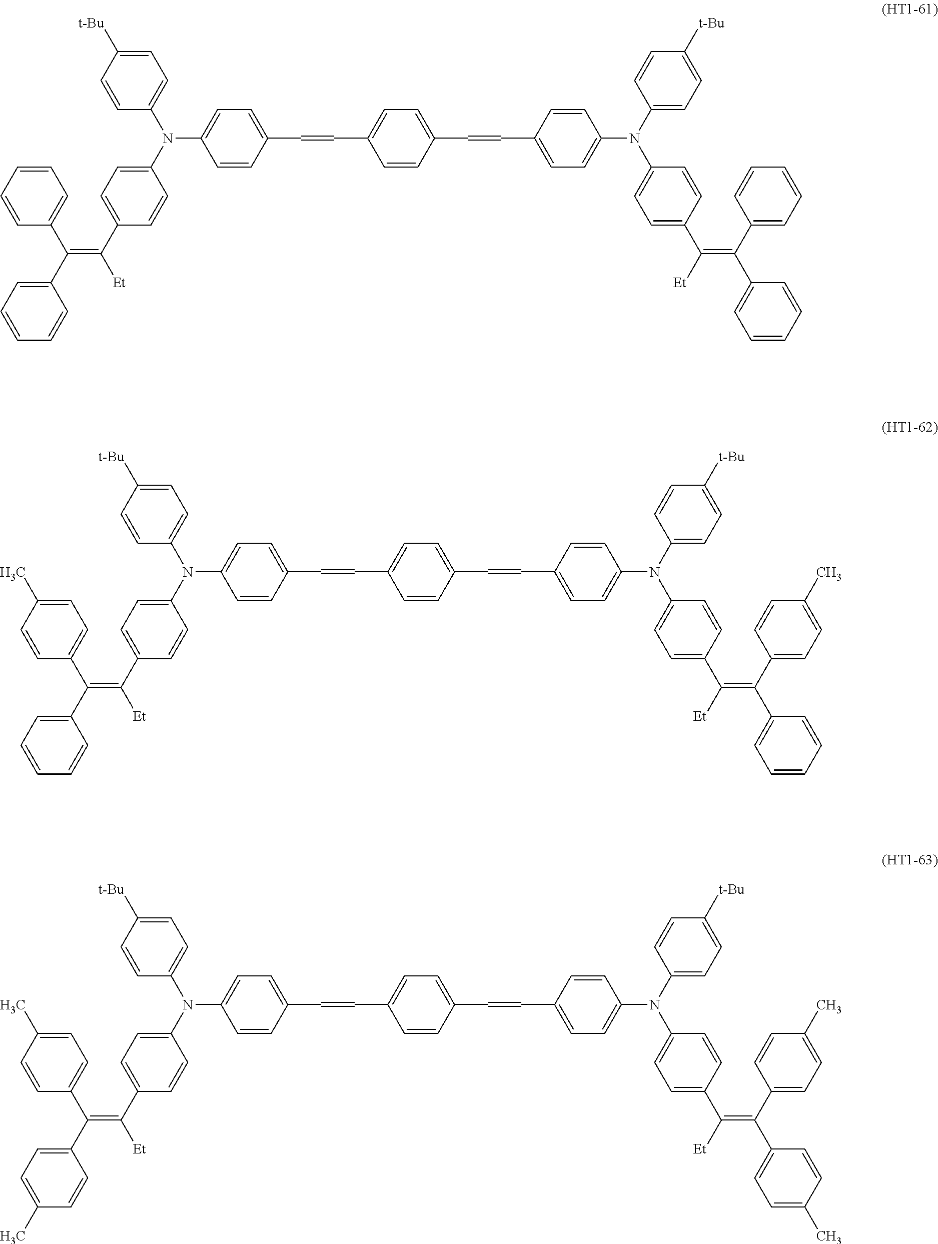

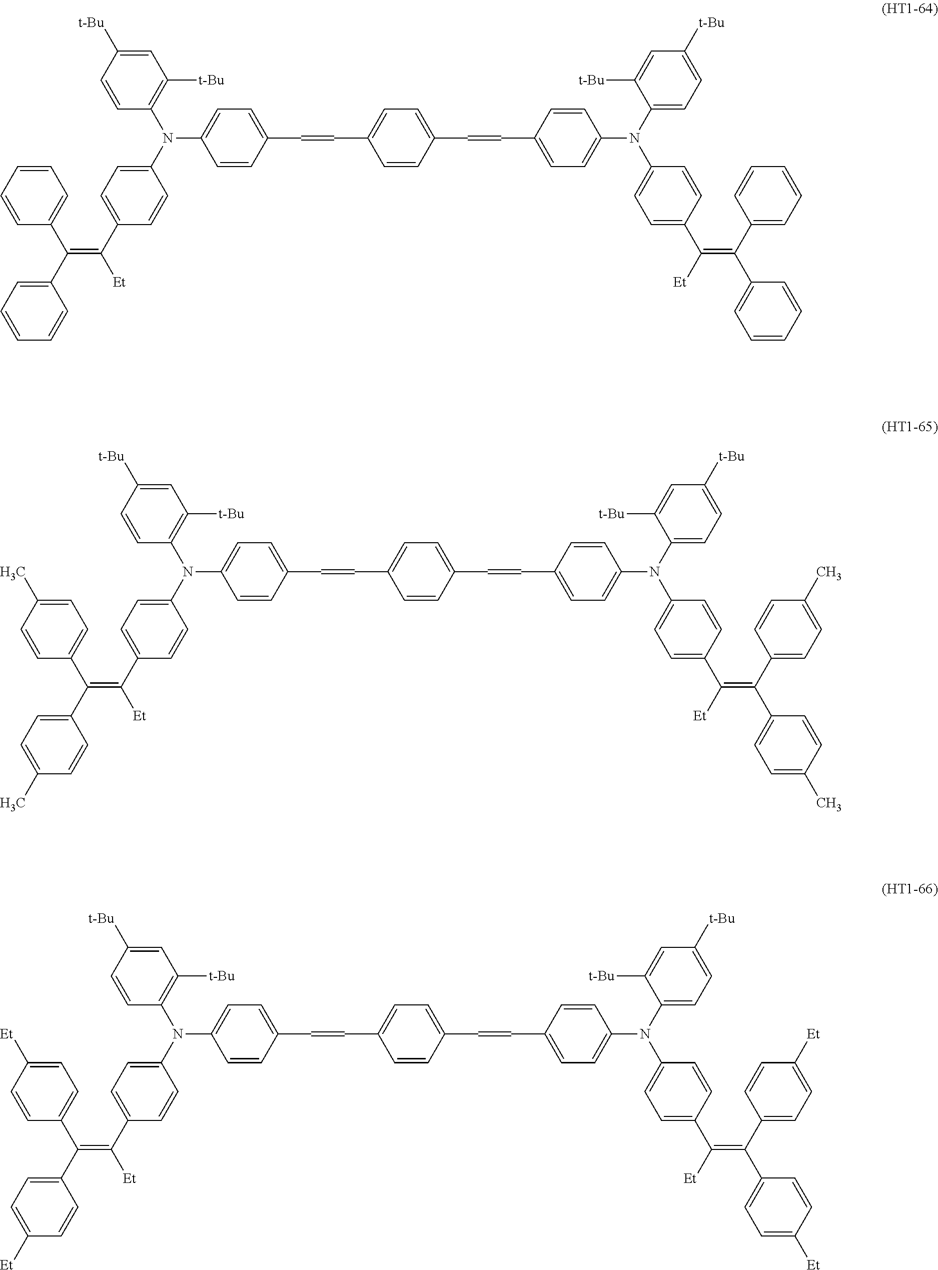

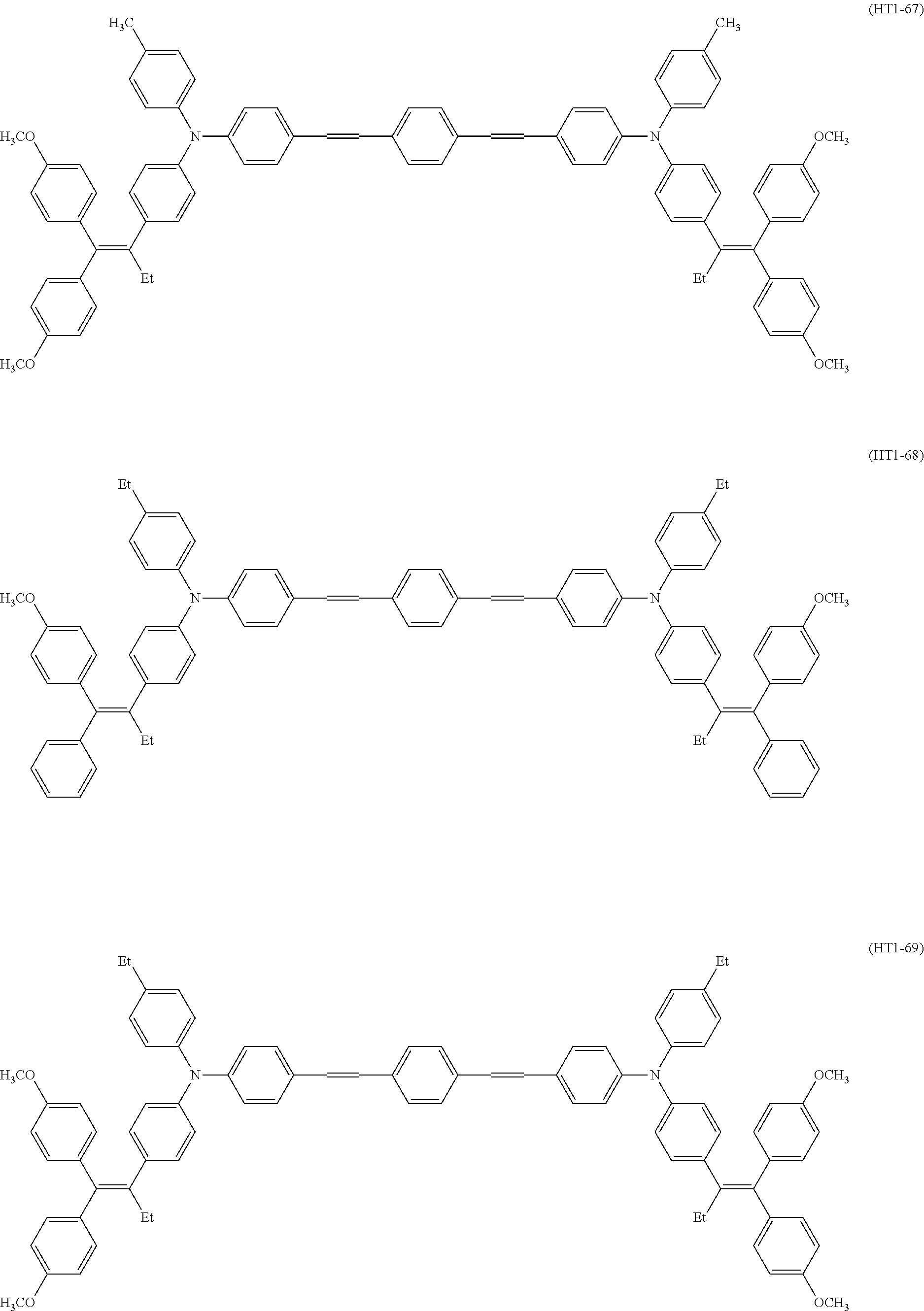

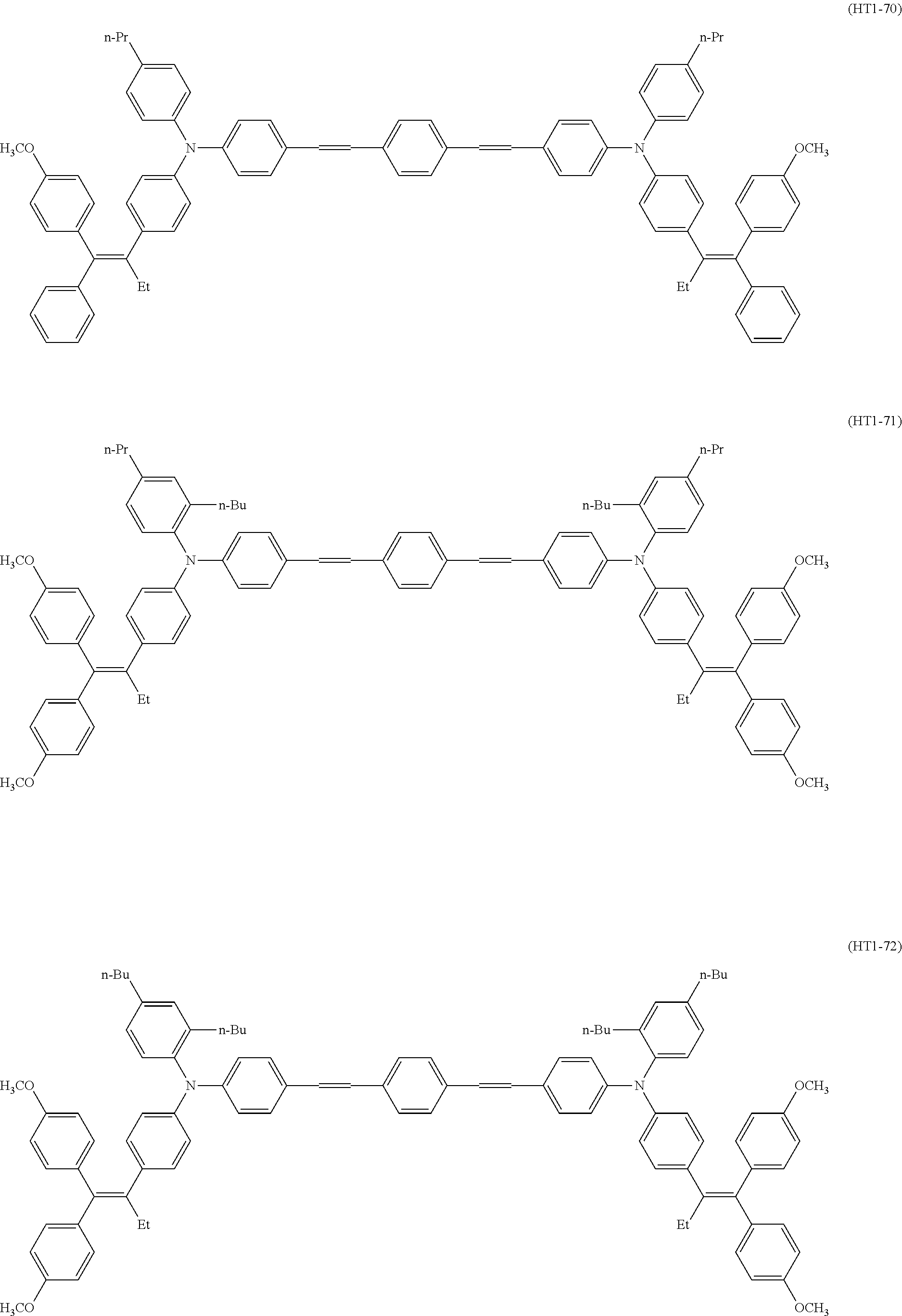

Specific examples of the hole transport material further include the following compounds.

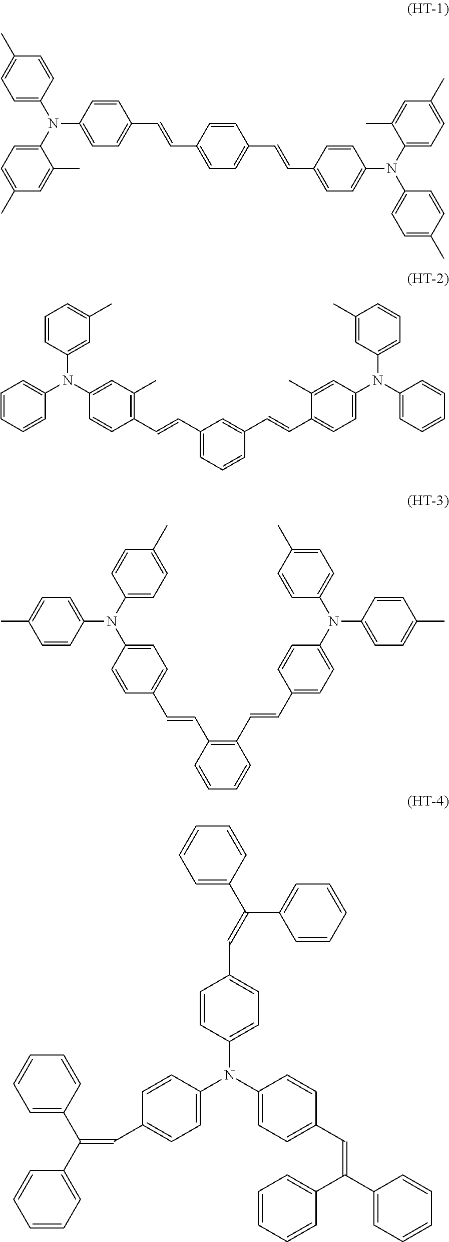

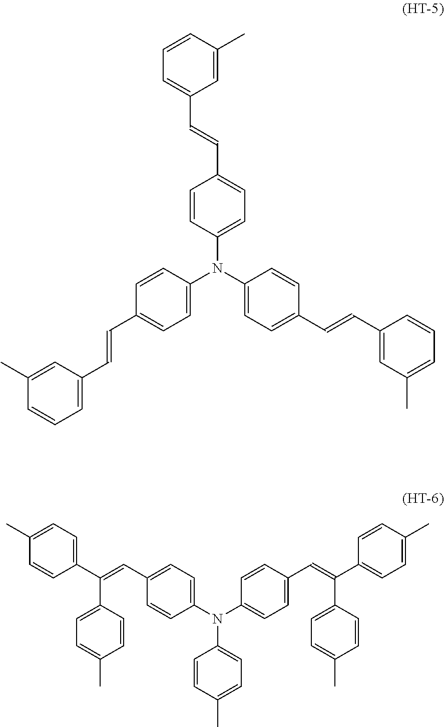

As the first resin binder of the charge transport layer 3 and the second resin binder of the charge generation layer 4, various polycarbonate resins, such as bisphenol A type, bisphenol Z type, bisphenol A type-biphenyl copolymer, and bisphenol Z type-biphenyl copolymer, polyphenylene resin, polyester resin, polyvinyl acetal resin, polyvinyl butyral resin, polyvinyl alcohol resin, vinyl chloride resin, vinyl acetate resin, polyethylene resin, polypropylene resin, acrylic resin, polyurethane resin, epoxy resin, melamine resin, silicone resin, polyamide resin, polystyrene resin, polyacetal resin, polyarylate resin, polysulfone resin, polymers of methacrylic acid esters, and copolymers thereof, and the like are usable. Further, resins of the same kind with different molecular weights may be mixed for use.

Examples of suitable resin binders include resins having a repeating unit represented by General Formula (BD1) below. More specific examples of suitable resin binders include polycarbonate resins having repeating units represented by Structural Formulae (BD1-1) to (BD1-3) below.

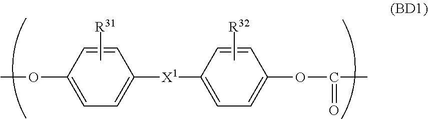

(In General Formula (BD1) above, R³¹ and R³² each are a hydrogen atom, a methyl group, or an ethyl group, X¹ is an oxygen atom, a sulfur atom, or —CR³³R³⁴, R³³ and R³⁴ each are a hydrogen atom, an alkyl group having 1 to 4 carbon atoms, or a phenyl group which may have a substituent, or R³³ and R³⁴ may be cyclically combined to form a cycloalkyl group having 4 to 6 carbon atoms which may have a substituent, and R³³ and R³⁴ may be the same or different.)

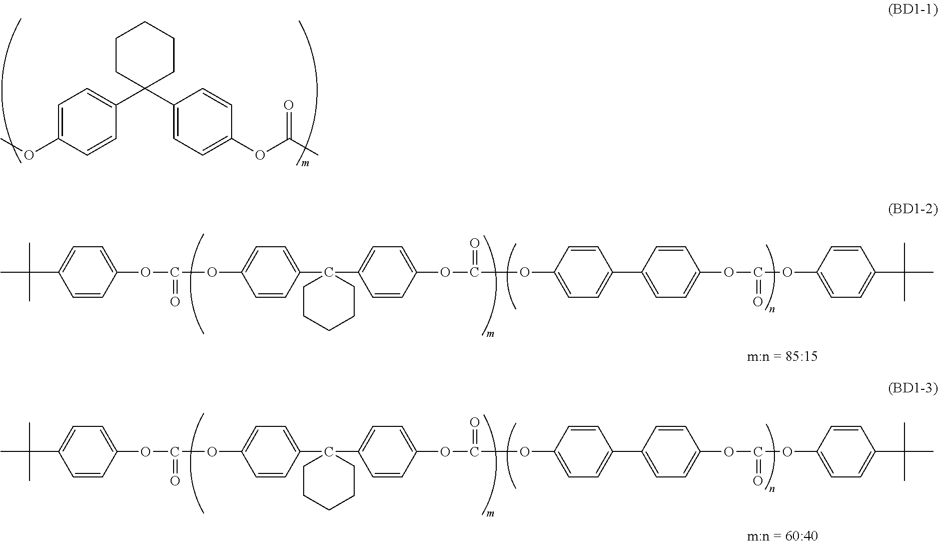

The charge generation material of the charge generation layer 4 is not particularly limited, and can be appropriately selected from known materials for use. Specifically, the charge generation material is not particularly limited insofar as materials have photosensitivity to the wavelength of an exposure light source. For example, organic pigments, such as phthalocyanine pigments, azo pigments, quinacridone pigments, indigo pigments, perylene pigments, perinone pigments, squarylium pigments, thiapyrylium pigments, polycyclic quinone pigments, anthanthrone pigments, and benzimidazole pigments, are usable. In particular, examples of the phthalocyanine pigments include metal-free phthalocyanine, titanyl phthalocyanine, chlorogallium phthalocyanine, hydroxygallium phthalocyanine, and copper phthalocyanine; and examples of the azo pigments include disazopigments and trisazopigments; and examples of the perylene pigments include N,N′-bis(3, 5-dimethylphenyl)-3,4:9,10-perylene-bis(carboximide). Among the above, metal-free phthalocyanine or titanyl phthalocyanine is preferably used and titanyl phthalocyanine is more preferably used. As the metal-free phthalocyanine, X-type metal-free phthalocyanine, τ-type metal-free phthalocyanine, and the like are usable, for example. As titanyl phthalocyanine, α-type titanyl phthalocyanine, β-type titanyl phthalocyanine, Y-type titanyl phthalocyanine, amorphous-type titanyl phthalocyanine, titanyl phthalocyanine with a Bragg angle 2θ of 9.6° in a CuKα: X-ray diffraction spectrum as the maximum peak described in JPH8-209023A, U.S. Pat. Nos. 5,736,282, and 5,874,570, and the like are usable. In an electrophotographic photoreceptor used in recent high speed printing devices, i.e., monochrome high speed machines (in particular, printing devices mounted with a cylindrical electrophotographic photoreceptor with a printing speed of 50 ppm or more and a diameter of 30 mm) or middle and high speed tandem color machines (in particular, printing devices mounted with a cylindrical electrophotographic photoreceptor with a printing speed 30 ppm or more and a diameter of 24 mm), the titanyl phthalocyanine above having sufficient sensitivity to a low exposure energy is suitable to increase the printing speed. As the charge generation material, one kind of the substances above can be used or two or more kinds thereof may be used in combination.

The electron transport material of the charge generation layer 4 is not particularly limited, and, for example, succinic anhydride, maleic anhydride, dibromosuccinic anhydride, phthalic anhydride, 3-nitrophthalic anhydride, 4-nitrophthalic anhydride, pyromellitic anhydride, pyromellitic acid, trimellitic acid, trimellitic anhydride, phthalimide, 4-nitrophthalimide, tetracyanoethylene, tetracyanoquinodimethane, chloranyl, bromanyl, o-nitrobenzoic acid, malononitrile, trinitrofluorenone, trinitrothioxanthone, dinitrobenzene, dinitroanthracene, dinitroacridine, nitroanthraquinone, dinitroanthraquinone, a thiopyran compound, a quinone compound, a benzoquinone compound, a diphenoquinone compound, a naphthoquinone compound, an anthraquinone compound, a stilbenequinone compound, an azoquinone compound, a naphthalenetetracarboxylic acid diimide compound, and the like are usable.

In particular, as the electron transport material, those with electron mobility when the electric field strength is 20 V/μm of 15×10⁻⁸ [cm²/V·s] or more and particularly 17×10⁻⁸ to 35×10⁻⁸ [cm²/V·s] are preferably used. Herein, the electron mobility can be measured using a test sample prepared by a coating solution obtained by adding the electron transport material into the resin binder to have a proportion of 50% by mass. The ratio between the electron transport material and the resin binder is 50:50. The resin binder may be a bisphenol Z -type polycarbonate resin. For example, Iupizeta PCZ-500 (trade name, manufactured by Mitsubishi Gas Chemical Company, Inc.) may be used. Specifically, this coating solution is applied onto a base material and dried at 120° C. for 30 minutes to prepare a coating film with a film thickness 7 μm, and the electron mobility at a constant electric field strength of 20 V/μm can be measured using a Time of Flight (TOF) method. The measurement temperature is 300 K.

Further, as the electron transport material, an azoquinone compound having a structure represented by General Formula (ET1) below or a naphthalenetetracarboxylic acid diimide compound having a structure represented by General Formula (ET2) below is preferably used.

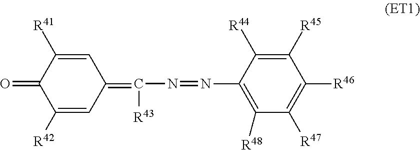

(In General Formula (ET1), R⁴¹, R⁴² are the same or different and represent a hydrogen atom, an alkyl group having 1 to 12 carbon atoms, an alkoxy group having 1 to 12 carbon atoms, an aryl group which may have a substituent, a cycloalkyl group, an aralkyl group which may have substituent, or a halogenated alkyl group, R⁴³ represents a hydrogen atom, an alkyl group having 1 to 6 carbon atoms, an alkoxy group having 1 to 6 carbon atoms, an aryl group which may have substituent, a cycloalkyl group, an aralkyl group which may have a substituent, or a halogenated alkyl group, R⁴⁴ to R⁴⁸ are the same or different and represent a hydrogen atom, a halogen atom, an alkyl group having 1 to 12 carbon atoms, an alkoxy group having 1 to 12 carbon atoms, an aryl group which may have a substituent, an aralkyl group which may have a substituent, a phenoxy group which may have a substituent, a halogenated alkyl group, a cyano group, or a nitro group, or two or more groups may be combined to form a ring, and a substituent represents a halogen atom, an alkyl group having 1 to 6 carbon atoms, an alkoxy group having 1 to 6 carbon atoms, a hydroxyl group, a cyano group, an amino group, a nitro group, or a halogenated alkyl group.)

Specific examples of the azoquinone compound having the structure represented by General Formula (ET1) above include the following substances.

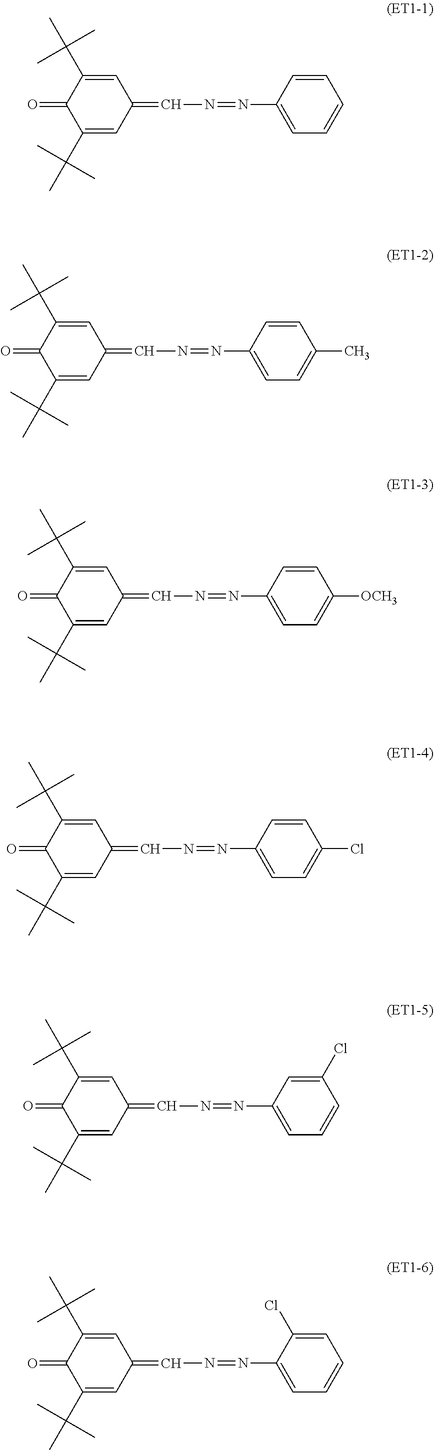

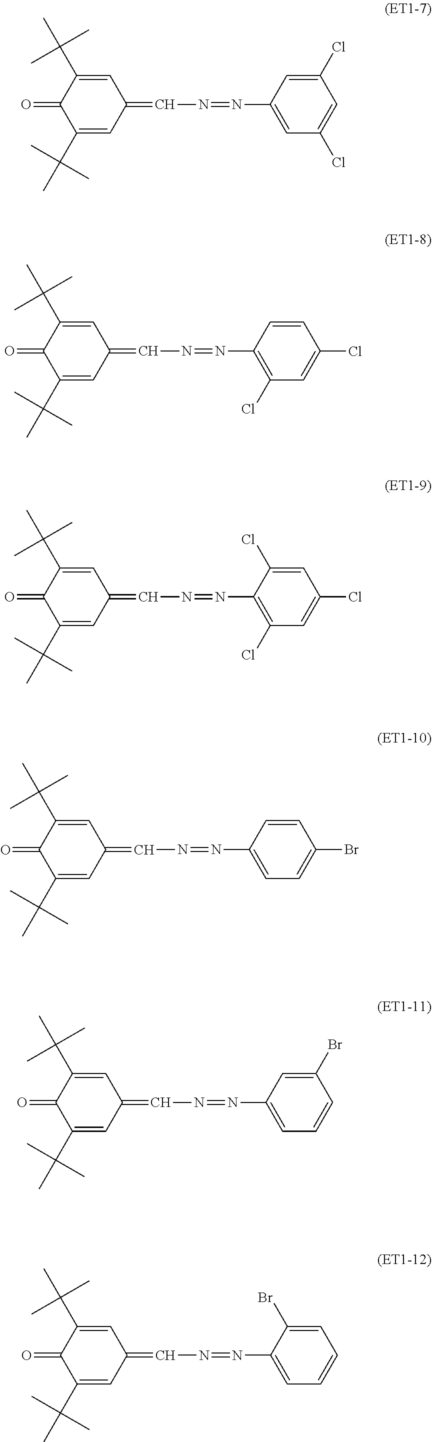

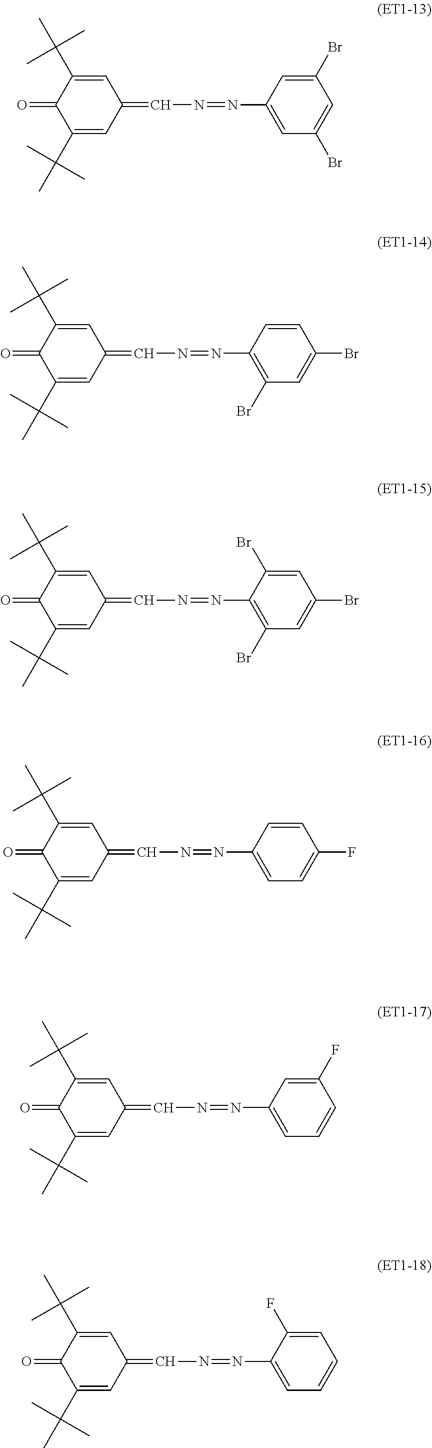

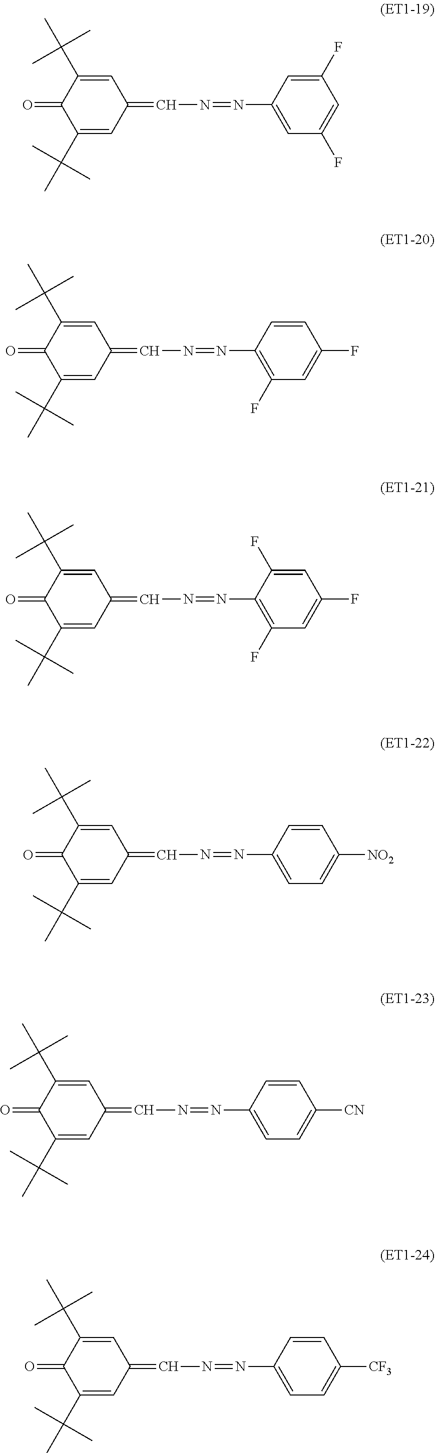

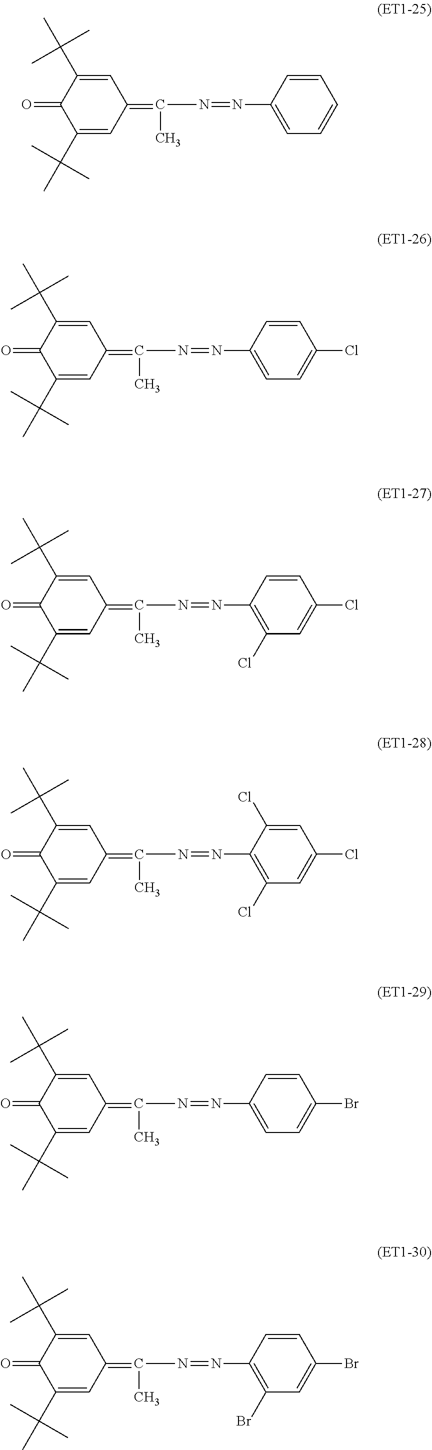

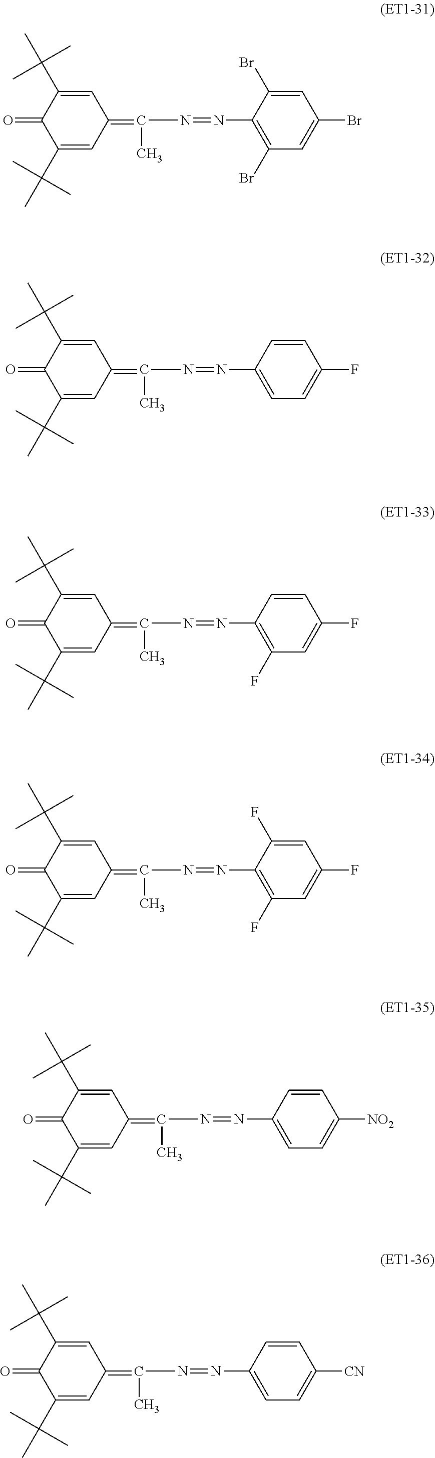

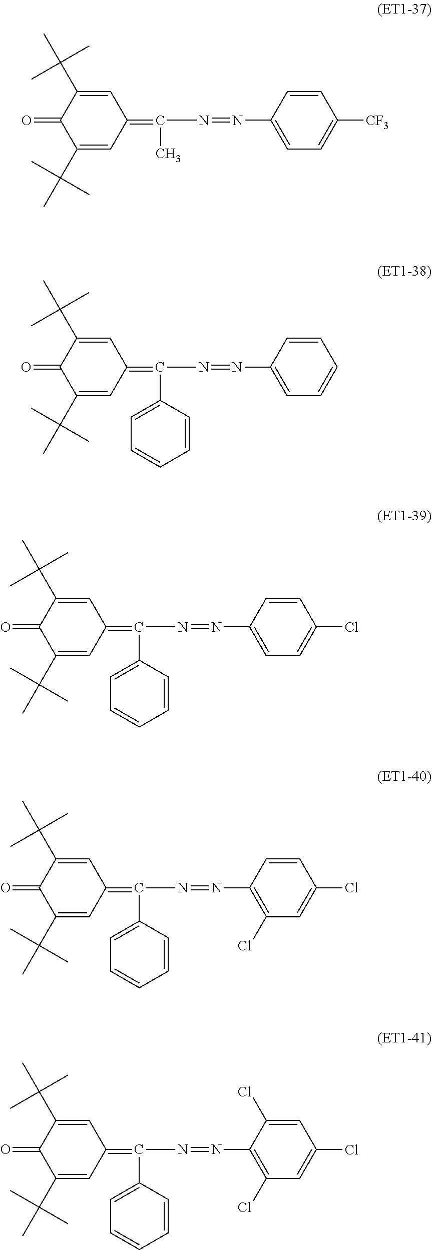

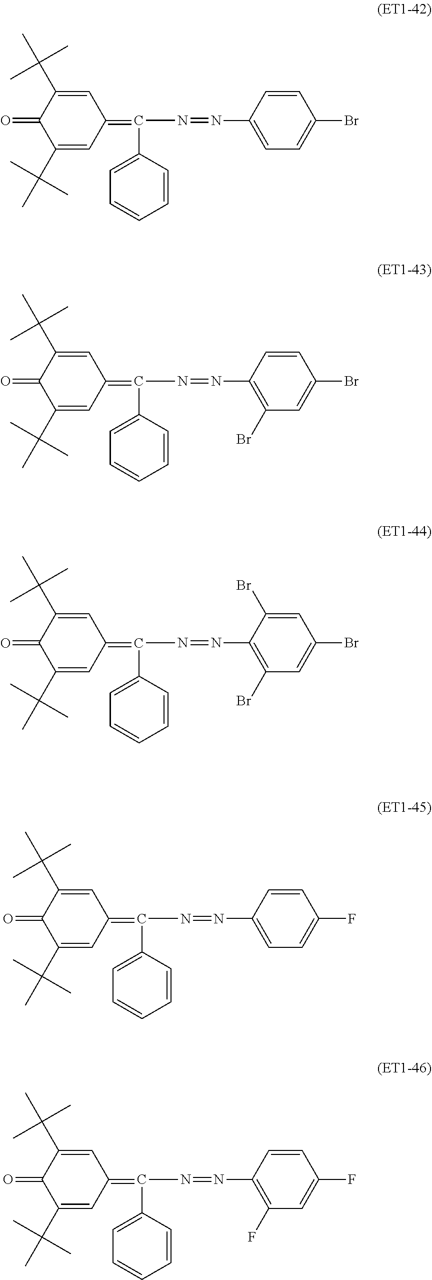

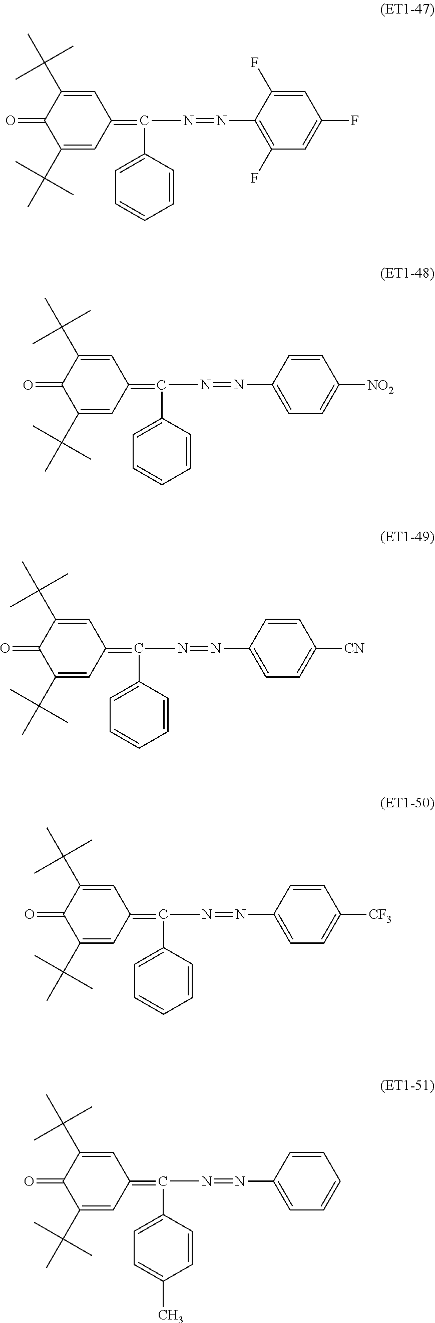

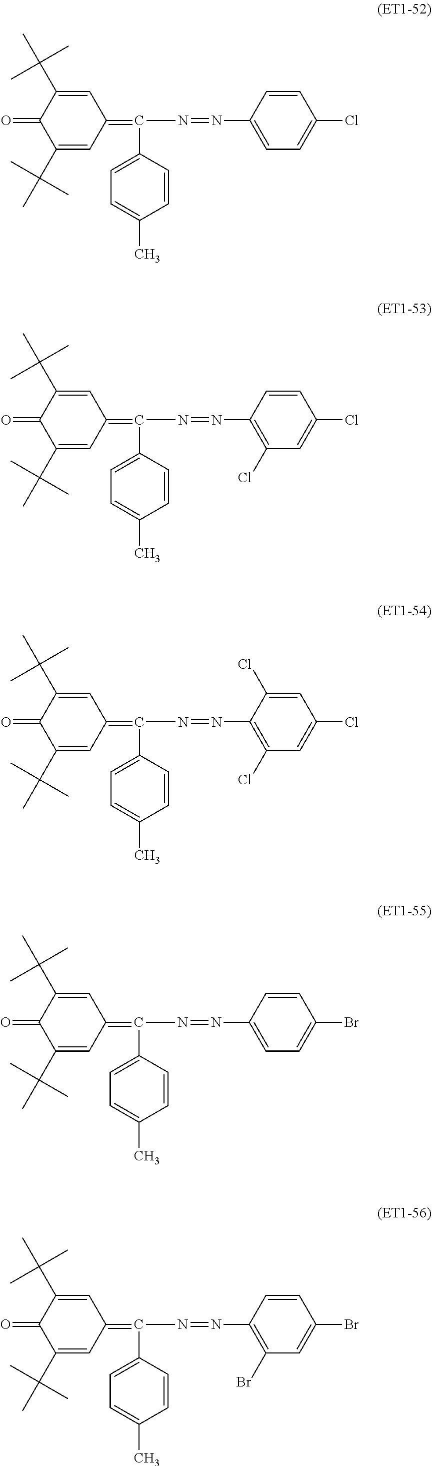

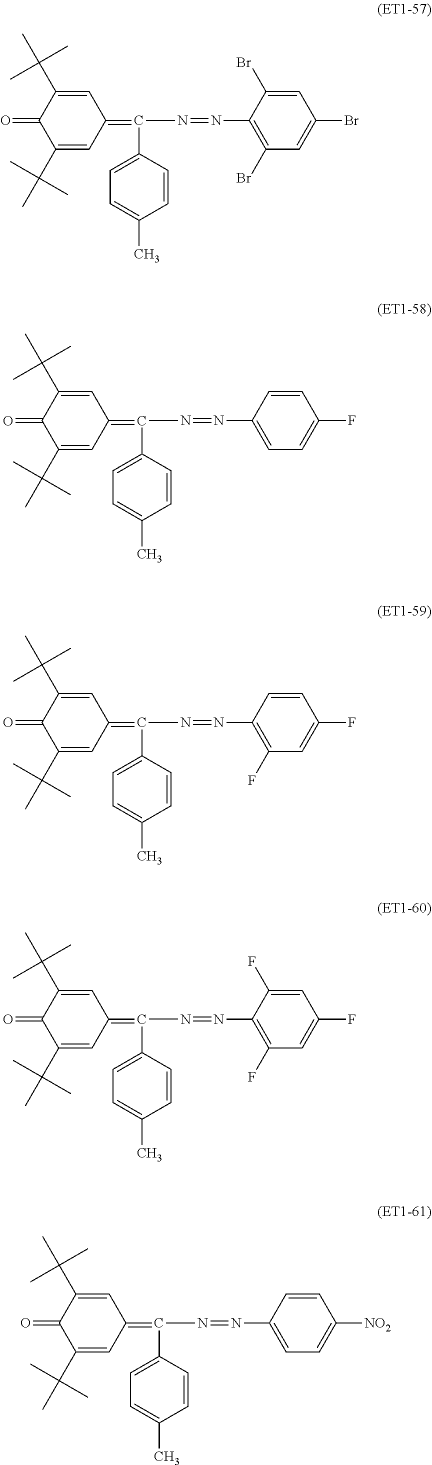

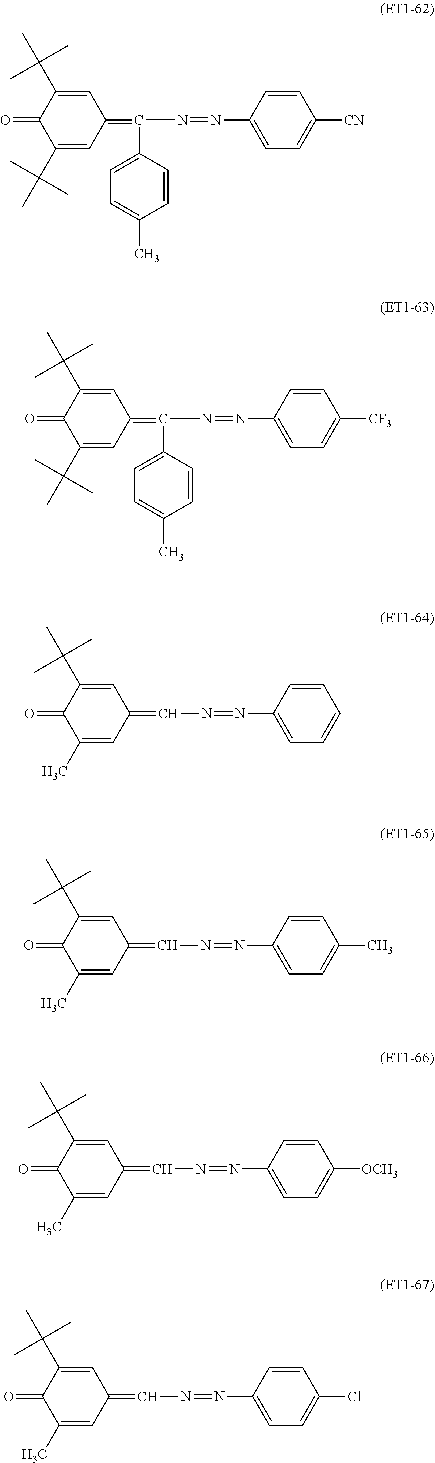

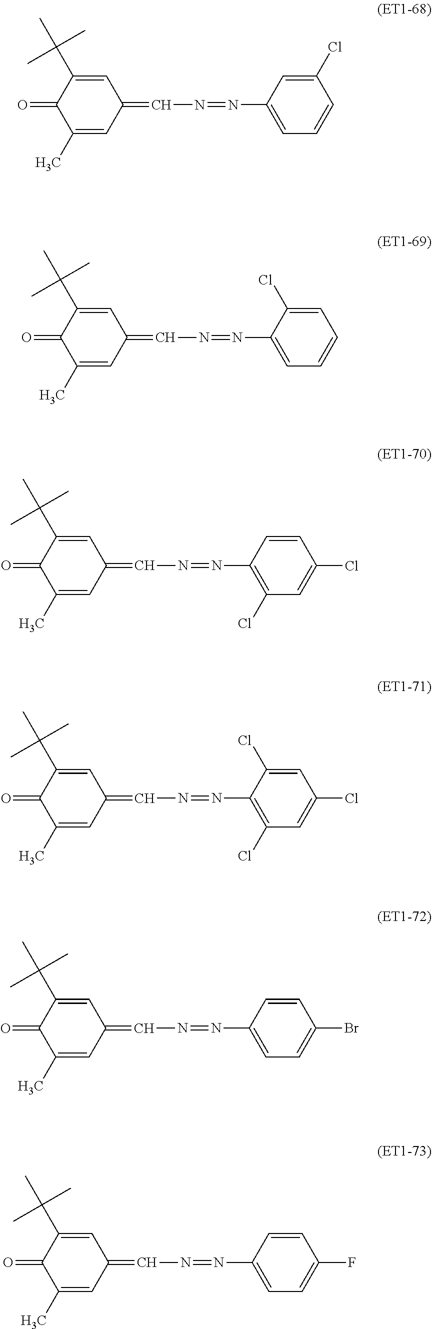

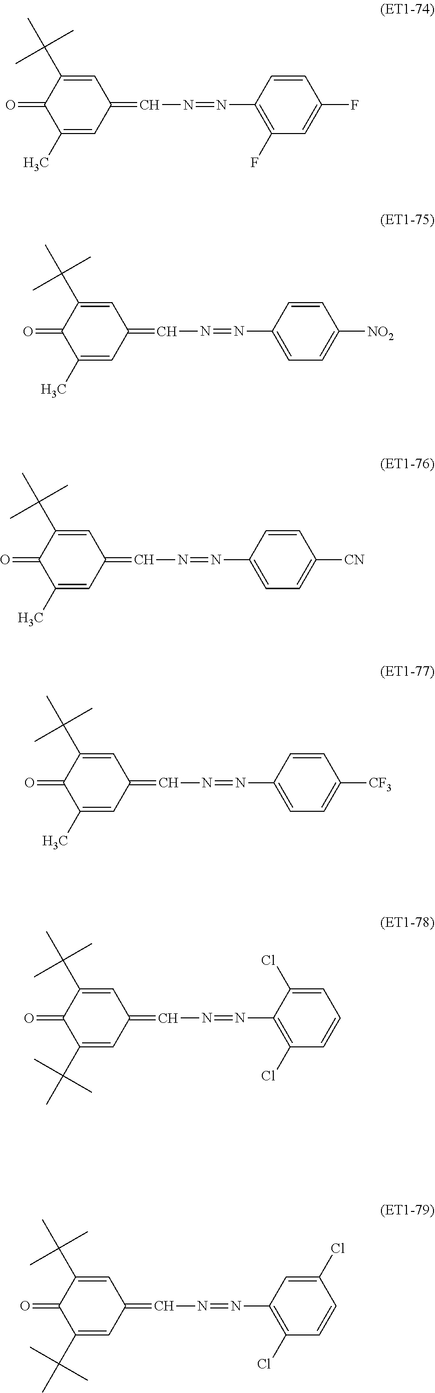

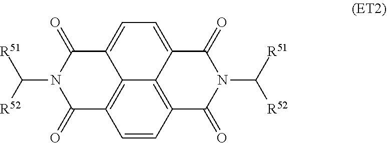

(In General Formula (ET2), R⁵¹ and R⁵² may be the same or different and represent a hydrogen atom, an alkyl group having 1 to 10 carbon atoms, an alkylene group, an alkoxy group, an alkyl ester group, a phenyl group which may have a substituent, a naphthyl group which may have a substituent, or a halogen atom, and R⁵¹ and R⁵² may be combined to each other to form an aromatic ring which may have a substituent.)

Specific examples of the naphthalenetetracarboxylic acid diimide compound having the structure represented by General Formula (ET2) above include the following substances.

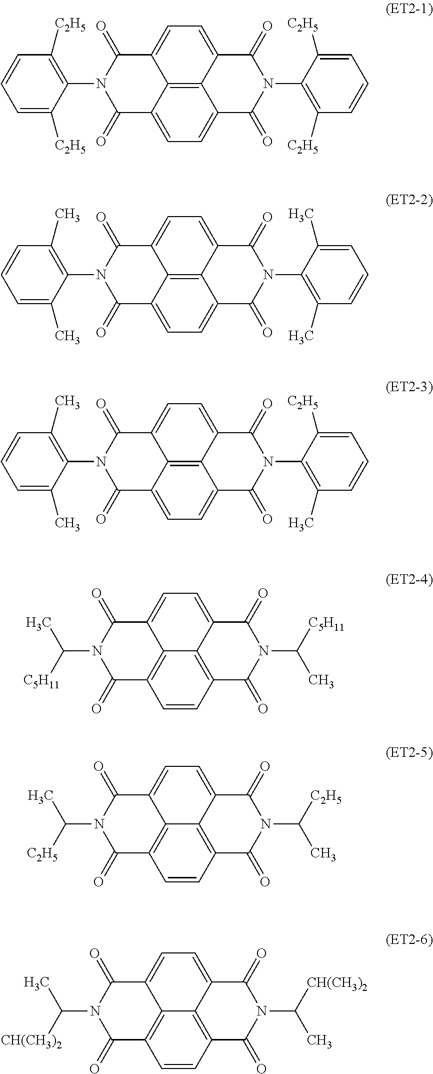

The use of the electron transport materials in combination as appropriate sometimes facilitates an improvement of the resistance to contamination from peripheral members or the adjustment of the sensitivity characteristics when matched with device processes of the photoreceptor surface.

As the electron transport material, when the azoquinone compound having the structure represented by General Formula (ET1) above and the naphthalenetetracarboxylic acid diimide compound having the structure represented by General Formula (ET2) above are used in combination, the mass ratio ET1:ET2 is suitably 5:95 to 95:5 and more suitably 20:80 to 80:20.

The content of the first hole transport material in the charge transport layer 3 is suitably 10 to 80% by mass and more suitably 20 to 70% by mass based on the solid content of the charge transport layer 3. The content of the first resin binder in the charge transport layer 3 is suitably 20 to 90% by mass and more suitably 30 to 80% by mass based on the solid content of the charge transport layer 3. The content of the electron transport material in the charge transport layer 3 when the charge transport layer 3 contains the electron transport material is suitably 40% by mass or less and more suitably 20% by mass or less based on the solid content of the charge transport layer 3.

The content of the compound represented by General Formula (AD1) above in the charge transport layer 3 is suitably 1 part by mass or more and 40 parts by mass or less and more suitably 15 parts by mass or more 30 parts by mass or less based on a total of 100 parts by mass of the first hole transport material and the first resin binder. By combining the compound represented by General Formula (AD1) above within the range above, the effect of preventing the occurrence of cracking due to sebum adhesion without reducing the creep strength of the photoreceptor and, simultaneously, greatly improving the ozone resistance can be satisfactorily obtained. When the charge transport layer 3 further contains the compound represented by General Formula (AD2) above, the content of the compound is suitably 1 part by mass or more and 20 parts by mass or less and more suitably 1 part by mass or more and 10 parts by mass or less based on a total of 100 parts by mass of the first hole transport material and the first resin binder. Thus, the above-described effect can be more satisfactorily obtained.

The film thickness of the charge transport layer 3 is preferably within the range of 3 to 50 μm and more preferably within the range of 5 to 40 μm.

The material used in the charge transport layer 3 is desirably a material which is less likely to be eluted into a solvent of a charge generation layer coating solution. The charge transport layer 3 desirably has a film property of being less likely to be eluted into a solvent of the charge generation layer coating solution.

The content of the charge generation material in the charge generation layer 4 is suitably 0.1 to 5% by mass and more suitably 0.5 to 3% by mass based on the solid content of the solid charge generation layer 4. The content of the second hole transport material in the charge generation layer 4 is suitably 1 to 30% by mass and more suitably 5 to 20% by mass based on the solid content of the charge generation layer 4. The content of the electron transport material in the charge generation layer 4 is suitably 5 to 65% by mass and more suitably 10 to 60% by mass based on the solid content of the charge generation layer 4. When a plurality of kinds of electron transport materials are mixed for use, the content of the electron transport materials may be 50 to 60% by mass based on the solid content of the charge generation layer 4. The content ratio of the second hole transport material and the electron transport material may fall within the range of 1:3 to 1:10. The content of the second resin binder in the charge generation layer 4 is suitably 20 to 80% by mass and more suitably 30 to 70% by mass based on the solid content of the charge generation layer 4.

The content of the compound represented by General Formula (AD2) above in the charge generation layer 4 is suitably 0.5 parts by mass or more and 15 parts by mass or less and more suitably 0.5 parts by mass or more and 5 parts by mass or less based on a total of 100 parts by mass of the second hole transport material, the electron transport material, the charge generation material, and the second resin binder. By compounding the compound represented by General Formula (AD2) above within the range above, the effect of preventing the occurrence of cracking due to sebum adhesion without reducing the creep strength of the photoreceptor and, simultaneously, greatly improving the ozone resistance can be satisfactorily obtained.

The film thickness of the charge generation layer 4 is preferably within the range of 3 to 50 and, to maintain a practically effective surface potential, preferably within the range of 5 to 40 μm and more preferably within the range of 8 to 30 μm.

In the photoreceptor according to the embodiment of the present invention, for the purposes of improving the leveling property of the formed film and imparting lubricity to the formed film, a leveling agent, such as silicone oil or a fluorine-based oil, can be compounded in the photosensitive layer 5. Further, a plurality of kinds of inorganic oxides can be compounded for the purposes of adjusting the film hardness, reducing the friction coefficient, imparting lubricity, and the like. Fine particles of metal oxides, such as silica, titanium oxide, zinc oxide, calcium oxide, alumina, and zirconium oxide, metal sulfates, such as barium sulfate and calcium sulfate, and metal nitrides, such as silicon nitride and aluminum nitride, or fluorine-based resin particles, such as tetrafluoride ethylene resin, fluorine-based comb-like graft polymer resin particles, and the like may be compounded. Further, other known additives can be compounded as necessary within the range where the electrophotographic characteristics are not significantly impaired.

For the purpose of further improving the environmental resistance or stability against harmful light, deterioration inhibitors, such as an antioxidant and a light stabilizer, can be compounded as an additional additive in the photosensitive layer 5. Examples of compounds used for the purposes include chromanol derivatives, such as tocopherol, and esterified compounds, polyaryl alkane compounds, hydroquinone derivatives, etherified compounds, di-etherified compounds, benzophenone derivatives, benzotriazole derivatives, thioether compounds, phenylenediamine derivatives, phosphoric esters, phosphorus esters, phenol compounds, hindered phenol compounds, linear amine compounds, cyclic amine compounds compound, hindered amine compound, and the like.

In the positive charging multilayer photoreceptor, the photosensitive layer is generally manufactured by a dip coating method in mass-production as with the positive charging single-layer photoreceptor. Therefore, the charge transport layer coating solution and the charge generation layer coating solution in which the materials of the charge transport layer 3 and the charge generation layer 4 constituting the photosensitive layer are dissolved or dispersed in a solvent are used.

Examples of the solvent of the charge transport layer 3 include halogenated hydrocarbons, such as dichloromethane, dichloroethane, chloroform, carbon tetrachloride, and chlorobenzene; ethers, such as dimethyl ether, diethyl ether, tetrahydrofuran, dioxane, dioxolane, ethylene glycol dimethyl ether, and diethylene glycol dimethyl ether; ketones, such as acetone, methyl ethyl ketone, and cyclohexanone, and the like. The solvent used in the charge transport layer 3 is selected considering the solubility, coatability, and storage stability of the hole transport material or the resin binder.

Also for the solvent of the charge generation layer 4, the same substances as those used in the charge transport layer 3 are mentioned. Among the substances, those having a high boiling point are generally preferable, and specifically those having a boiling point of 60° C. or more, particularly those having a boiling point of 80° C. or more, are suitably used. Among the above, when titanyl phthalocyanine with a high quantum efficiency is used in the charge generation material for high sensitivity, dichloroethane with a large specific gravity and a boiling point of 80° C. or more is suitably used as the solvent in the formation of the charge generation layer 4 in terms of dispersion stability and the difficulty of elution of the charge transport layer 3.

### (Method for Manufacturing Photoreceptor)

A method for manufacturing a photoreceptor according to the embodiment of the present invention includes, in manufacturing the above-described electrophotographic photoreceptor, a step of preparing the charge transport layer coating solution containing at least the first hole transport material, the first resin binder, and the compound represented by General Formula (AD1) above and a step of forming the charge transport layer by a dip coating method using the charge transport layer coating solution.

Specifically, first, the charge transport layer is formed by a method including a step of preparing and producing the charge transport layer coating solution by dissolving any first hole transport material, any first resin binder, and the compound represented by General Formula (AD1) above in a solvent and a step of applying the charge transport layer coating solution onto the outer periphery of a conductive substrate by a dip coating method via an undercoat layer as desired, followed by drying, to form a charge transport layer. Next, the charge generation layer is formed by a method including a step of preparing and producing the charge generation layer coating solution by dissolving and dispersing any second hole transport material, any electron transport material, any charge generation material, and any second resin binder in a solvent and a step of applying the charge generation layer coating solution onto the charge transport layer by a dip coating method, followed by drying, to form a charge generation layer. According to such a manufacturing method, a multilayer photoreceptor according to the embodiment of the present invention can be manufactured. Herein, the kind of the solvent used in the preparation of the coating solution, coating condition, drying condition, and the like can be appropriately selected according to common methods, and are not particularly limited.

The photoreceptor according to the embodiment of the present invention can achieve the desired effects by being applied to various machine processes. Specifically, sufficient effects can be obtained also in charging processes, such as contact charging methods using charging members, such as rollers or brushes, non-contact charging methods using corotrons or scorotrons, and development processes, such as contact development and non-contact development methods using developers, such as non-magnetic one-component developers, magnetic one-component developers, and two-component developers.

### (Electrophotographic Apparatus)

The electrophotographic apparatus according to the embodiment of the present invention is mounted with the above-described electrophotographic photoreceptor. Even when applied particularly to monochrome high speed printers or small middle speed tandem color printers, the electrophotographic apparatus according to the embodiment of the present invention has sufficiently high sensitivity, has excellent potential stability in repeated printing in various environments, and does not cause problems, such as the deterioration of the gradation or the generation of memory images.

FIG. 2 illustrates a schematic configuration view of one configuration example of the electrophotographic apparatus according to the embodiment of the present invention. An illustrated electrophotographic apparatus 30 is mounted with a photoreceptor 20 according to the embodiment of the present invention including the conductive substrate 1, the undercoat layer 2 applied onto the outer peripheral surface of the conductive substrate 1, and the photosensitive layer 5 containing the charge transport layer 3 and the charge generation layer 4. The electrophotographic apparatus 30 contains in the illustrated example, a scorotron charging member 21, a high voltage power source 22 supplying an applied voltage to the charging member 21, an image exposure member 23, a developing member 24, and a transfer member 25 which are arranged in an outer peripheral edge portion of the photoreceptor 20. The electrophotographic apparatus 30 may further contain a cleaning member 26. The electrophotographic apparatus 30 can be a color printer.

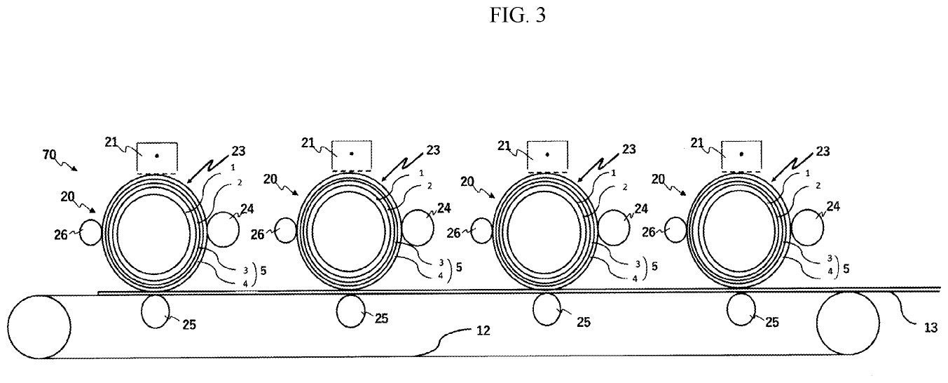

FIG. 3 illustrates a schematic configuration view illustrating another example of an electrophotographic process layout view in the electrophotographic apparatus according to the embodiment of the present invention. The illustrated electrophotographic process indicates a tandem color printer. An electrophotographic apparatus 70 illustrated in the figure is mounted with the four photoreceptors 20 according to the embodiment of the present invention each including the conductive substrate 1, the undercoat layer 2 applied onto the outer peripheral surface of the conductive substrate 1, and the photosensitive layer 5 containing the charge transport layer 3 and the charge generation layer 4. This electrophotographic apparatus 70 contains the charging member 21, a charging power source (not illustrated) supplying an applied voltage to this charging member 21, the image exposure member 23, the developing member 24, and the transfer member 25 which are arranged in the outer peripheral edge portion of each of the photoreceptors 20, and further a transfer belt 12 and a transfer paper 13. The electrophotographic apparatus 70 may further contain a cleaning member 26.

When a cylindrical aluminum substrate with a diameter of 28 mm or more and 40 mm or less is used as the conductive substrate 1, a monochrome electrophotographic apparatus with a printing speed of 50 ppm or more, a monochrome electrophotographic apparatus with a photoconductor drum life of 50,000 sheets or more, or a tandem color electrophotographic apparatus with a printing speed of 30 ppm or more can be provided. When a cylindrical aluminum substrate with a diameter of 15 mm or more and less than 28 mm is used as the conductive substrate 1, a tandem color electrophotographic apparatus with a printing speed of 30 ppm or more or a tandem color electrophotographic apparatus with a photoconductor drum life of 30,000 sheets or more can be provided.

### EXAMPLES

Hereinafter, specific aspects of the present invention are described in more detail using Examples. The present invention is not limited by Examples below without departing from the gist thereof.

### <Positive Charging Multilayer Photoreceptor>

### Example 1

As the conductive substrate, an aluminum tube (cylindrical aluminum substrate) with a wall thickness of 0.75 mm machined to have a diameter of 30 mm, a length of 244.5 mm, and a surface roughness (Rz) of 1.2 μm was used. For this conductive substrate, an anodized film was formed according to common methods. Pure water sealing treatment with a current density in the treatment of 0.5 A/dm² and an energization period of time of 30 minutes was performed at 95° C. for 30 minutes, giving a 51.tm thick anodized film.

### [Charge Transport Layer]

30 parts by mass of the compound represented by Structural Formula (HT1 -5) above and 30 parts by mass of the compound represented by Structural Formula (HT-1) above as the first hole transport material, 40 parts by mass a polycarbonate resin (viscosity average molecular weight: 52,500) having the repeating unit represented by Structural Formula (BD1-2) above as the first resin binder, and additives in the compounding amounts illustrated in Tables 1 and 2 below were dissolved in 400 parts by mass of tetrahydrofuran as a solvent, preparing the charge transport layer coating solution. This charge transport layer coating solution was applied by a dip coating method onto the conductive substrate above and dried at 100° C. for 30 minutes to form a charge transport layer with a film thickness of 12 The solvent compounding amount was adjusted such that the desired film thickness was obtained.

### [Charge Generation Layer]

5 parts by mass of the compound represented by Structural Formula (HT1-5) above and 5 parts by mass of the compound represented by Structural Formula (HT-1) above as the second hole transport material, 30 parts by mass of the compound represented by Structural Formula (ET1-4) above and 15 parts by mass of the compound represented by Structural Formula (ET2-4) above as the electron transport material, 44 parts by mass of a polycarbonate resin (viscosity average molecular weight: 54,500) having the repeating unit represented by Structural Formula (BD1-3) above as the second resin binder, and additives of the compounding amounts illustrated in Tables 1 and 2 below were dissolved in 380 parts by mass of tetrahydrofuran as the solvent, 1 part by mass of Y-type titanyl phthalocyanine represented by Structural Formula (CG1) below as the charge generation material was added, and then dispersion treatment was performed in a dispersing machine (DYNO-MILL Research Lab Type manufactured by Willy A. Bachofen AG) under the conditions of beads: φ0.4ZrO, filling rate: 70%, number of rotations: 3000 rpm, and 3 passes, thereby preparing a charge generation layer coating solution. This charge generation layer coating solution was applied onto the charge transport layer above by a dip coating method and dried at a temperature of 110° C. for 30 minutes to form a charge generation layer with a film thickness of 12 The solvent compounding amount was adjusted such that the desired film thickness was obtained. Thus, a positive charging multilayer electrophotographic photoreceptor having a photosensitive layer with a total film thickness of 24 μm was obtained.

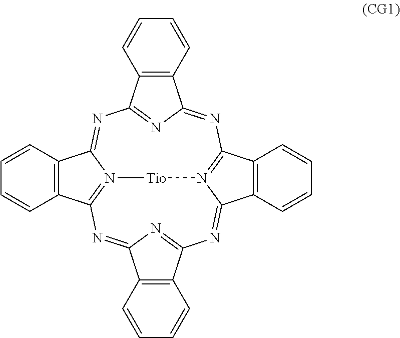

### Examples 2 to 27 and Comparative Examples 1 to 23

Positive charging multilayer electrophotographic photoreceptors were obtained in the same manner as in Example 1, except for changing the kind and the compounding amount of additives according to Tables 1 and 2 below. The compounding amount of the solvent was adjusted as appropriate such that the desired film thickness was obtained.

TABLE 1

| | Charge transport layer | | | | Charge generation layer | | | |
|---|---|---|---|---|---|---|---|---|
| | Additive 1A | | Additive 1B | | Additive 2A | | Additive 2B | |
| | | Content | | Content | | Content | | Content |
| | | (part by | | (part by | | (part by | | (part by |
| | Material | mass) | Material | mass) | Material | mass) | Material | mass) |
| Ex. 1 | AD1-2 | 1 | — | — | — | — | — | — |
| Ex. 2 | AD1-2 | 5 | — | — | — | — | — | — |
| Ex. 3 | AD1-2 | 10 | — | — | — | — | — | — |
| Ex. 4 | AD1-2 | 15 | — | — | — | — | — | — |
| Ex. 5 | AD1-2 | 20 | — | — | — | — | — | — |
| Ex. 6 | AD1-2 | 30 | — | — | — | — | — | — |
| Ex. 7 | AD1-2 | 35 | — | — | — | — | — | — |
| Ex. 8 | AD1-2 | 20 | — | — | — | — | AD2-4 | 0.5 |
| Ex. 9 | AD1-2 | 20 | — | — | — | — | AD2-4 | 1 |
| Ex. 10 | AD1-2 | 20 | — | — | — | — | AD2-4 | 5 |
| Ex. 11 | AD1-2 | 20 | — | — | — | — | AD2-4 | 10 |
| Ex. 12 | AD1-2 | 1 | — | — | — | — | AD2-4 | 1 |
| Ex. 13 | AD1-2 | 5 | — | — | — | — | AD2-4 | 1 |
| Ex. 14 | AD1-2 | 10 | — | — | — | — | AD2-4 | 1 |
| Ex. 15 | AD1-2 | 15 | — | — | — | — | AD2-4 | 1 |
| Ex. 16 | AD1-2 | 30 | — | — | — | — | AD2-4 | 1 |
| Ex. 17 | AD1-2 | 20 | AD2-4 | 1 | — | — | AD2-4 | 1 |
| Ex. 18 | AD1-2 | 20 | AD2-4 | 5 | — | — | AD2-4 | 1 |
| Ex. 19 | AD1-2 | 20 | AD2-4 | 10 | — | — | AD2-4 | 1 |
| Ex. 20 | AD1-2 | 20 | AD2-4 | 15 | — | — | AD2-4 | 1 |
| Ex. 21 | AD1-2 | 20 | — | — | AD1-2 | 1 | AD2-4 | 1 |
| Ex. 22 | AD1-2 | 20 | AD2-4 | 5 | AD1-2 | 1 | AD2-4 | 1 |
| Ex. 23 | AD1-2 | 20 | AD2-4 | 5 | — | — | — | — |
| Ex. 24 | AD1-2 | 20 | — | — | AD1-2 | 1 | — | — |
| Ex. 25 | AD1-2 | 20 | AD2-4 | 5 | AD1-2 | 1 | — | — |

TABLE 2

| | Charge transport layer | | | | Charge generation layer | | | |
|---|---|---|---|---|---|---|---|---|
| | Additive 1A | | Additive 1B | | Additive 2A | | Additive 2B | |
| | | Content | | Content | | Content | | Content |
| | | (part by | | (part by | | (part by | | (part by |
| | Material | mass) | Material | mass) | Material | mass) | Material | mass) |
| Ex. 26 | AD1-2 | 20 | BHT | 1 | — | — | AD2-4 | 1 |
| Ex. 27 | AD1-2 | 20 | — | — | — | — | BHT | 1 |
| Com. Ex. 1 | — | — | — | — | — | — | — | — |
| Com. Ex. 2 | — | — | — | — | — | — | AD2-4 | 0.5 |
| Com. Ex. 3 | — | — | — | — | — | — | AD2-4 | 1 |
| Com. Ex. 4 | — | — | — | — | — | — | AD2-4 | 5 |
| Com. Ex. 5 | — | — | — | — | — | — | AD2-4 | 10 |
| Com. Ex. 6 | — | — | AD2-4 | 1 | — | — | — | — |
| Com. Ex. 7 | — | — | AD2-4 | 5 | — | — | — | — |
| Com. Ex. 8 | — | — | AD2-4 | 10 | — | — | — | — |
| Com. Ex. 9 | — | — | AD2-4 | 15 | — | — | — | — |
| Com. Ex. 10 | — | — | — | — | AD1-2 | 1 | — | — |
| Com. Ex. 11 | — | — | — | — | AD1-2 | 5 | — | — |
| Com. Ex. 12 | — | — | — | — | AD1-2 | 10 | — | — |
| Com. Ex. 13 | — | — | — | — | AD1-2 | 15 | — | — |
| Com. Ex. 14 | — | — | — | — | AD1-2 | 20 | — | — |
| Com. Ex. 15 | — | — | — | — | AD1-2 | 30 | — | — |
| Com. Ex. 16 | — | — | — | — | AD1-2 | 35 | — | — |
| Com. Ex. 17 | — | — | — | — | AD1-2 | 1 | AD2-4 | 1 |
| Com. Ex. 18 | — | — | AD2-4 | 5 | AD1-2 | 1 | — | — |
| Com. Ex. 19 | — | — | AD2-4 | 5 | AD1-2 | 1 | AD2-4 | 1 |
| Com. Ex. 20 | — | — | AD2-4 | 5 | — | — | AD2-4 | 1 |
| Com. Ex. 21 | — | — | BHT | 1 | — | — | — | — |
| Com. Ex. 22 | — | — | BHT | 1 | — | — | AD2-4 | 1 |
| Com. Ex. 23 | — | — | BHT | 1 | — | — | BHT | 1 |

BHT in the table indicates dibutylhydroxytoluene (hindered phenolic antioxidant).

### [Initial Electrical Characteristics]

The electrophotographic characteristics of the photoreceptors produced in each of Examples 1 to 27 and Comparative Examples 1 to 23 above were evaluated by the following method. More specifically, first, the photoreceptor surface was charged to +650 V by corona discharging in a dark place using an evaluation device (Cynthia manufactured by Gentec Co., Ltd.), and then a surface potential V0 immediately after charging was measured. Subsequently, after standing in the dark place for 5 seconds, a surface potential V5 was measured, and the ratio of V5 to V0 was determined and set as a potential holding ratio Vk5 (%) 5 seconds after the charging.

Next, a halogen lamp was used as a light source, an exposure light split into 780 nm using a filter was emitted to the photoreceptor for 5 seconds after the surface potential reached +600 V, the time until the surface potential reached +300 V was measured, and the exposure amount required for light attenuation was determined and set as sensitivity E1/2 (μJcm⁻²). The surface potential after the light irradiation was measured at an exposure energy of 0.30 (μJcm⁻²) and set as a residual potential VR0.30 (V).

### [Ozone Resistance Evaluation]

Assuming the environment of a small electrophotographic apparatus where the ozone concentration around the photoreceptor is high, the photoreceptor of each of Examples and Comparative Examples was installed in an ozone exposure device where the photoreceptor can be allowed to stand in the ozone atmosphere, the photoreceptor was exposed to ozone at a concentration of 50 parts per million (ppm) for 30 minutes, the potential holding ratio after standing in the dark for 4 hours outside the ozone exposure apparatus was measured, a holding ratio Vk52 after exposure to and standing in ozone for 4 hours to a holding ratio Vk5₁ before the exposure to ozone was determined, and an ozone exposure holding recovery rate ΔVk5 (%)=(Vk5₂/Vk5₁)×100 was obtained. The evaluation was performed on a scale of Level 1 to Level 5: a case where the ΔVk5 value was 90% or more was evaluated as Level 5, a case where the ΔVk5 value was 80% or more and less than 90% was evaluated as Level 4, a case where the ΔVk5 value was 70% or more and less than 80% was evaluated as Level 3, a case where the ΔVk5 value was 60% or more and less than 70% was evaluated as Level 2, and a case where the ΔVk5 value was less than 60% was evaluated as Level 1. The practically usable levels are Level 3 to Level 5 above.

### [Evaluation of Occurrence of Cracking]

Human-derived sebum was made to adhere to 10 places of the photoreceptor surface and the adhesion places after standing for 10 days were examined whether cracking or staining (colored) occurred under an optical microscope at a 100× magnification. Then, the evaluation was performed on a scale of Level 1 to Level 5: a case where no cracking occurred and no staining occurred in all of the 10 places was evaluated as Level 5, a case where no cracking occurred in all of the 10 places and staining occurred in less than five places was evaluated as Level 4, a case where no cracking occurred in all of the 10 places and staining occurred in five places or more was evaluated as Level 3, a case where cracking occurred in less than five places was evaluated as Level 2, and a case where cracking occurred in five places or more was evaluated as Level 1. The practically usable levels are Level 3 to Level 5 above.

### [Creep Deformation Evaluation]

A 100 g weight was attached to bods ends of a tungsten wire with a diameter of 60 μm and a length of 10 cm, laid on the photoreceptor, and allowed to stand for one week in a high temperature and normal humidity environment of 50° C. Thereafter, the creep deformation quantity (depression) was measured using a probe type meter. The evaluation was performed on a scale of Level 1 to Level 5: a case where the creep deformation quantity was 0 μm or more and less than 1μm was evaluated as Level 5, a case where the creep deformation quantity was 1 μm or more and less than 2μm was evaluated as Level 4, a case where the creep deformation quantity was 2 μm or more and less than 3 μm was evaluated as Level 3, a case where the creep deformation quantity was 3 μm or more and less than 4 μm was evaluated as Level 2, and a case where the creep deformation quantity was 4 μm or more was evaluated as Level 1. The practically usable levels are Level 3 to Level 5 above. These evaluation results are shown in Tables 3 and 4 below. In Examples 1 to 27 containing the compound represented by General Formula (AD1) as the additive in the charge transport layer, the initial electrical characteristics are good and all of the three kinds of evaluations of the ozone resistance, the occurrence of cracking, and the creep deformation are Level 3 or more, and thus the photoreceptors having the evaluation properties were obtained. In contrast thereto, in Comparative Examples 1 to 23 not containing the compound represented by General Formula (AD1) as the additive in the charge transport layer, the initial electrical characteristics are relatively good but any one or all of the three kinds of evaluations of the ozone resistance, the occurrence of cracking, and the creep deformation are Level 2 or less, and thus the photoreceptors having the three kinds of evaluation properties were not obtained.

Among the above, Examples 8 to 10 and 15 to 19 containing the compound represented by General Formula (AD1) as the additive in the charge transport layer in a proportion of 15 parts by mass or more and 30 parts by mass or less based on a total of 100 parts by mass of the first hole transport material and the first resin binder and containing the compound represented by General Formula (AD2) as the additive in the charge generation layer in a proportion of 0.5 parts by mass or more and 5 parts by mass or less based on a total of 100 parts by mass of the charge generation material, the second hole transport material, the electron transport material, and the second resin binder are evaluated as Level 5 in all of the three kinds of evaluation of the ozone resistance, the occurrence of cracking, and the creep deformation, and Examples 20 to 22 containing the compounds in the proportions above are evaluated as Level 4 in one kind of the evaluations and as Level 5 in two kinds of the evaluations, and thus the photoreceptors having the evaluation properties in a high level were obtained. Particular in the photoreceptors of Examples 17 to 20, and 22 containing the compound represented by General Formula (AD2) as the additive in the charge transport layer in a proportion of 1 part by mass or more and 10 parts by mass or less based on a total of 100 parts by mass of the first hole transport material and the first resin binder, the initial electrical characteristics are more excellent.

On the other hand, when Comparative Examples not containing the compound represented by General Formula (AD1) as the additive in the charge transport layer are compared with one another, an improvement of the evaluation of the occurrence of cracking is not observed even in Comparative Examples 10 to 16 containing the compound represented by General Formula (AD1) as the additive in the charge generation layer, in contrast to Comparative Example 1 not containing the compound represented by General Formula (AD1) as the additive in the charge generation layer. Among the above, in Comparative Example 10 containing 1 part by mass of the compound represented by General Formula (AD1) as the additive in the charge generation layer, an improvement of the evaluation of the creep deformation is observed as compared with Comparative Example 1, but an improvement of the evaluation of the ozone resistance is not observed. In Comparative Examples 12 to 16 containing 10 parts by mass or more of the compound represented by General Formula (AD1) as the additive in the charge generation layer, an improvement of the evaluation of the ozone resistance is observed as compared with Comparative Example 1, but the evaluation of the creep deformation deteriorates, and both the evaluation characteristics of the ozone resistance and the creep deformation are not observed. In Comparative Examples 21 to 23 containing the typical antioxidant BHT in place of the compound represented by General Formula (AD2) as the additive in the charge transport layer, an improvement of the evaluations of the ozone resistance and the occurrence of cracking is not observed. AD1-2 was used as the additive represented by General Formula (AD1) and AD2-4 was used as the additive represented by General Formula (AD2), but similar effects were observed also in other materials.

TABLE 3

| | Initial electrical | | | | | |
|---|---|---|---|---|---|---|
| | characteristics | | | Ozone | Occurrence | Creep |
| | Vk5 | El/2 | VR0.30 | resistance | of cracking | deformation |
| Ex. 1 | 88 | 0.14 | 145 | 3 | 4 | 4 |
| Ex. 2 | 89 | 0.14 | 145 | 3 | 4 | 4 |
| Ex. 3 | 90 | 0.14 | 145 | 3 | 4 | 4 |
| Ex. 4 | 91 | 0.14 | 145 | 4 | 4 | 4 |
| Ex. 5 | 93 | 0.14 | 145 | 4 | 4 | 4 |
| Ex. 6 | 93 | 0.14 | 145 | 4 | 4 | 4 |
| Ex. 7 | 91 | 0.15 | 150 | 4 | 3 | 4 |
| Ex. 8 | 91 | 0.14 | 145 | 5 | 5 | 5 |
| Ex. 9 | 91 | 0.14 | 145 | 5 | 5 | 5 |
| Ex. 10 | 90 | 0.15 | 150 | 5 | 5 | 5 |
| Ex. 11 | 89 | 0.15 | 155 | 4 | 5 | 3 |
| Ex. 12 | 88 | 0.14 | 145 | 3 | 4 | 5 |
| Ex. 13 | 89 | 0.14 | 145 | 4 | 4 | 5 |
| Ex. 14 | 90 | 0.14 | 145 | 4 | 4 | 5 |
| Ex. 15 | 91 | 0.14 | 145 | 5 | 5 | 5 |
| Ex. 16 | 93 | 0.14 | 145 | 5 | 5 | 5 |
| Ex. 17 | 93 | 0.13 | 135 | 5 | 5 | 5 |
| Ex. 18 | 94 | 0.12 | 130 | 5 | 5 | 5 |
| Ex. 19 | 93 | 0.13 | 135 | 5 | 5 | 5 |
| Ex. 20 | 92 | 0.13 | 135 | 4 | 5 | 5 |
| Ex. 21 | 91 | 0.15 | 150 | 5 | 5 | 4 |
| Ex. 22 | 92 | 0.13 | 135 | 5 | 5 | 4 |
| Ex. 23 | 92 | 0.12 | 130 | 4 | 4 | 4 |
| Ex. 24 | 91 | 0.14 | 145 | 4 | 4 | 5 |
| Ex. 25 | 91 | 0.13 | 135 | 4 | 4 | 5 |

TABLE 4

| | Initial electrical | | | Ozone | | Creep |
|---|---|---|---|---|---|---|
| | characteristics | | | resis- | Occurrence | defor- |
| | Vk5 | El/2 | VR0.30 | tance | of cracking | mation |
| Ex. 26 | 87 | 0.15 | 155 | 3 | 3 | 5 |
| Ex. 27 | 88 | 0.16 | 160 | 4 | 4 | 3 |
| Com. Ex. 1 | 89 | 0.14 | 145 | 1 | 1 | 4 |
| Com. Ex. 2 | 88 | 0.14 | 145 | 2 | 1 | 5 |
| Com. Ex. 3 | 88 | 0.14 | 145 | 2 | 1 | 5 |
| Com. Ex. 4 | 87 | 0.15 | 150 | 1 | 1 | 5 |
| Com. Ex. 5 | 86 | 0.15 | 150 | 1 | 1 | 3 |
| Com. Ex. 6 | 88 | 0.14 | 140 | 2 | 2 | 4 |
| Com. Ex. 7 | 88 | 0.12 | 135 | 2 | 2 | 4 |
| Com. Ex. 8 | 87 | 0.13 | 135 | 2 | 2 | 4 |
| Com. Ex. 9 | 87 | 0.13 | 135 | 1 | 2 | 4 |
| Com. Ex. 10 | 88 | 0.14 | 145 | 1 | 1 | 5 |
| Com. Ex. 11 | 88 | 0.14 | 145 | 1 | 1 | 4 |
| Com. Ex. 12 | 88 | 0.14 | 145 | 2 | 1 | 2 |
| Com. Ex. 13 | 89 | 0.15 | 155 | 2 | 1 | 1 |
| Com. Ex. 14 | 88 | 0.17 | 180 | 2 | 1 | 1 |
| Com. Ex. 15 | 87 | 0.18 | 185 | 2 | 1 | 1 |
| Com. Ex. 16 | 82 | 0.18 | 185 | 2 | 1 | 1 |
| Com. Ex. 17 | 88 | 0.15 | 150 | 2 | 1 | 4 |
| Com. Ex. 18 | 89 | 0.13 | 140 | 2 | 2 | 5 |
| Com. Ex. 19 | 89 | 0.14 | 145 | 3 | 2 | 4 |
| Com. Ex. 20 | 89 | 0.13 | 140 | 3 | 2 | 5 |
| Com. Ex. 21 | 87 | 0.15 | 155 | 1 | 1 | 4 |
| Com. Ex. 22 | 87 | 0.15 | 155 | 2 | 1 | 5 |
| Com. Ex. 23 | 87 | 0.17 | 180 | 1 | 1 | 3 |

### [Evaluation of Printing by Electrophotographic Apparatus]

The photoreceptors of Example 1, Example 7, Example 15, and Example 27 each were mounted in a commercially available 50 ppm monochrome high speed printer HL-L6400DW manufactured by Brother Industries, Ltd., and subjected to a durability test of intermittently printing 75,000 sheets of A4 monochrome images with a print area ratio of 4% at a rate of 5,000 sheets per day for intermittently 10 seconds in each of three environments of a low temperature and low humidity (10° C., 20%) environment, a normal temperature and normal humidity (24° C., 50%) environment, and a high temperature and high humidity (35° C., 80%) environment. It was confirmed that no deterioration of the image quality resulting from the ozone deterioration, the occurrence of cracking, or the creep deformation causing problems in actual use was observed in all of the photoreceptors.

As the conductive substrate, four photoreceptors produced in the same manner as in Example 18, except for using an aluminum tube (cylindrical aluminum substrate) with a wall thickness of 0.75 mm machined to have a diameter of 30 mm, a length of 252.6 mm, and a surface roughness (Rz) of 1.0 μm, were mounted in a commercially available 31 ppm tandem color medium speed printer HL-L8360CDW manufactured by Brother Industries, Ltd., and subjected to a durability test of intermittently printing 40,000 sheets of A4 color images with a print area ratio of 4% at a rate of 3,000 sheets per day for intermittently 10 seconds in each of three environments of a low temperature and low humidity (10° C., 20%) environment, a normal temperature and normal humidity (24° C., 50%) environment, and a high temperature and high humidity (35° C., 80%) environment. It was confirmed that no deterioration of the image quality resulting from the ozone deterioration, the occurrence of cracking, or the creep deformation causing problems in actual use was observed.

From the above, it is considered that the creep deformation is greatly affected by the film quality of the charge generation layer serving as the surface layer and is hardly affected by the film quality of the charge transport layer serving as the lower layer in the positive charging multilayer electrophotographic photoreceptor. Thus, it was found that, by the use of the additives satisfying the conditions of the present invention, an improvement of the ozone resistance and the suppression effect of the occurrence of cracking are observed, and the creep deformation hardly deteriorates. More specifically, it was able to be confirmed that the electrophotographic photoreceptor satisfactorily having all of the ozone resistance, the suppression effect of the occurrence of cracking, and the suppression effect of the creep deformation and having good electrical characteristics can be obtained.

### DESCRIPTION OF SYMBOLS

1 conductive substrate

2 undercoat layer

3 charge transport layer

4 charge generation layer

5 photosensitive layer

12 transfer belt

13 transfer paper

20 photoreceptor

21 charging member

22 high voltage power source

23 image exposure member

24 developing member (developing roller)

25 transfer member (transfer roller)

26 cleaning member (cleaning roller)

30, 70 electrophotographic apparatus

1. An electrophotographic photoreceptor comprising:
in a positive charging multilayer electrophotographic photoreceptor containing a conductive substrate, a charge transport layer containing at least a first hole transport material and a first resin binder; and a charge generation layer containing at least a second hole transport material, an electron transport material, a charge generation material, and a second resin binder,
the charge transport layer and the charge generation layer being sequentially laminated on the conductive substrate,
a compound represented by General Formula (AD1) below in the charge transport layer, 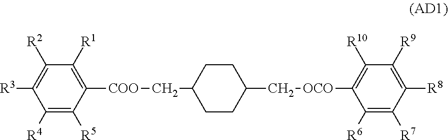
wherein, in General Formula (AD1), R¹ to R¹⁰ each independently represent a hydrogen atom, a halogen atom, a substituted or unsubstituted alkyl group having 1 to 5 carbon atoms, a substituted or unsubstituted aryl group, or an alkoxy group having 1 to 5 carbon atoms, and a substituent represents a halogen atom, an alkyl group having 1 to 5 carbon atoms, an aryl group, or an alkoxy group having 1 to 5 carbon atoms.

2. The electrophotographic photoreceptor according to claim 1, wherein the compound represented by General Formula (AD1) above is present in the charge transport layer at between 15 parts by mass or more and 30 parts by mass or less based on a total of 100 parts by mass of the first hole transport material and the first resin binder.

3. The electrophotographic photoreceptor according to claim 1, wherein the charge generation layer contains a compound represented by General Formula (AD2) below, 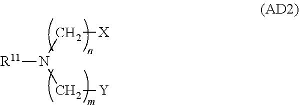
wherein, in General Formula (AD2), represents a hydrogen atom, an alkyl group having 1 to 5 carbon atoms, a substituted or unsubstituted aryl group, or a substituted or unsubstituted aralkyl group; X and Y represent a substituted or unsubstituted aryl group; and n and m represent 1 or 2; and a substituent represents a halogen atom, an alkyl group having 1 to 5 carbon atoms, an aryl group, or an alkoxy group having 1 to 5 carbon atoms.

4. The electrophotographic photoreceptor according to claim 3, wherein the compound represented by General Formula (AD2) is present in the charge generation layer at between 0.5 parts by mass or more and 5 parts by mass or less based on a total of 100 parts by mass of the second hole transport material, the electron transport material, the charge generation material, and the second resin binder.

5. The electrophotographic photoreceptor according to claim 1, wherein the charge transport layer further contains a compound represented by General Formula (AD2) below, 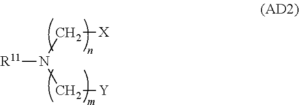
wherein, in General Formula (AD2), represents a hydrogen atom, an alkyl group having 1 to 5 carbon atoms, a substituted or unsubstituted aryl group, or a substituted or unsubstituted aralkyl group; X and Y represent a substituted or unsubstituted aryl group; and n and m represent 1 or 2; and a substituent represents a halogen atom, an alkyl group having 1 to 5 carbon atoms, an aryl group, or an alkoxy group having 1 to 5 carbon atoms.

6. The electrophotographic photoreceptor according to claim 5, wherein the compound represented by General Formula (AD2) is present in the charge transport layer at between 1 part by mass or more and 10 parts by mass or less based on a total of 100 parts by mass of the first hole transport material and the first resin binder.

7. The electrophotographic photoreceptor according to claim 1, wherein either one or both of the first hole transport material and the second hole transport material contains a compound represented by Structural Formula (HT1) below: 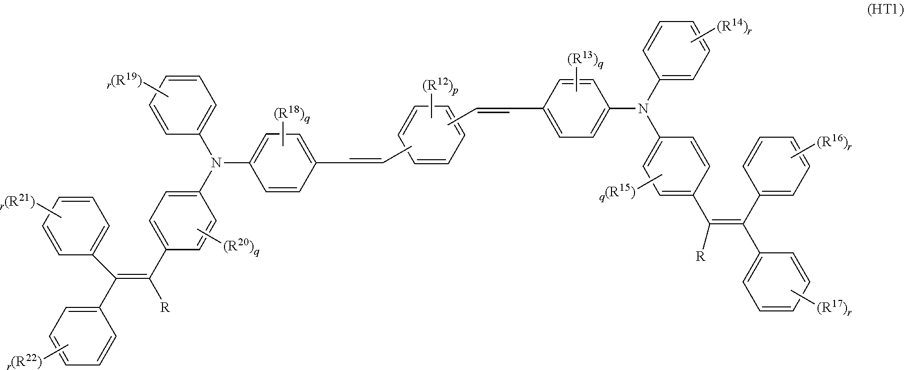
wherein, in Structural Formula (HT1), R¹² represents a hydrogen atom or an alkyl group having 1 to 3 carbon atoms which may have a substituent, R¹³ to R²² each independently represent a hydrogen atom, a halogen atom, an alkyl group having 1 to 6 carbon atoms which may have a substituent, or an alkoxy group having 1 to 6 carbon atoms which may have a substituent, p is an integer of 0 to 4, q is an integer of 0 to 4, r is an integer of 0 to 5, and R represents a hydrogen atom or an alkyl group having 1 to 3 carbon atoms which may have a substituent.

8. The electrophotographic photoreceptor according to claim 1, wherein the charge generation material is titanyl phthalocyanine.

9. The electrophotographic photoreceptor according to claim 1, wherein, in General Formula (AD1), R¹ to R¹⁰ each independently represent a hydrogen atom or a methyl group.

10. The electrophotographic photoreceptor according to claim 3, wherein, in General Formula (AD2), R¹¹ represents a benzyl group, X and Y represent an unsubstituted phenyl group, and n and m represent 1.

11. The electrophotographic photoreceptor according to claim 1, wherein the charge transport layer and the charge generation layer are formed by a dip coating method.

12. The electrophotographic photoreceptor according to claim 1, wherein the conductive substrate is a cylindrical aluminum substrate having a diameter of between 28 mm or more and 40 mm or less.

13. The electrophotographic photoreceptor according to claim 1, wherein the conductive substrate is a cylindrical aluminum substrate having a diameter of between 15 mm or more and less than 28 mm.

14. A method for manufacturing an electrophotographic photoreceptor according to claim 1 comprising:
a step of preparing a charge transport layer coating solution containing at least the first hole transport material, the first resin binder, and the compound represented by General Formula (AD1); and
a step of forming the charge transport layer by a dip coating method using the charge transport layer coating solution.

15. A monochrome electrophotographic apparatus comprising the electrophotographic photoreceptor according to claim 12, wherein a printing speed is 50 ppm or more.

16. A monochrome electrophotographic apparatus comprising the electrophotographic photoreceptor according to claim 12, wherein a photoconductor drum life is 50,000 sheets or more.

17. A tandem color electrophotographic apparatus comprising the electrophotographic photoreceptor according to claim 12, wherein a printing speed is 30 ppm or more.

18. A tandem color electrophotographic apparatus comprising the electrophotographic photoreceptor according to claim 13, wherein a printing speed is 30 ppm or more.

19. A tandem color electrophotographic apparatus comprising the electrophotographic photoreceptor according to claim 13, wherein a photoconductor drum life is 30,000 sheets or more.
